(19) United States
(12) Patent Application Publication
(10) Pub. No.: US 2026/0086710 A1
(43) Pub. Date: Mar. 26, 2026

(54) Devices, Methods, and Graphical User Interfaces for Providing Application Functions and Device Functions

(71) Applicant: Apple Inc., Cupertino, CA (US)

(72) Inventors: Gemma A. Roper, San Francisco, CA (US); Nicolas V. Scapel, London (GB); James H. Foster, Oxford (GB)

(21) Appl. No.: 19/334,721

(22) Filed: Sep. 19, 2025

Related U.S. Application Data
(60) Provisional application No. 63/699,732, filed on Sep. 26, 2024.

(51) Int. Cl. G06F 3/0488; G06F 3/0354

(52) U.S. Cl. CPC G06F 3/0488; G06F 3/03547

(57) ABSTRACT

A first computer system displays a user interface that provides access to a first plurality of functions in accordance with a first operating environment. While displaying the user interface, the computer system detects that the first computer system is connected to another computer system, and in response: if the other computer system is operating in accordance with a second operating environment, the first computer system switches to operating in accordance with the second operating environment, including providing instructions to the other computer system to perform a second plurality of operations in accordance with the second operating environment; and if the other computer system is operating in accordance with a third operating environment, the computer system switches to operating in accordance with the third operating environment, including receiving instructions from the third computer system to perform a third plurality of operations in accordance with the third operating environment.

### RELATED APPLICATIONS

This application claims priority to U.S. Provisional Patent Application No. 63/699,732, filed Sep. 26, 2024, which is hereby incorporated by reference in its entirety.

### TECHNICAL FIELD

This relates generally to electronic devices with input devices, such as touch-sensitive surfaces or touch screens, including but not limited to electronic devices that application functions and device functions.

### BACKGROUND

The use of computer systems and other electronic computing devices has increased significantly in recent years. Example devices include smartphones, personal computers, wearable devices, and smart devices (such as home control devices, televisions, and/or other household appliances). With advances in processing power and memory, the functionality of these computer systems continues to grow.

While these computer systems may be capable of performing a large number of application functions and device functions, users often have difficulty accessing such functionality, and are sometimes unaware that such functions are available. As computer systems are becoming ubiquitous and increasingly sophisticated, users encounter redundant functionality on different computer systems, and may find it frustrating to manage and utilize different variations of the same or similar functionality on different computer systems. Redundancy in hardware components for different computer systems also leads to inefficiency and complexity in managing interoperability of the computer systems, resulting increased cost for manufacturing and maintaining the computer systems.

Existing methods for accessing device and application functionality are sometimes inefficient (e.g., requiring navigation through a large number of irrelevant options, requiring performance of multiple user inputs, and/or navigation through multiple menus), or require pre-existing knowledge (e.g., the user must already know what application or specific function the user is trying to access). This can result in both unnecessary power consumption by the computer system, and in user frustration with the computer system.

### SUMMARY

Accordingly, there is a need for computer systems with faster, more efficient methods of accessing useful functions of the computer system and improving efficiency and interoperability of different computer systems. Such methods and interfaces optionally complement or replace conventional user interfaces and/or methods of accessing functions of the computer system and providing interoperability of computer systems. Such methods and interfaces reduce the number, extent, and/or nature of the inputs from a user and produce a more efficient human-machine interface. For battery-operated devices, such methods and interfaces conserve power and increase the time between battery charges.

The above deficiencies and other problems associated with user interfaces for electronic devices (or more generally, computer systems) with touch-sensitive surfaces are reduced or eliminated by the disclosed devices. In some embodiments, the device is a smartphone (e.g., a mobile phone with graphical user interfaces for accessing application functions and device functions, including a telephony function). In some embodiments, the device is a tablet device (e.g., a portable tablet computer with graphical user interfaces for accessing application functions and devices functions, optionally with or without a telephony function). In some embodiments, the device is a desktop computer. In some embodiments, the device is portable (e.g., a notebook computer, tablet computer, or handheld device). In some embodiments, the device is a personal electronic device (e.g., a wearable electronic device, such as a watch). In some embodiments, the device has a touchpad. In some embodiments, the device has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a method is performed at a computer system in communication with one or more display generation components and one or more input elements. The method includes, while the computer system is in a restricted state, detecting, via the one or more input elements, a first event that corresponds to a request to exit the restricted state of the computer system. The method includes, in response to detecting the first event, displaying, via the one or more display generation components, a first user interface that corresponds to a starting state of the computer system upon exiting the restricted state of the computer system, wherein displaying the first user interface includes: in accordance with a determination that a current context of the computer system meets a first set of contextual criteria, displaying, via the one or more display generation components, a first plurality of user interface objects corresponding to a first set of application functions provided by a first plurality of applications, wherein the first plurality of user interface objects includes a first number of user interface objects; and in accordance with a determination that the current context meets a second set of contextual criteria, different from the first set of contextual criteria, displaying, via the one or more display generation components, a second plurality of user interface objects corresponding to a second set of application functions provided by a second plurality of applications, wherein: the second plurality of user interface objects includes a second number of user interface objects that is different from the first number of user interface objects; and the second set of application functions are different from the first set of application functions.

In accordance with some embodiments, a method is performed at a first computer system that is in communication with a first set of one or more display generation components and a first set of one or more input elements for detecting user inputs. The method includes, displaying, via the first set of one or more display generation components, a first user interface in accordance with a first operating environment associated with the first computer system, wherein the first user interface provides access to a first plurality of functions of the first operating environment. The method includes, while displaying the first user interface in accordance with the first operating environment associated with the first computer system, detecting, via the first set of one or more input elements, that the first computer system is connected to a respective computer system. The method includes, in response to detecting that the first computer system is connected to the respective computer system: in accordance with a determination that the respective computer system is a second computer system that operates in accordance with a second operating environment different from the first operating environment, switching from operating in accordance with the first operating environment to operating in accordance with the second operating environment, including providing instructions to the second computer system that, when received by the second computer system, cause performance of a second plurality of operations by the second computer system, in accordance with the second operating environment; and in accordance with a determination that the respective computer system is a third computer system that operates in accordance with a third operating environment different from the first operating environment and the second operating environment, switching from operating in accordance with the first operating environment to operating in accordance with the third operating environment, including: receiving instructions from the third computer system; and in response to receiving the instructions from the third computer system performing a third plurality of operations, different from the first plurality of operations and the second plurality of operations.

In accordance with some embodiments, an electronic device (or computer system more generally) includes a display, a touch-sensitive surface, optionally one or more sensors to detect intensities and/or durations of contacts with the touch-sensitive surface, optionally one or more tactile output generators, one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device with a display, a touch-sensitive surface, optionally one or more sensors to detect intensities and/or duration of contacts with the touch-sensitive surface, and optionally one or more tactile output generators, cause the device to perform or cause performance of the operations of any of the methods described herein. In accordance with some embodiments, a graphical user interface on an electronic device with a display, a touch-sensitive surface, optionally one or more sensors to detect intensities and/or duration of contacts with the touch-sensitive surface, optionally one or more tactile output generators, a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display, a touch-sensitive surface, optionally one or more sensors to detect intensities and/or durations of contacts with the touch-sensitive surface, and optionally one or more tactile output generators; and means for performing or causing performance of the operations of any of the methods described herein. In accordance with some embodiments, an information processing apparatus, for use in an electronic device with a display, a touch-sensitive surface, optionally one or more sensors to detect intensities and/or duration of contacts with the touch-sensitive surface, and optionally one or more tactile output generators, includes means for performing or causing performance of the operations of any of the methods described herein.

Thus, electronic devices and other computer systems with displays, touch-sensitive surfaces, optionally one or more sensors to detect intensities and/or duration of contacts with the touch-sensitive surface, optionally one or more tactile output generators, optionally one or more device orientation sensors, and optionally an audio system, are provided with improved methods and interfaces for providing application and device functions of the computer system, thereby increasing the effectiveness, efficiency, and user satisfaction with such devices. Such methods and interfaces may complement or replace conventional methods for interacting with computer systems.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

Figure (“FIG.”) 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3A is a block diagram of an example multifunction device with a display and a touch-sensitive surface in accordance with some embodiments.

FIGS. 3B-3G illustrate the use of Application Programming Interfaces (APIs) to perform operations.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 4C1-4C2 illustrate an example state diagram of navigation between various user interfaces of the multifunction devices in accordance with some embodiments.

FIGS. 5A-5AJ illustrate exemplary contextually-updated user interfaces and exemplary user interactions with said contextually-updated user interfaces, in accordance with some embodiments.

FIGS. 6A-6M illustrate exemplary user interfaces and changes in function of a computer system, when the computer system is connected to different external computer systems, in accordance with some embodiments.

FIGS. 7A-7I are flow diagrams of a method for displaying and interacting with contextually-updated user interfaces, in accordance with some embodiments.

FIGS. 8A-8D are flow diagrams of a method for displaying different user interfaces and changing functions of a computer system, when connected to different external computer systems, in accordance with some embodiments.

### DESCRIPTION OF EMBODIMENTS

Many computer systems provide access to functionality and applications of by displaying an application library, a springboard user interface, or a home screen that includes an arrangement of application icons and widgets for a large number of available applications, as an initial user interface that is displayed when a computer system exits a restricted state such as a lock screen state and/or a wake screen state in response to a user input to dismiss the lock screen or wake screen. A user can access individual functionality of a respective application by selecting the application icon or widget of the respective application to display an initial user interface the application, and then navigating to the desired functionality using the user interface hierarchy of the respective application through a series of user inputs directed to the user interfaces of the respective application. This way of accessing desired application and device functionality can be difficult and cumbersome, because the number of available applications can be numerous, and the user interface hierarchies of applications can be complex, varied, and unapparent to the user. Without efficient and intuitive methods of presenting, searching, filtering, or otherwise streamlining the delivery of relevant application and/or device functions to a user, the user experience on the computer system can be slow, error-prone, ineffective, and frustrating. In some embodiments, described below, a computer system exits a restricted state of the computer system and displays an initial or starting user interface of the computer system, in response to a user request to exit the restricted state of the computer system, where the initial or starting user interface automatically includes user interface objects corresponding to contextually-selected applications and/or contextually-selected subsets of application functionality and/or device functionality from the contextually-selected applications (e.g., including system applications and/or user applications), based on the current context of the computer system. Providing the contextually-selected subsets of application functionality and/or device functionality from a limited number of contextually-selected applications based on current context, allows different number (e.g., two, three, four, five, or another contextually determined number) of automatically-generated user interface objects (e.g., widgets, user interface snippets, and/or other types of user interface objects that include contextually-selected application content and application controls) to be presented, optionally arranged in different contextually-determined orders and/or spatial arrangements, in the initial or starting user interface of the computer system, based on the current context of the computer system (e.g., essentially providing a “contextual” home screen or a “contextual” springboard user interface in response to a user input directed to the lock screen or wake screen user interface). In some embodiments, such contextual initial user interfaces of the computer system can be updated to display different sets of user interface objects corresponding to different subsets of functionality from different subsets of applications, as the current context changes over time while the contextual initial user interface is displayed, and/or when the contextual initial user interface is redisplayed (e.g., reinvoked from the restricted state, or redisplayed after exiting an application user interface) at another time with a different context.

Based on a current context (e.g., a current location, a current time of day, recent and upcoming calendar information, recent communication information, recent user interaction with the computer system, and/or other contextual information), the computer system can continuously display, and provide access to, contextually relevant functions and/or applications (e.g., without displaying contextually irrelevant functions and/or applications). In some embodiments, described below, the computer system allows for natural language searching (e.g., removing the need to know the precise function and/or application associated with a precise function that is being searched for) while displaying the initial user interface and/or the wake screen user interface, which enables the computer system to reduce the number of user inputs needed to perform the search functions (e.g., the computer system can automatically input information gathered from the natural language search, without requiring manual entry or input by the user), and further refine the set of user interface objects presented in the initial user interface and the application functions and/or device functions presented in the user interface objects.

In some embodiments, a computer system includes processors, memory, and input/output elements (e.g., touch-sensitive surfaces, touch-screen, displays, projectors, buttons, joysticks, communication ports, cameras, fingerprint and/or other biometric sensors, gaze tracking sensors, remote controls, temperature sensors, ambient light sensors, orientation sensors, motion sensors, antenna, network interfaces, telephony circuitry, speakers, tactile output generators, and/or other input/output devices and interfaces). The functionality and operating environment of the computer system changes when the computer system is connected to another computer system; and the functionality and operating environment of the computer system while connected to the other computer system, depend on the device type of the other computer system, and, optionally, the characteristics of the connection itself (e.g., the type of connection and/or the spatial arrangement of the computer systems while connected). In some embodiments, the computer system may operate in a standalone manner (e.g., not connected to the other computer system), as a source of content and input for the other computer system (e.g., stream content to a TV or acting as a user-operated remote control for the TV, as a track-pad for a desktop computer, as a pointing device for a head-mounted AR/VR device, as a keyboard for a tablet computer), or as an extension of the other computer system to perform operations for the other computer system (e.g., as a display and speaker for a smart-home controller device, as a web-camera for a desktop computer, as a radio transmitter or broadcaster for a network server, or as an additional processing or storage unit for the other computer). In some embodiments, the computer system changes its active operating system from a first operating system to a second operating system or a third operating system when the computer system is connected to another computer system, depending on the characteristics of the connection made to the other computer system. In some embodiments, the computer system restores the original operating environment when the connection is terminated. In some embodiments, the user interface initially displayed on the computer system before the connection is changed or replaced when the connection to the other computer system is made and, in accordance with the new functions and roles of the computer system are providing in the connected state. As described below, a computer system can display a user interface that changes based on which external device (e.g., an external computer system) is in communication with (e.g., connected to), and optionally, can provide instructions and/or data to, and/or receiving instructions and/or data from, the external device. The computer system provides a versatile set of functions and plays a number of different roles when connected to different external devices, thereby better utilizing the available device functions and hardware capabilities of the computer system and the external device(s), and reducing the complexity of configuring the computer system and the external devices(s) to provide various application functionality and device functionality.

As described herein, in some embodiments, the computer system that provides contextually selected application and device functions based on the current context, and/or switches operating environments and roles based on the connection made to another computer system, is a lightweight device that has a simplified user interface hierarchy and reduced hardware capabilities, and that can optionally be produced with reduced cost and/or more suitable for temporary use in the standalone mode (e.g., to the beach, outdoors, or during physical activities). The lightweight device can be coupled to another device (e.g., a smartphone, a desktop computer, a tablet computer, a TV, or other computer systems) to achieve a broader range of functionalities and full user interface hierarchies for the operating system and different applications. In some embodiments, the computer system can operate in the lightweight mode with a simplified user interface hierarchy, and a regular mode with the broader range of functionalities and full user interface hierarchies for the operating system and different applications. In some embodiments, the lightweight mode and the regular or full-function mode are selectively activated based on the current context (e.g., whether the user is traveling, outdoors, exercising, or driving, as opposed to indoors, at home, or sitting down), or based on prior user selection (e.g., schedules based on time of day and location, or based on user inputs used to navigate away from the lock screen or wake screen).

The methods, devices, and GUIs described herein make it easier to access contextually-relevant functions and/or applications (e.g., by automatically displaying contextually relevant information and/or providing access to contextually relevant applications and functions), and to perform desired functions (e.g., by streamlining access to said functions). In addition, the methods, devices, and GUIs described herein make it more efficient to utilize the hardware and application capabilities of multiple computer systems, thereby reducing redundancy of hardware components, and/or improve interoperability of different computer systems.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

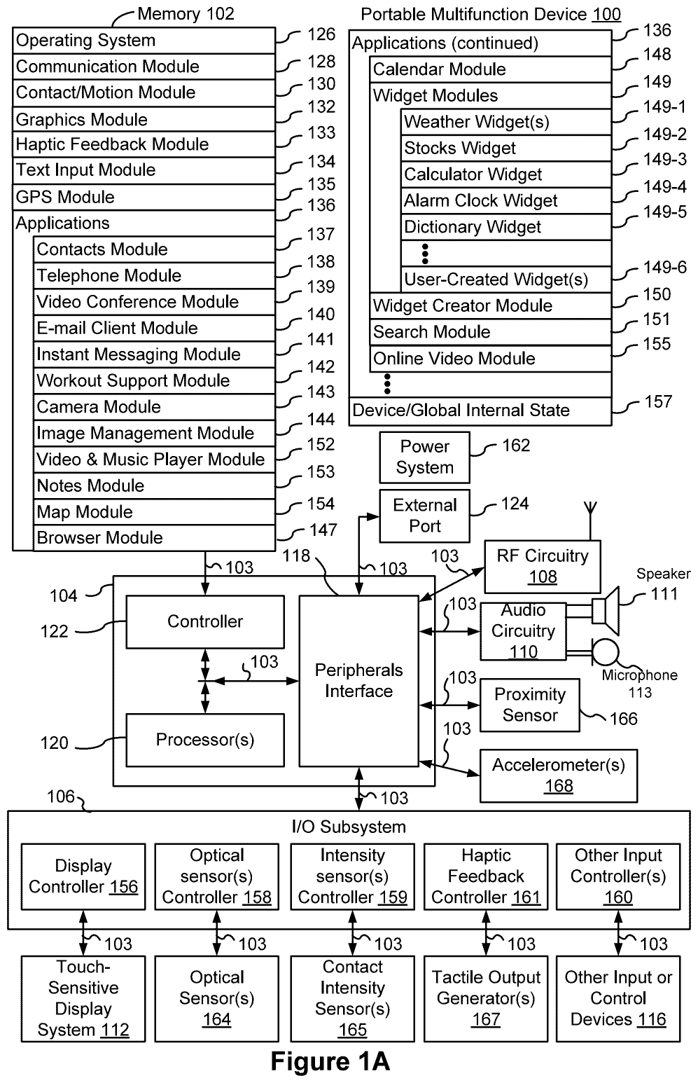

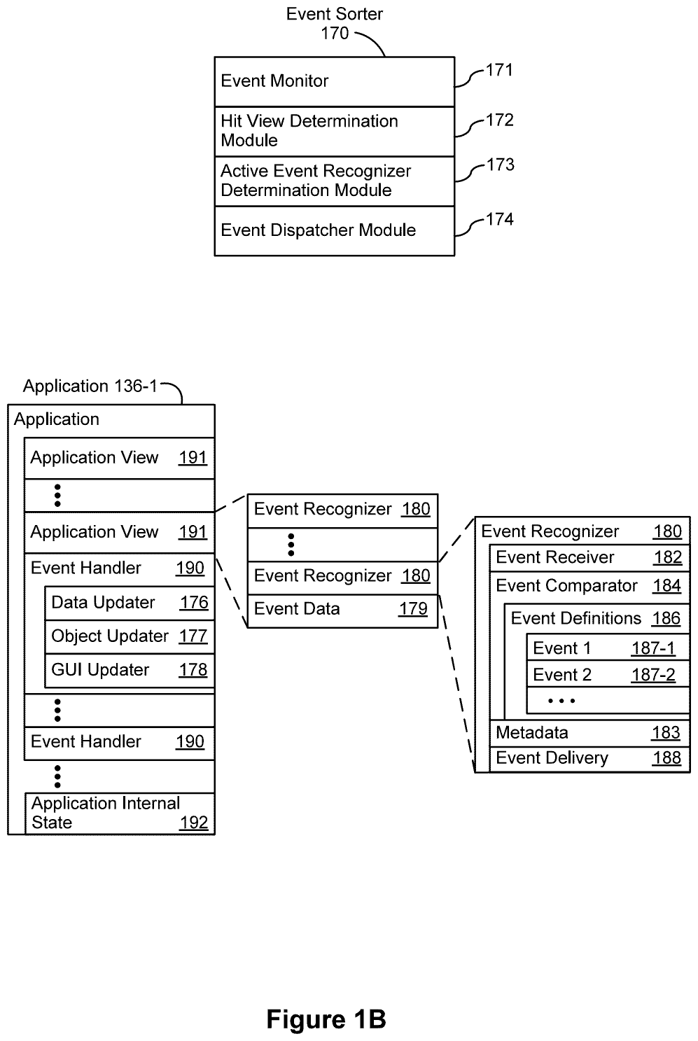

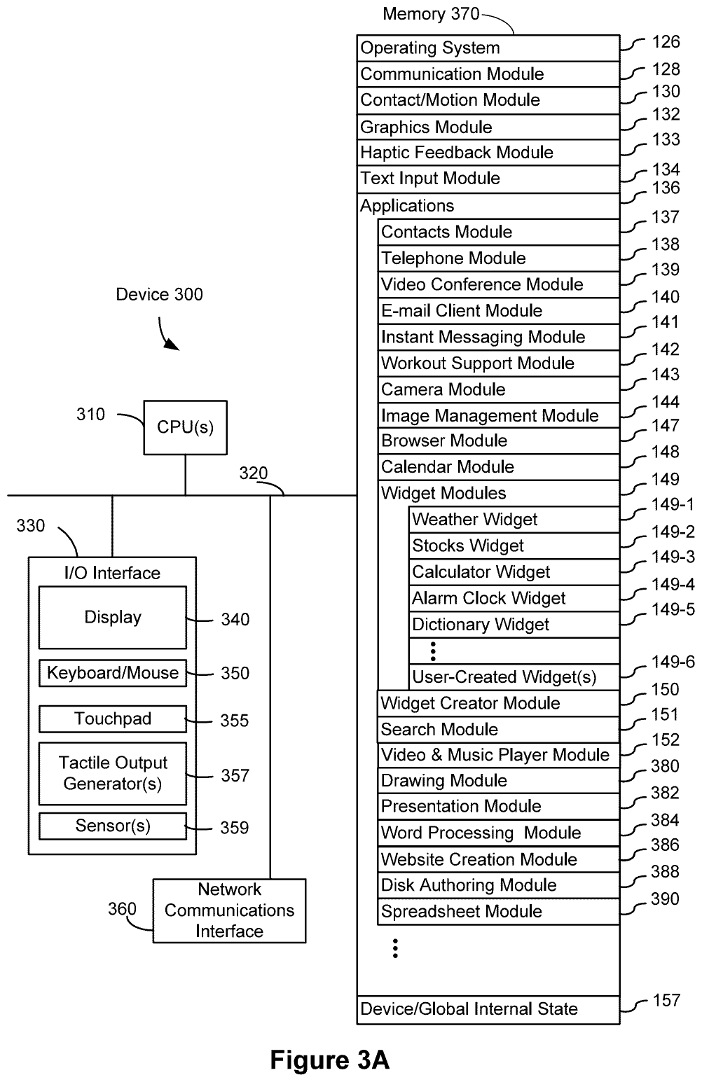

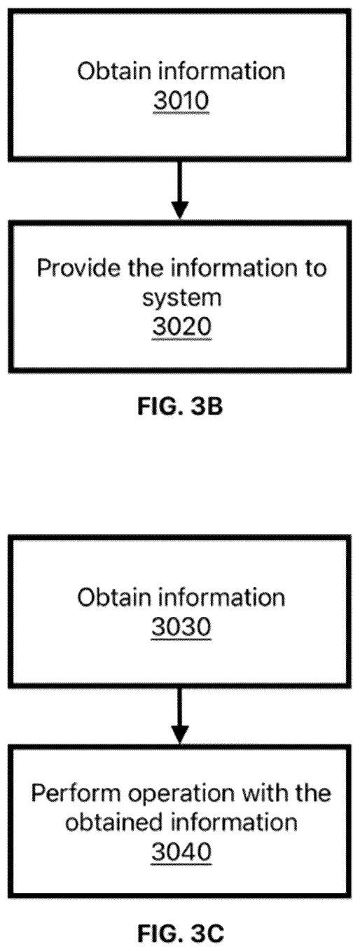

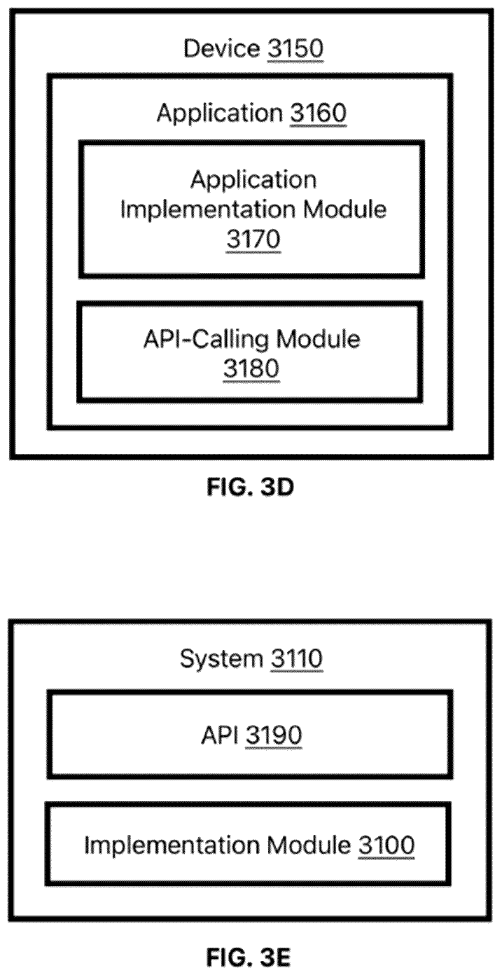

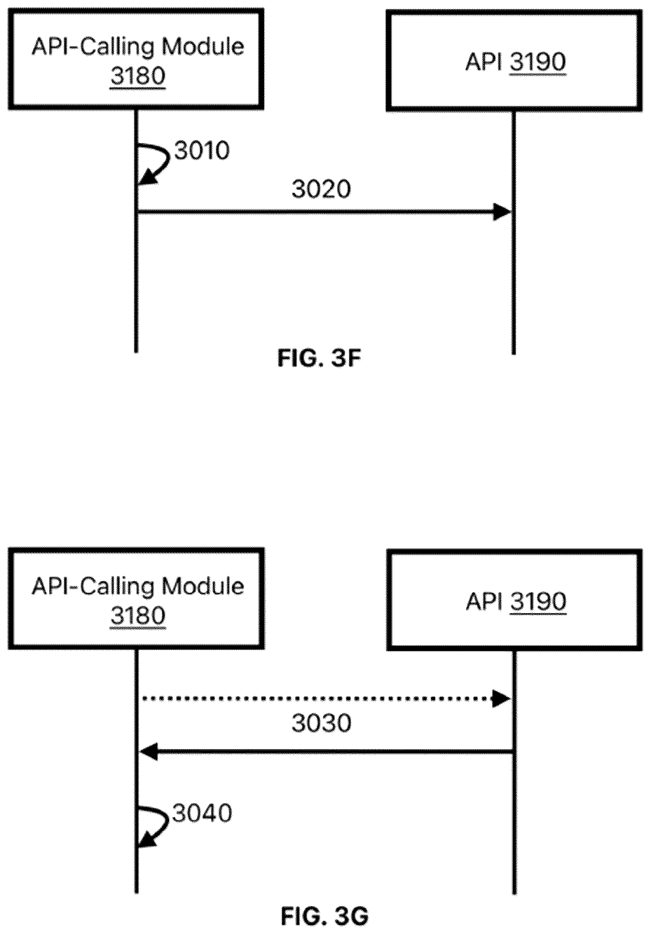

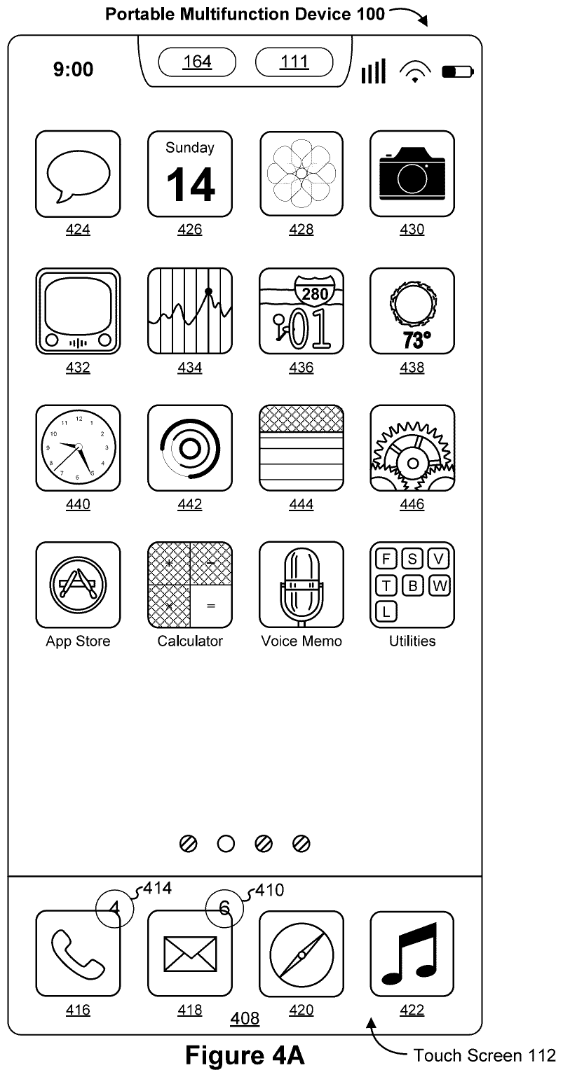

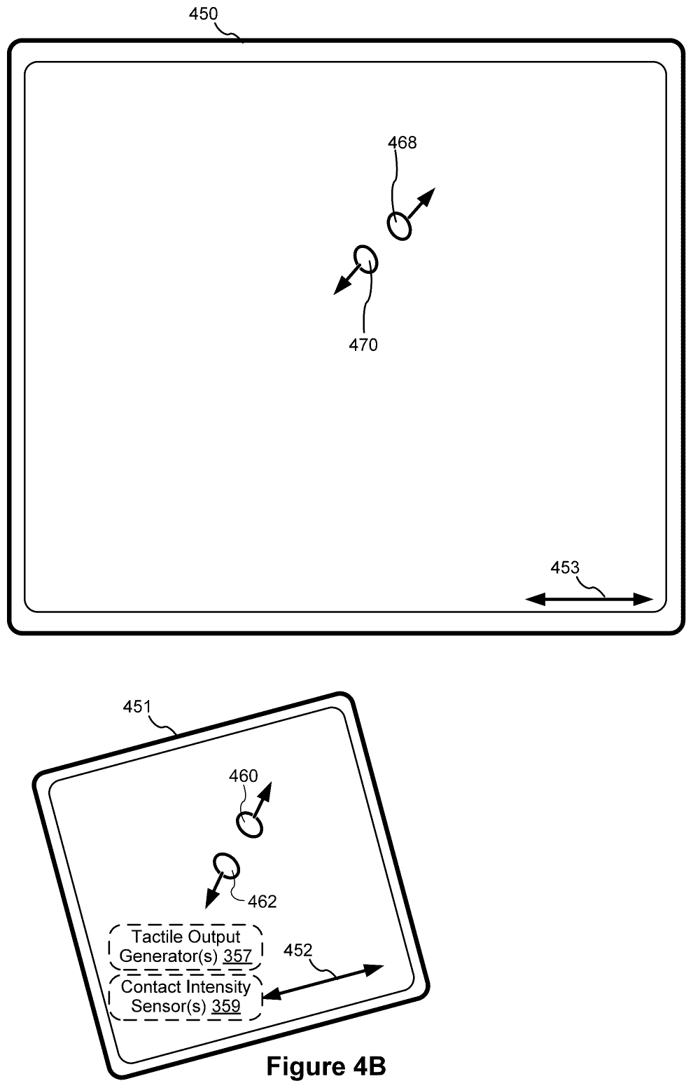

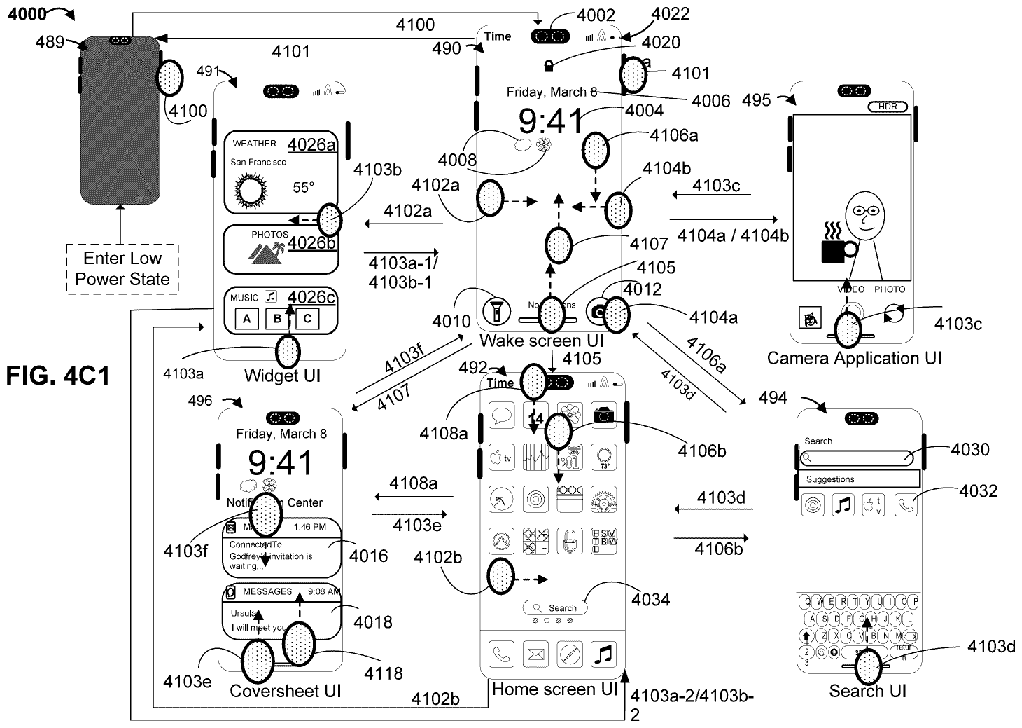

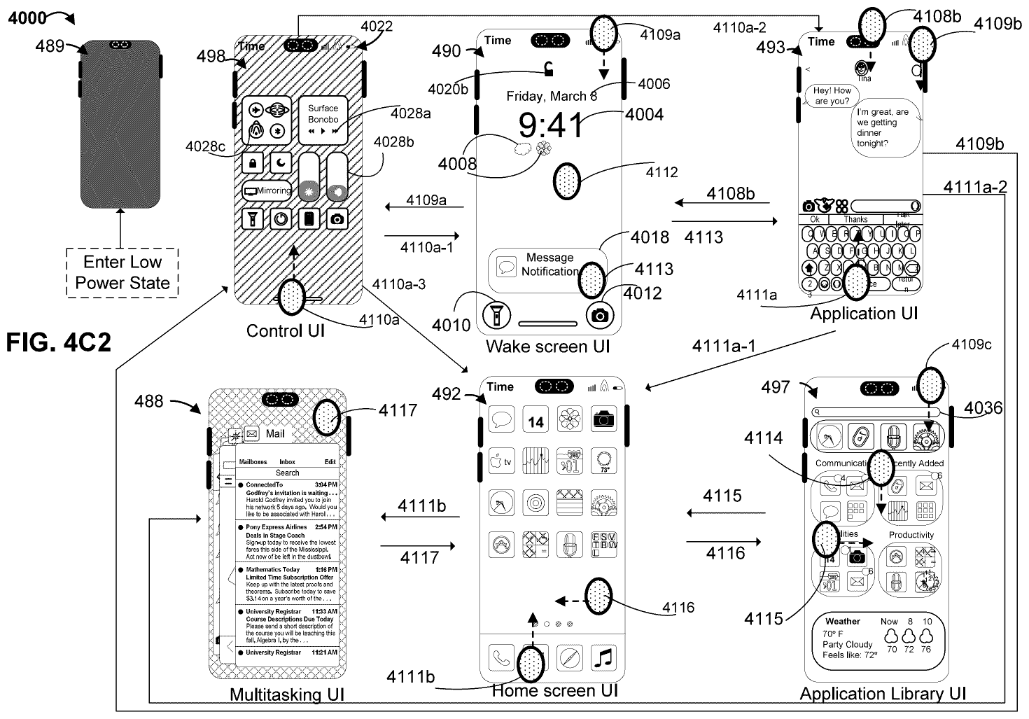

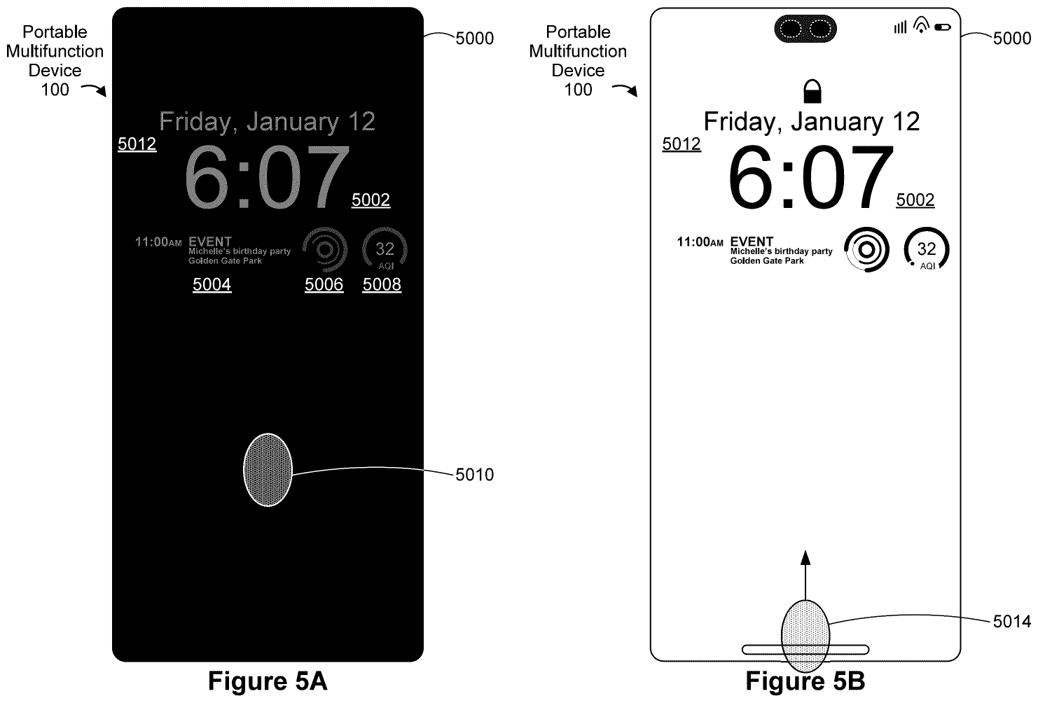

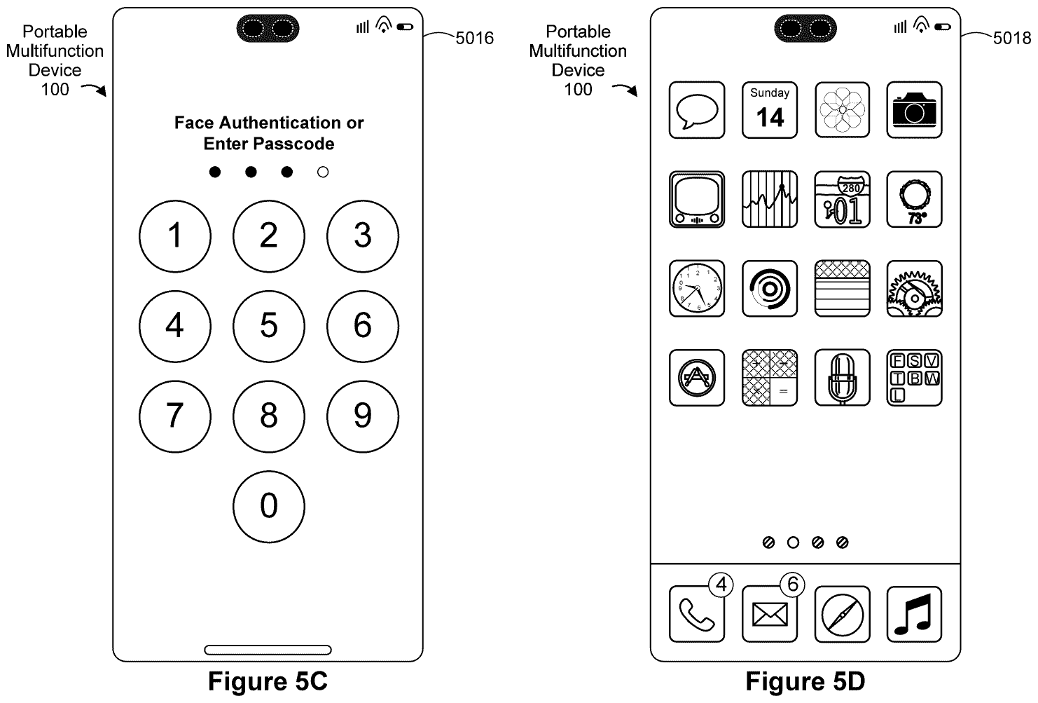

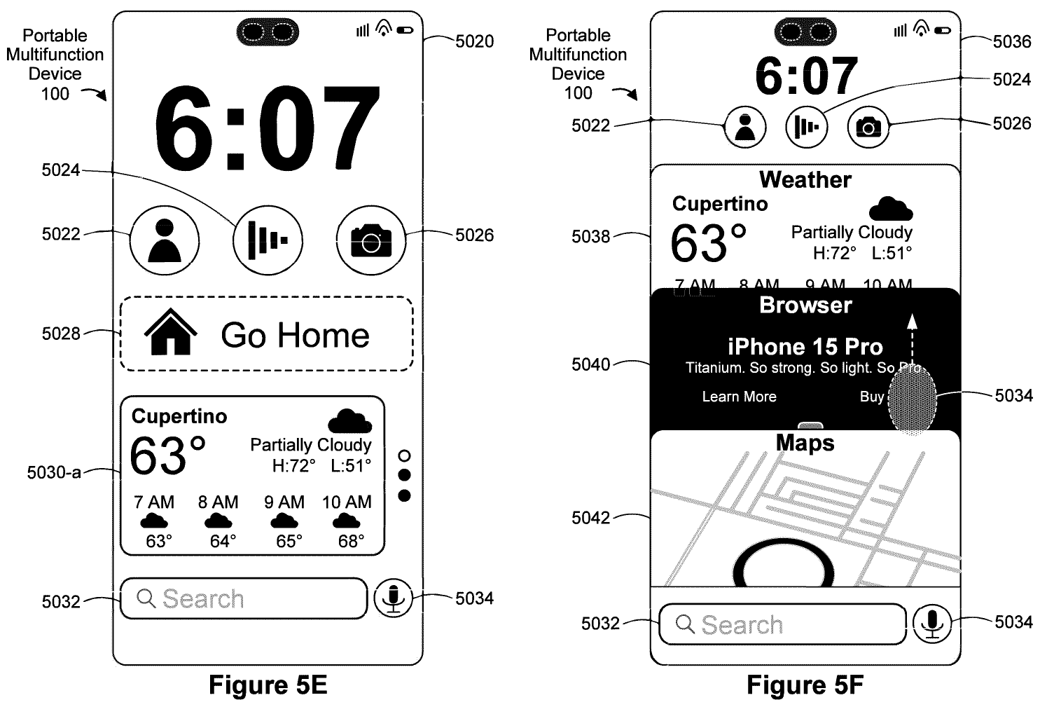

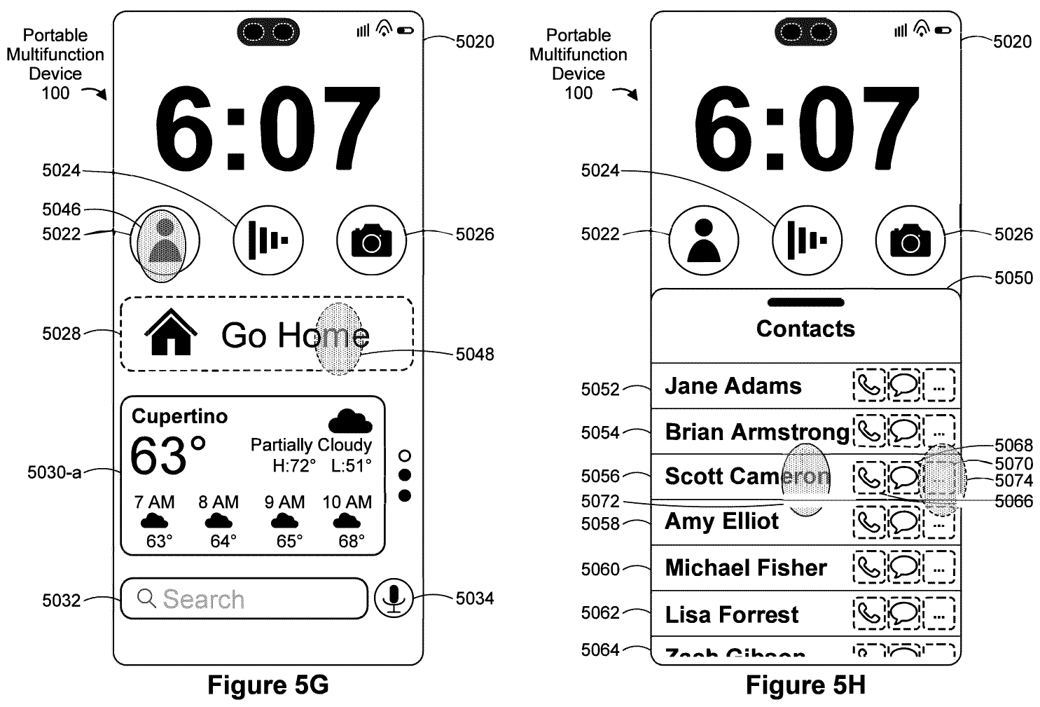

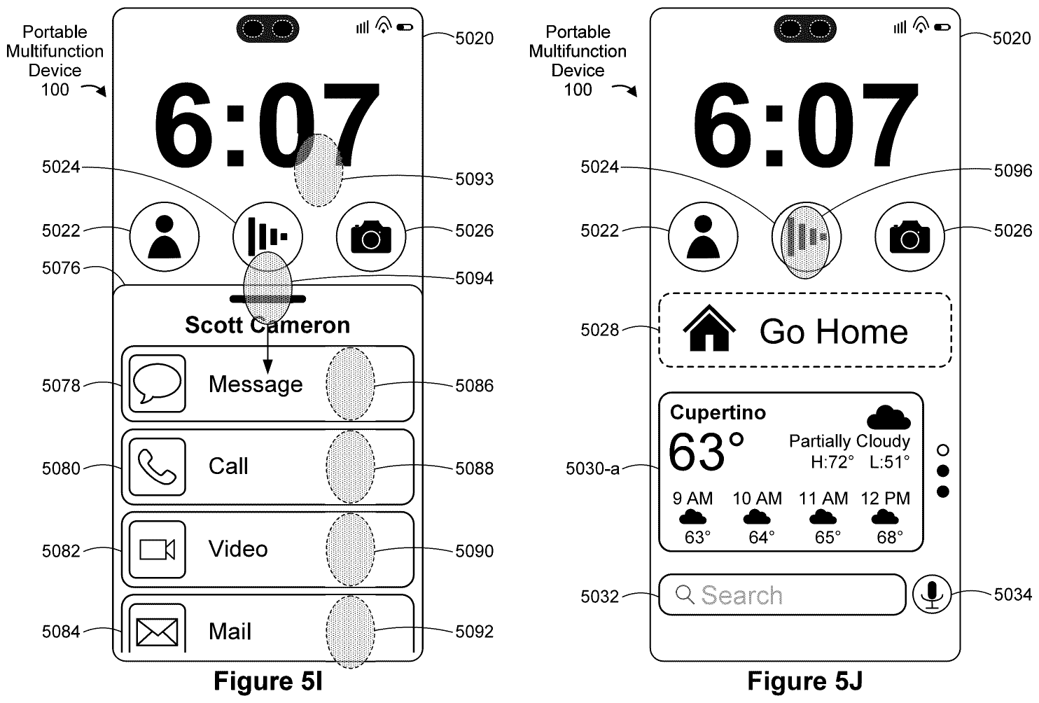

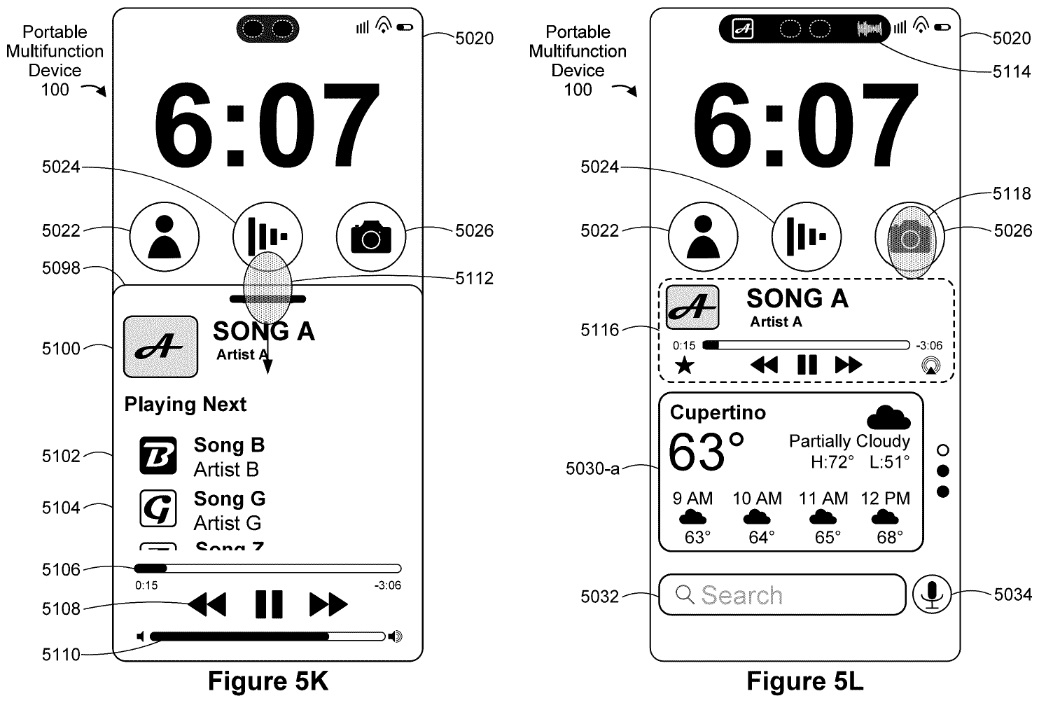

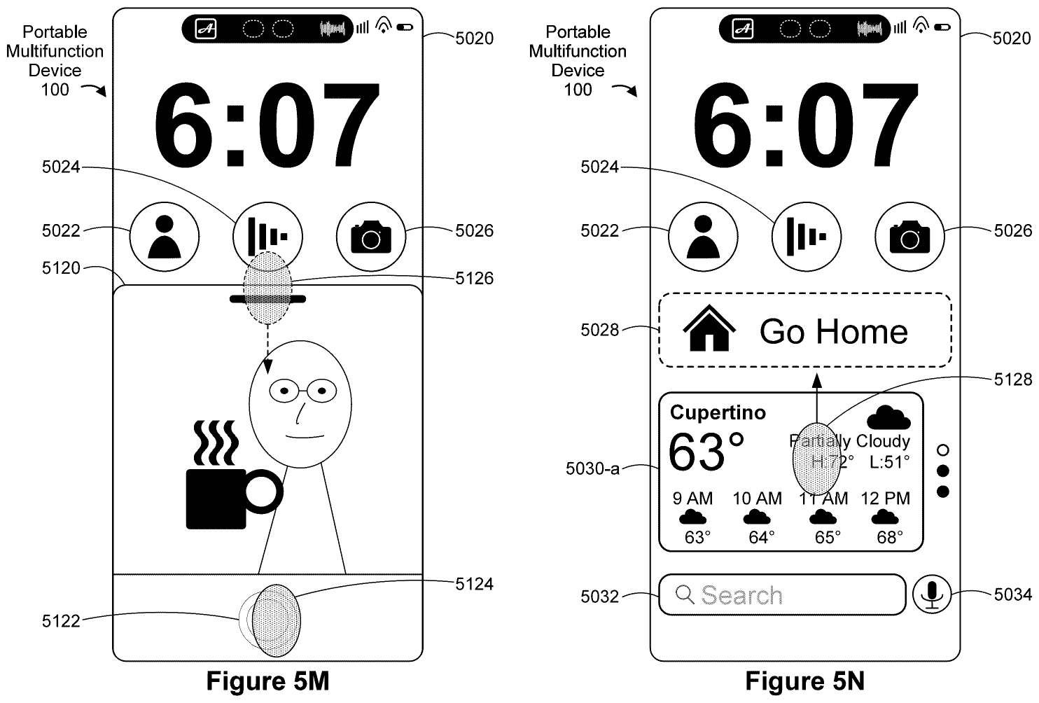

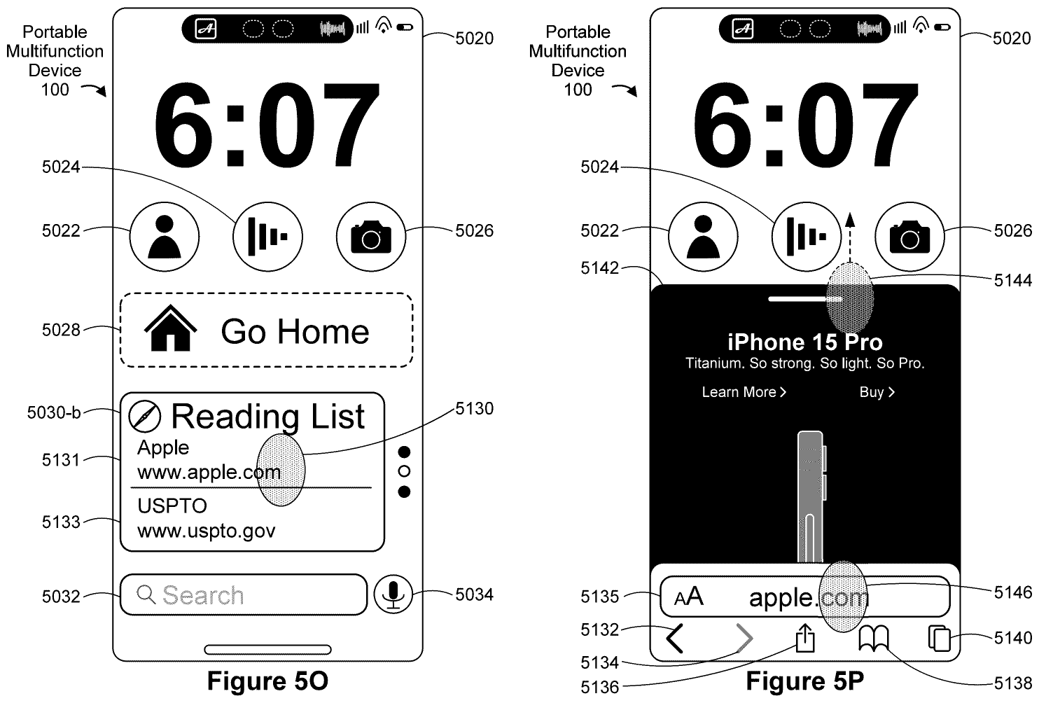

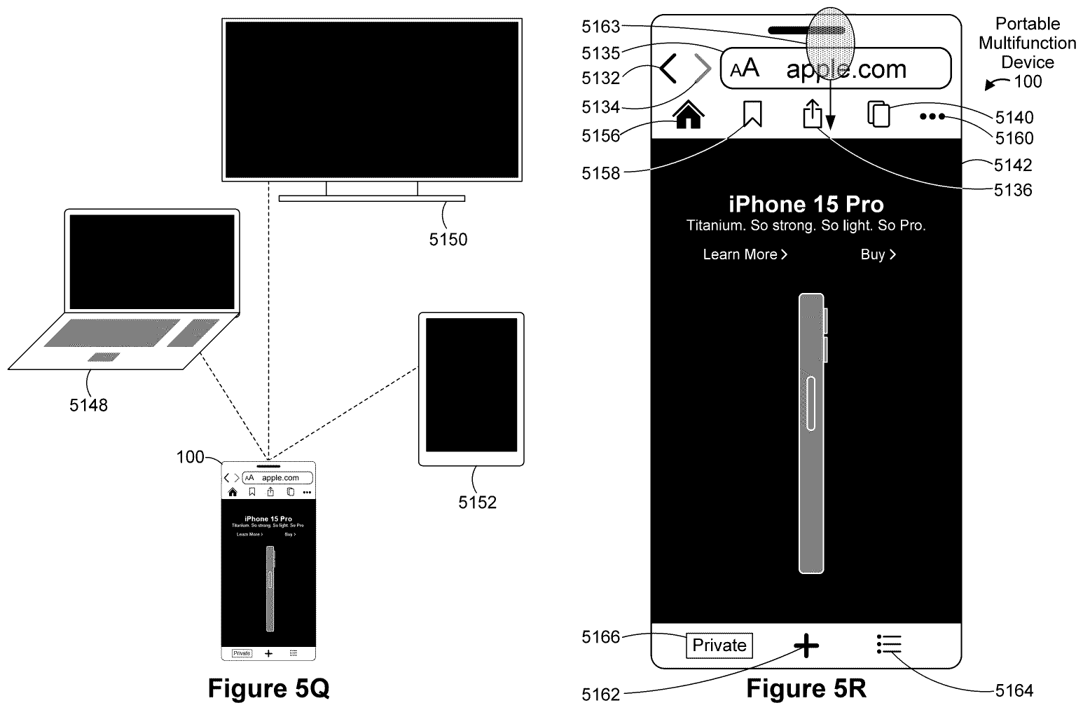

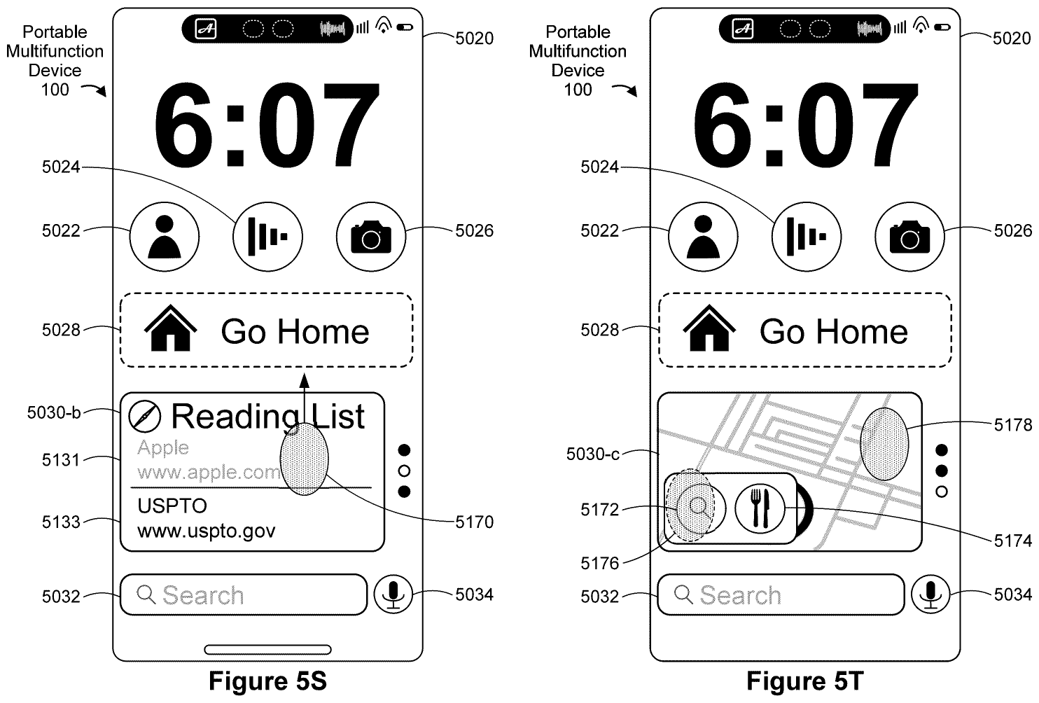

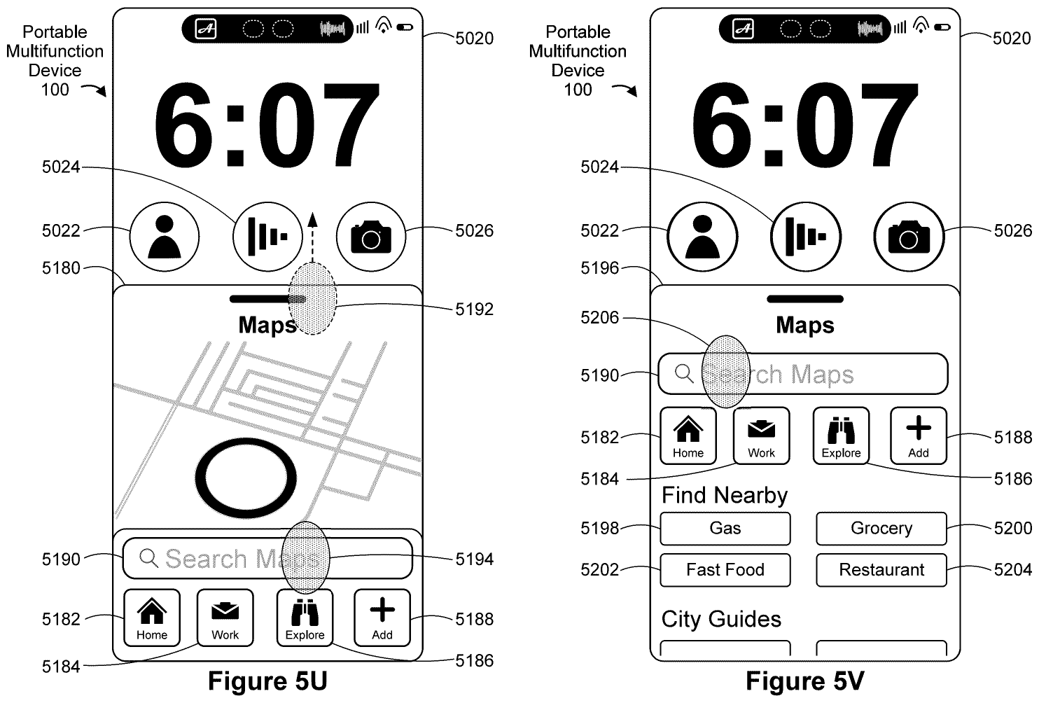

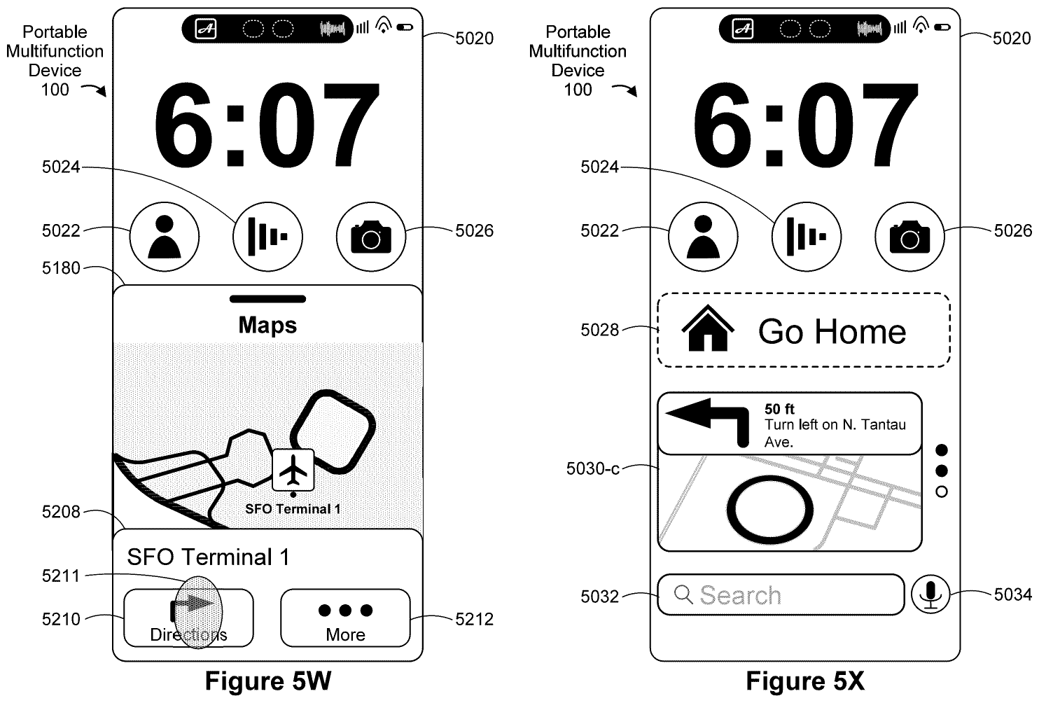

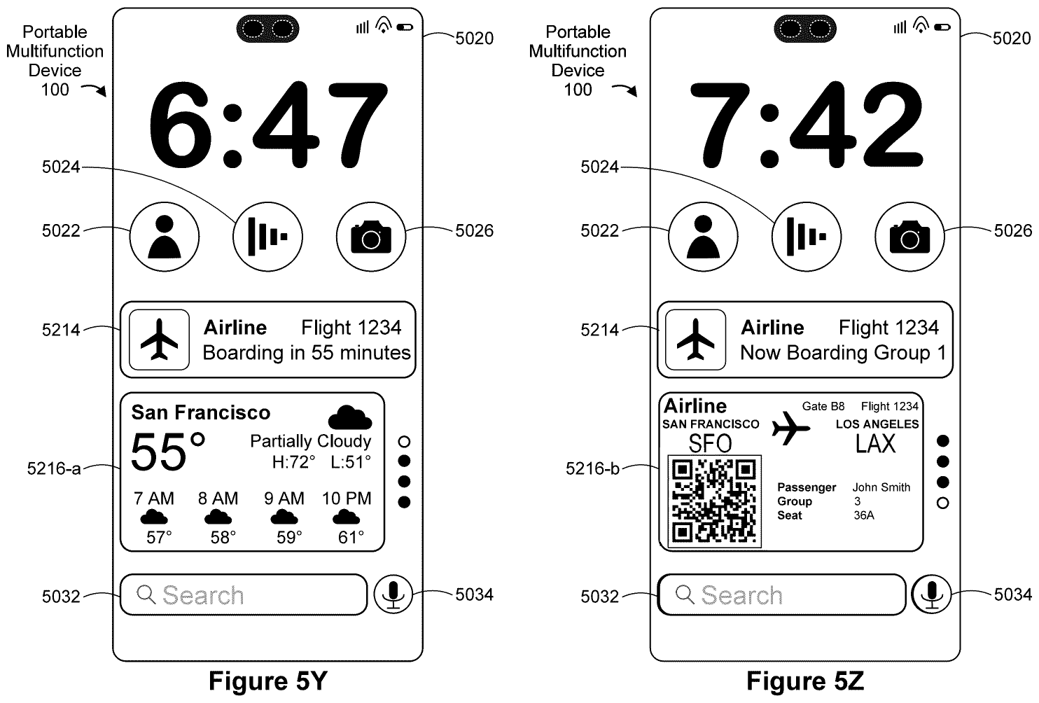

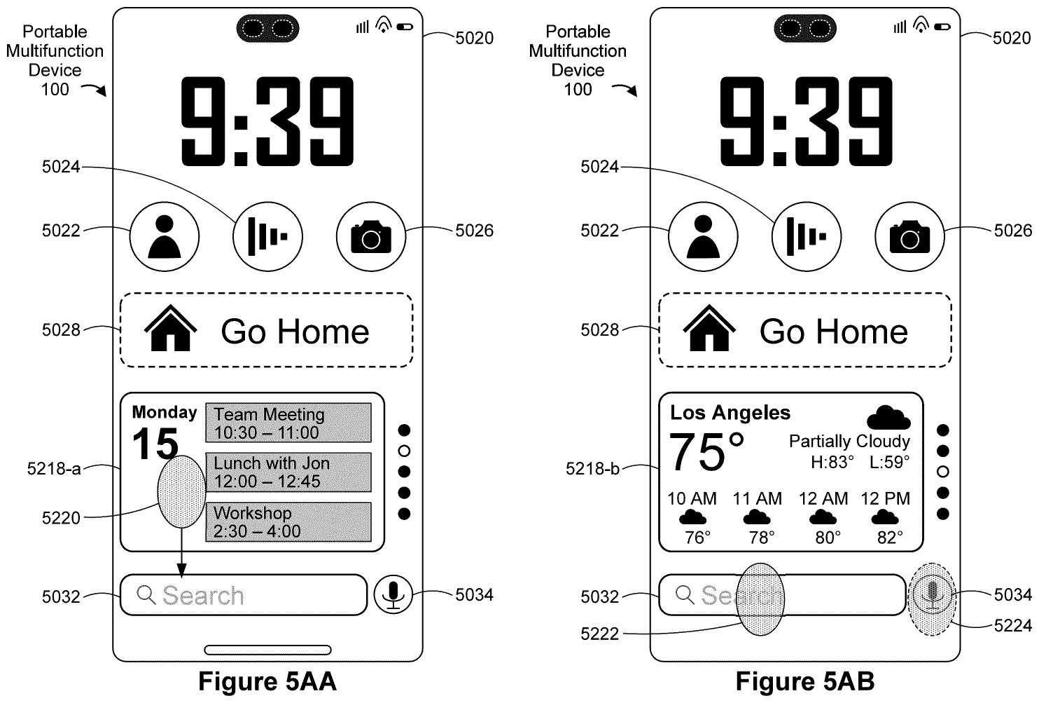

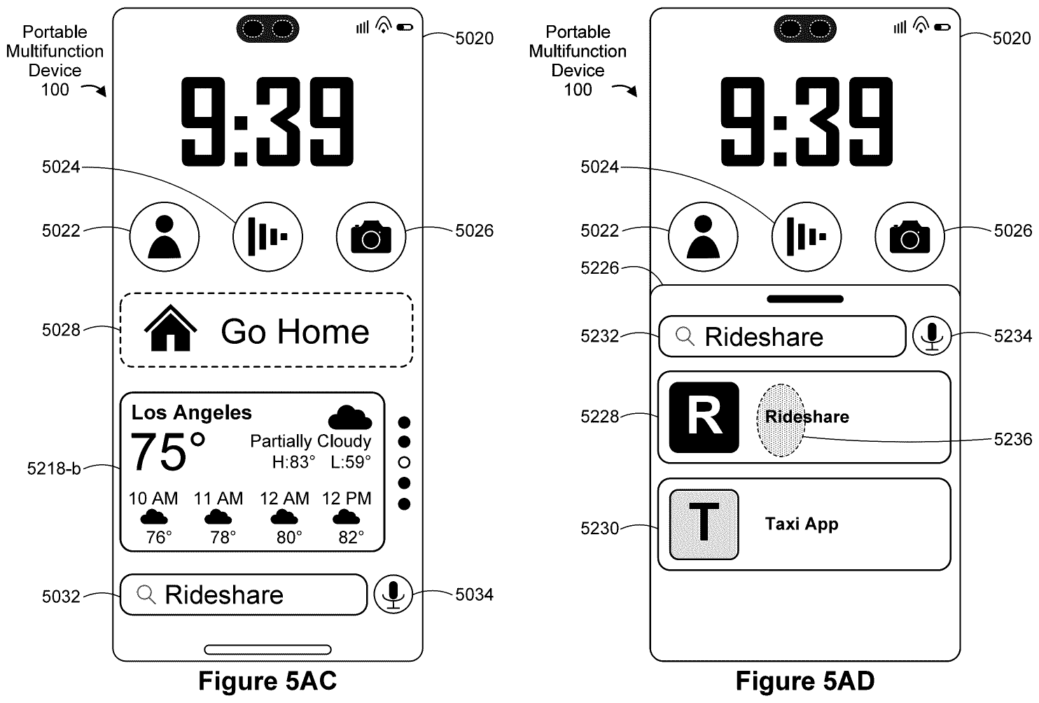

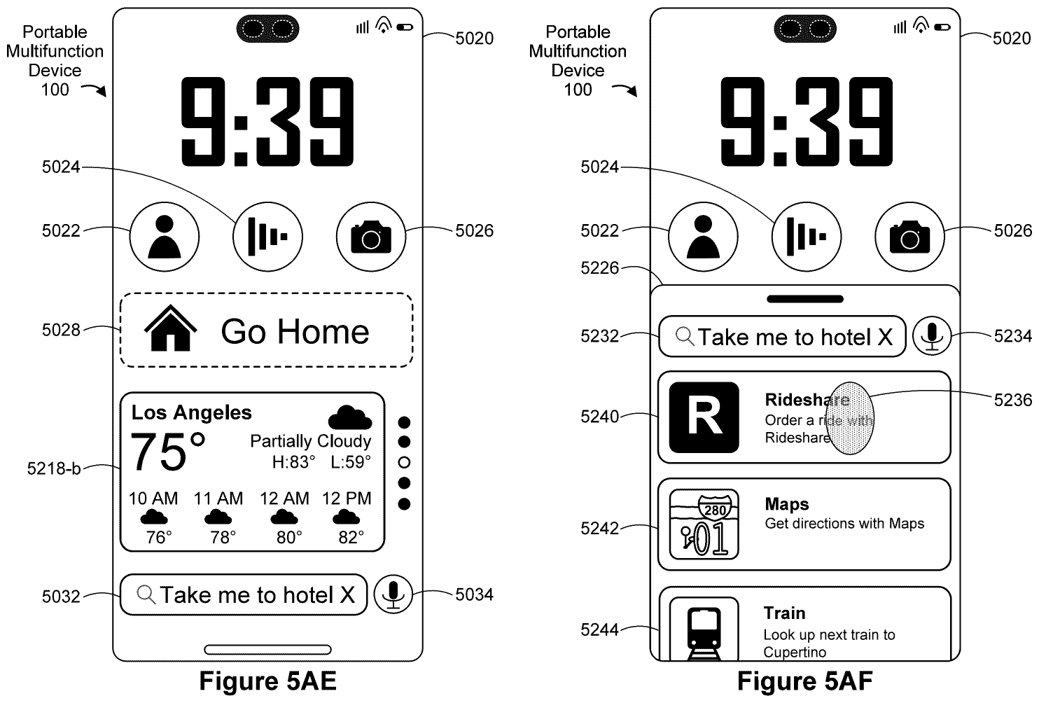

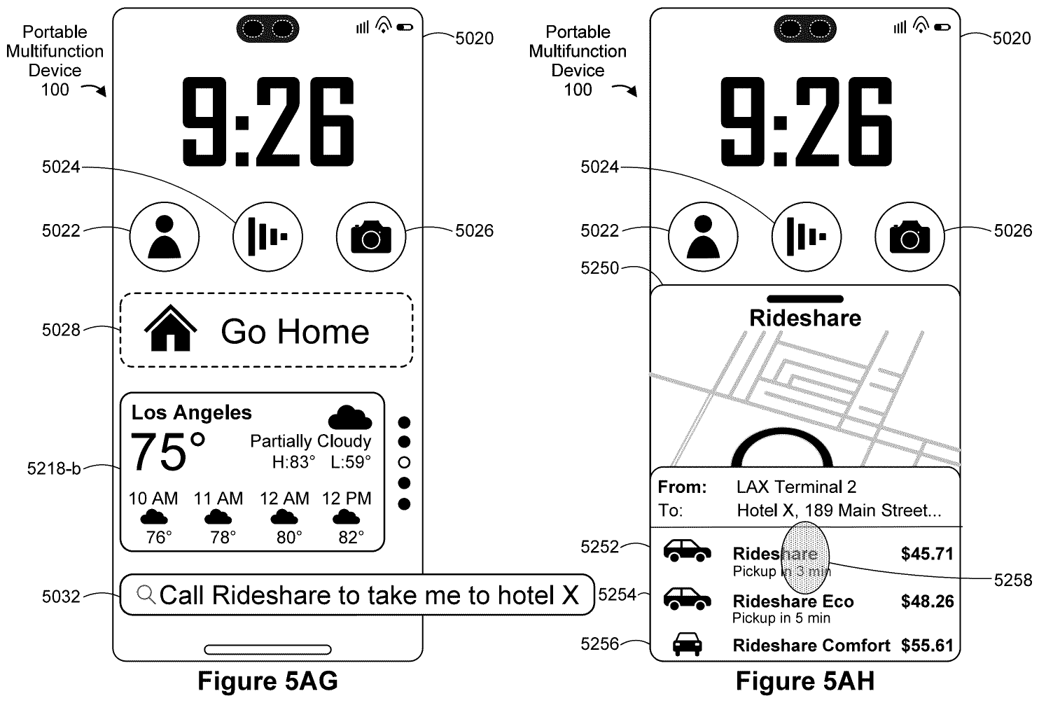

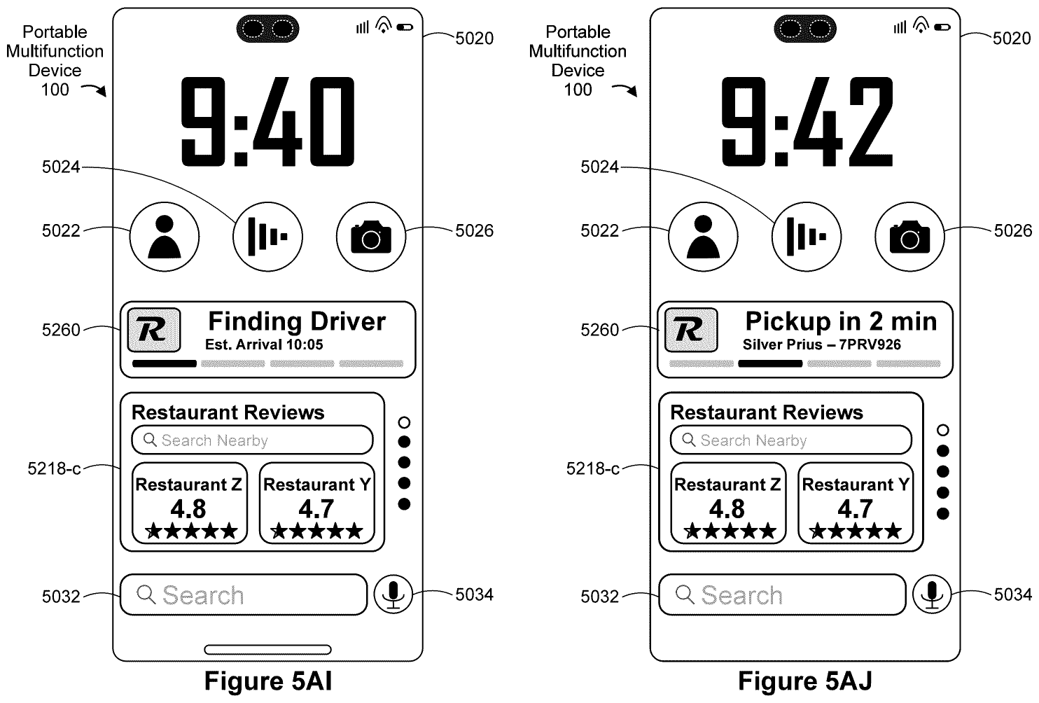

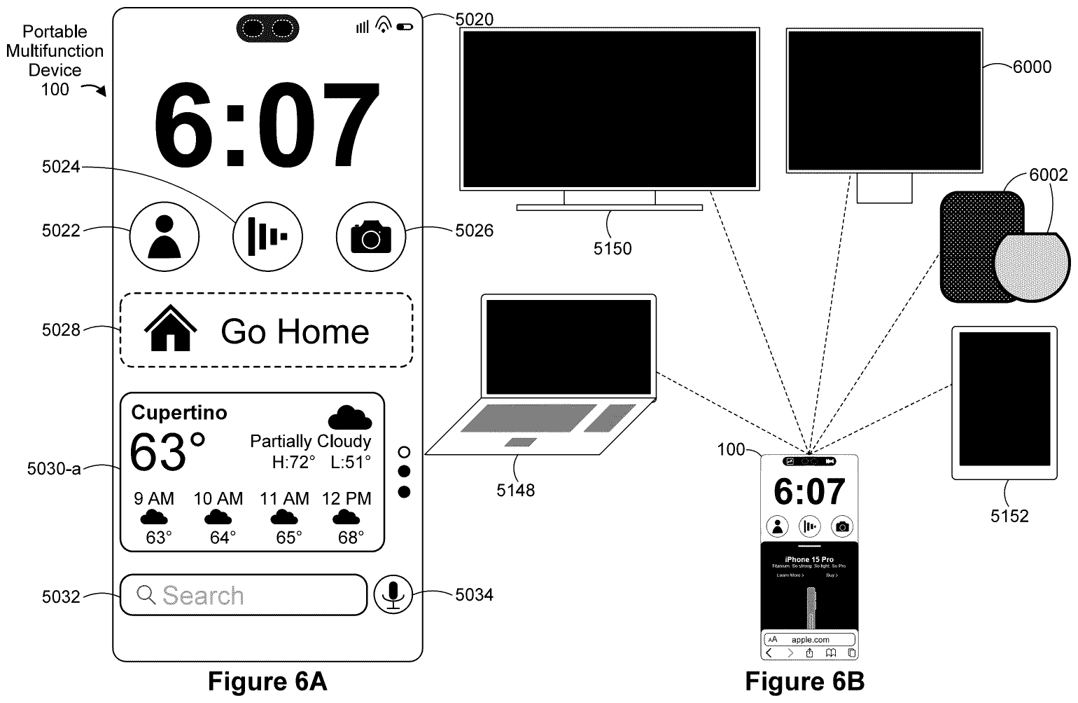

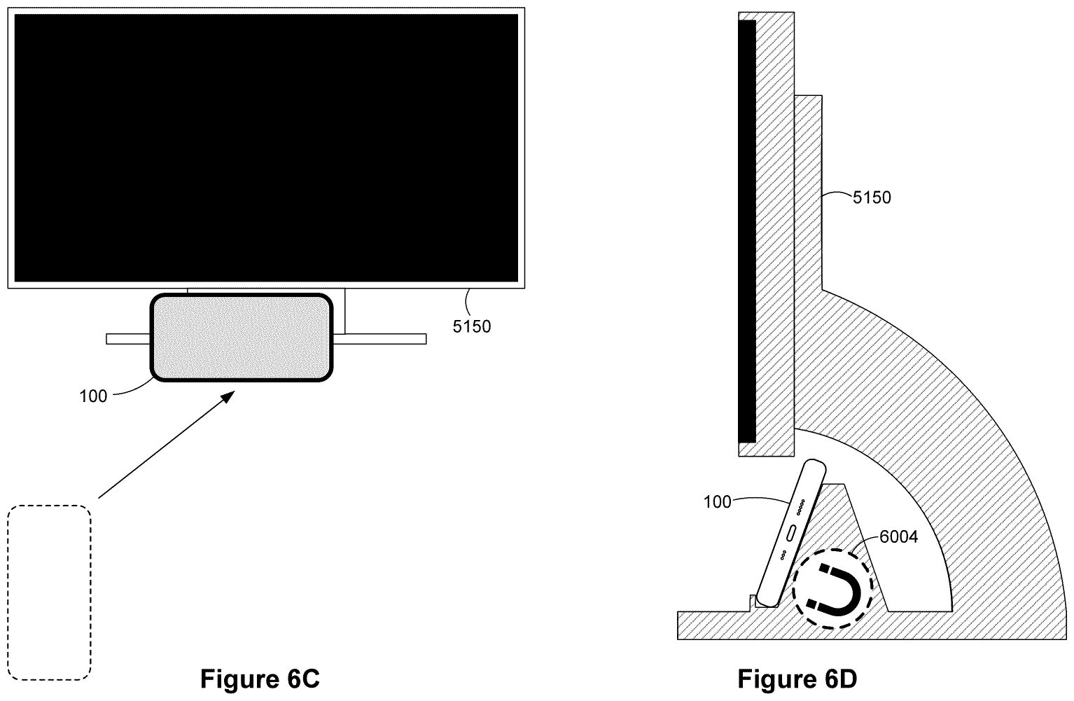

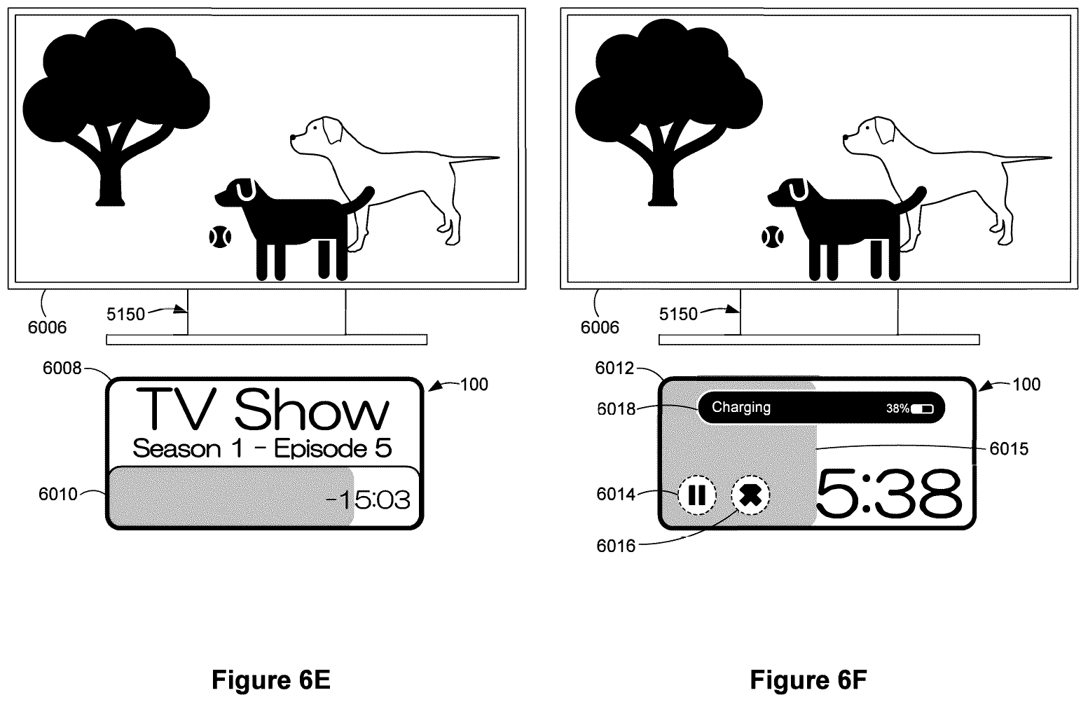

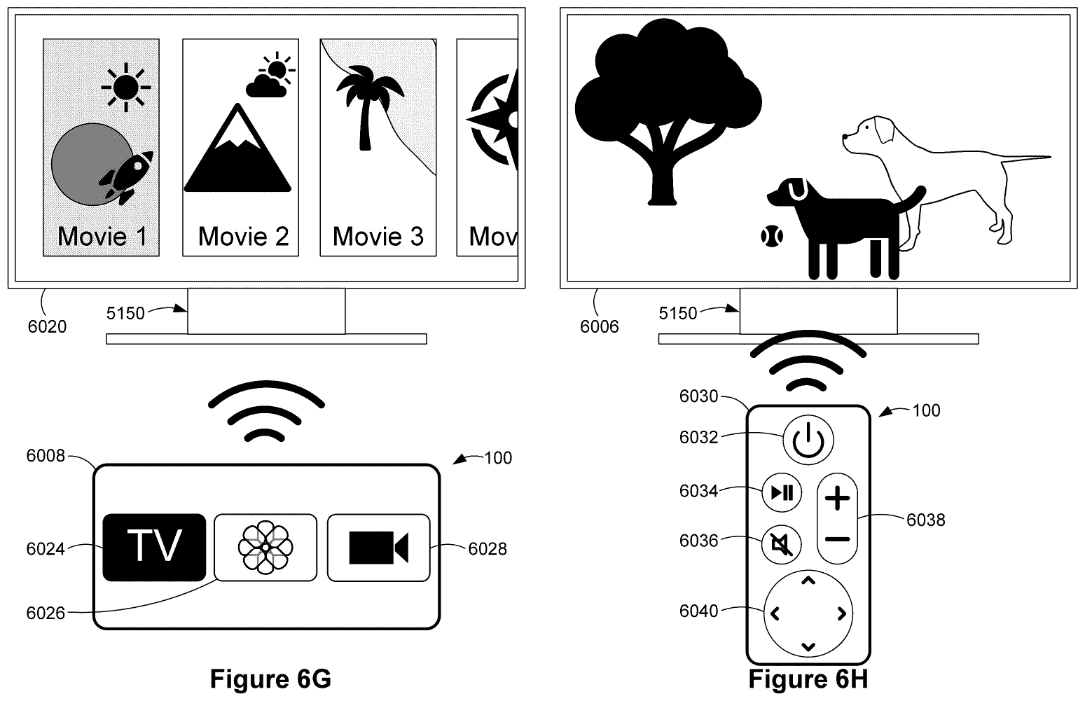

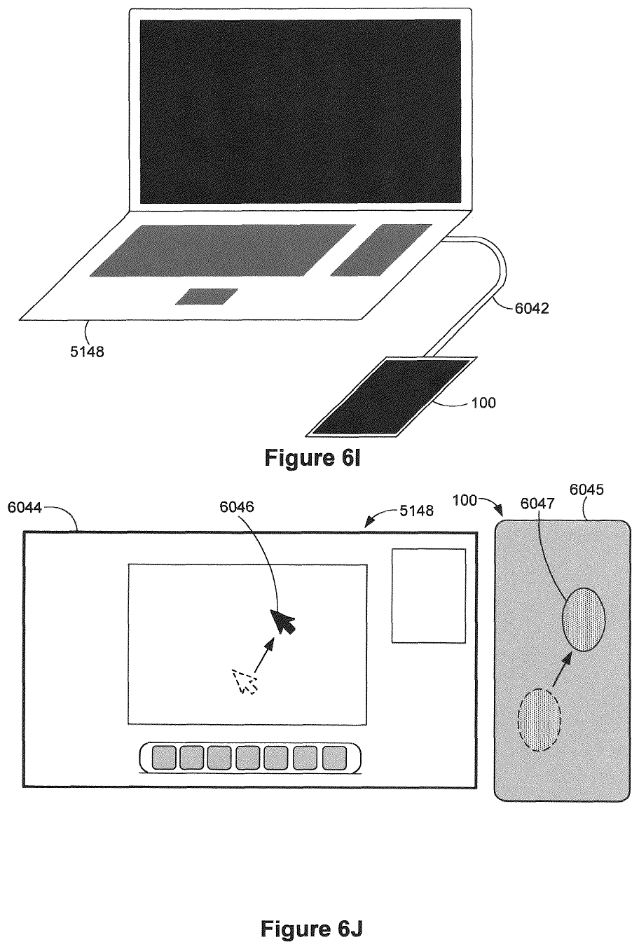

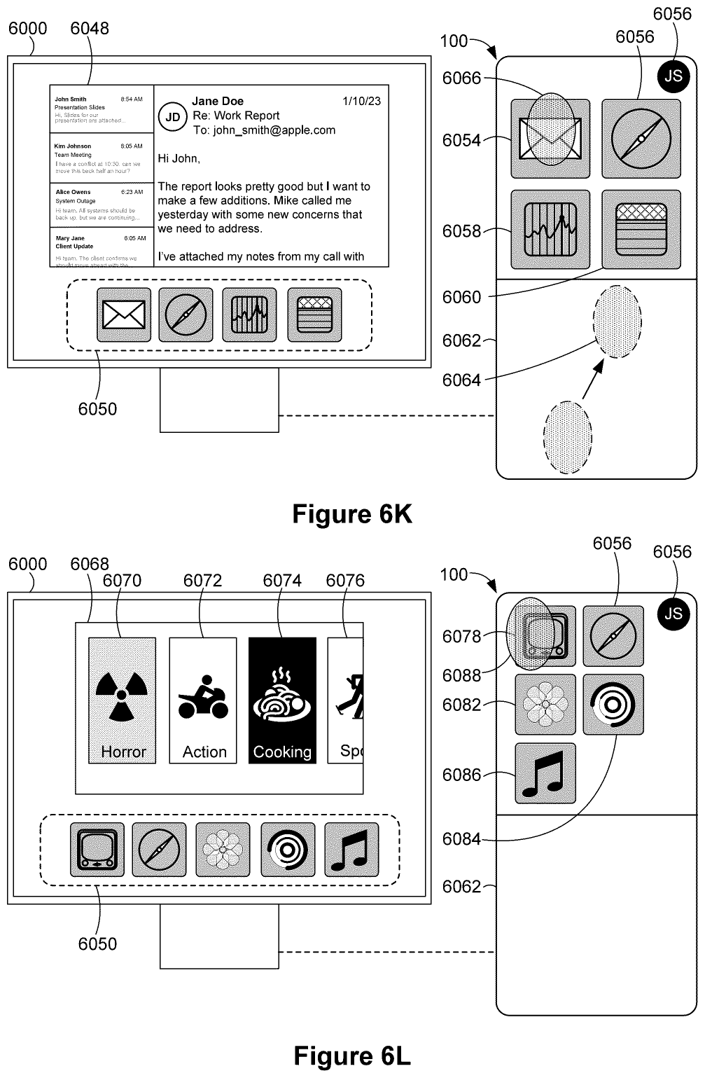

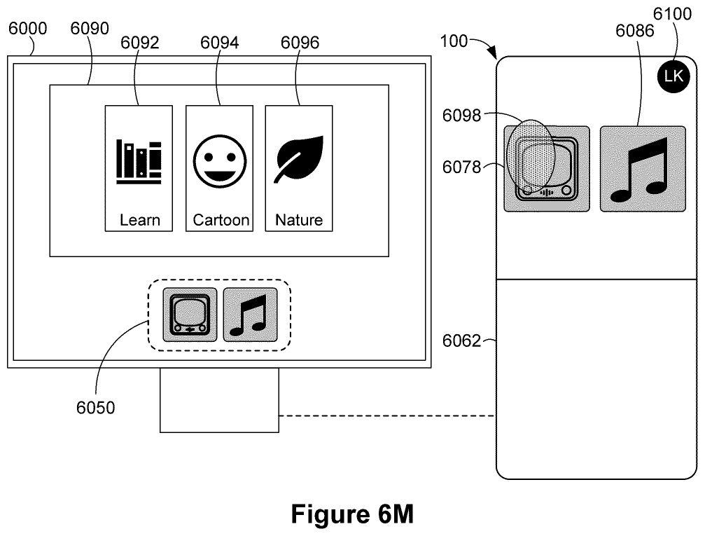

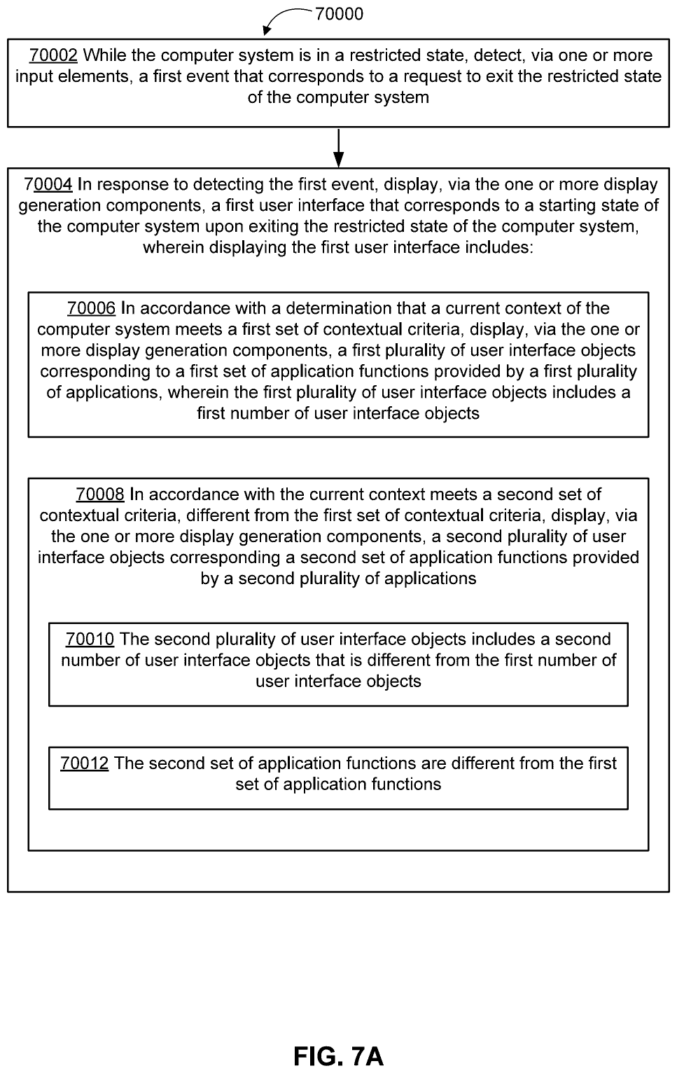

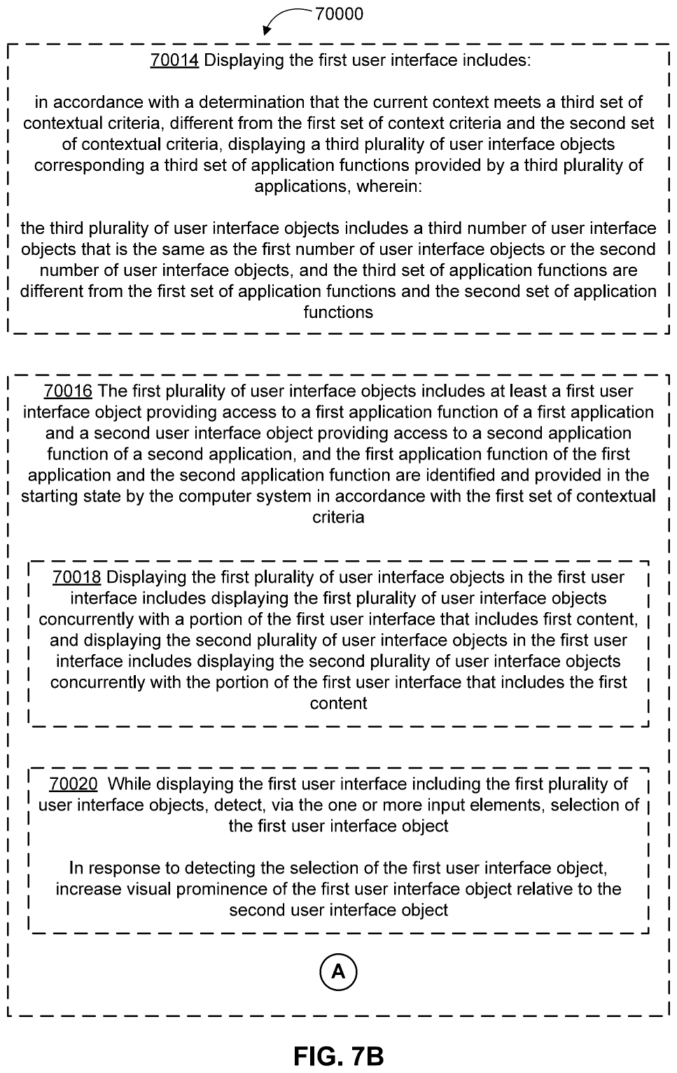

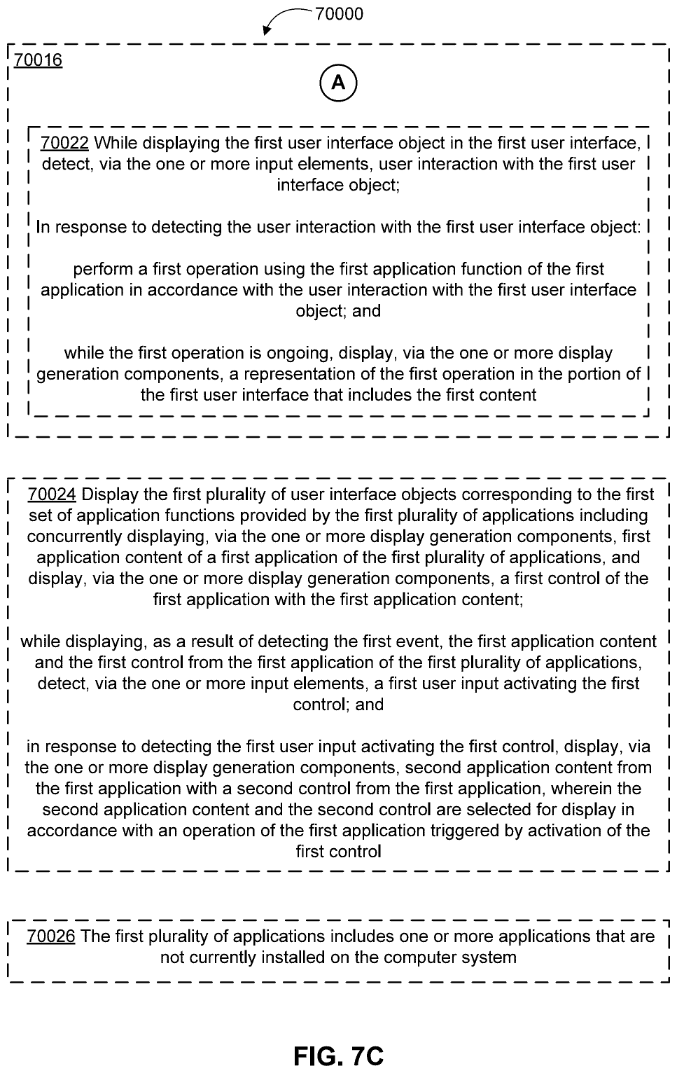

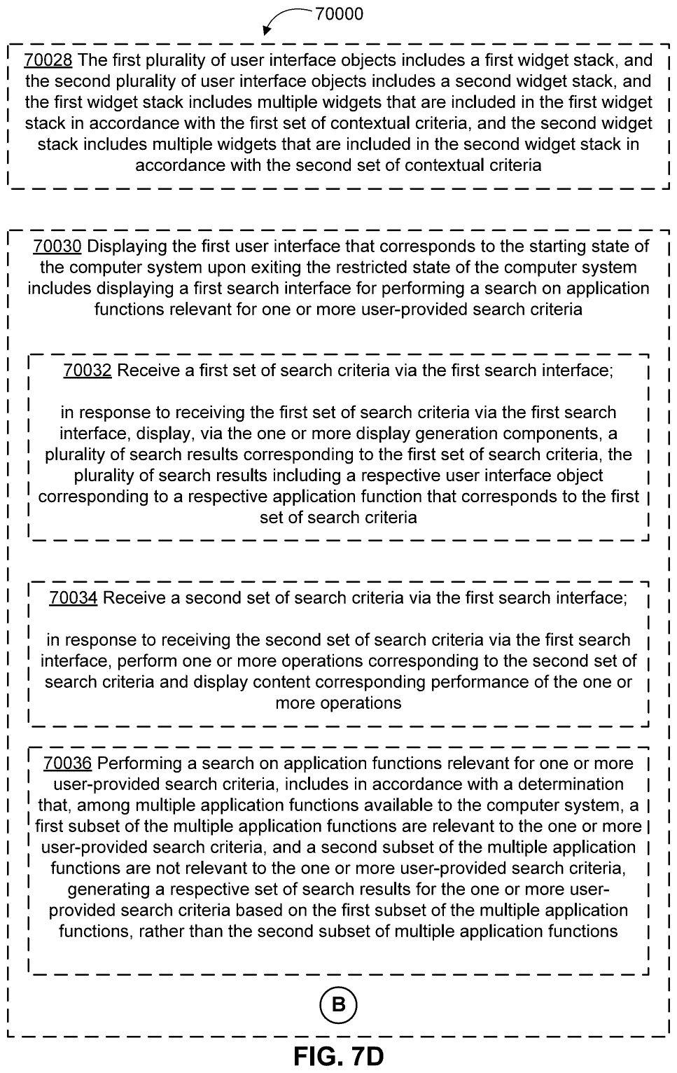

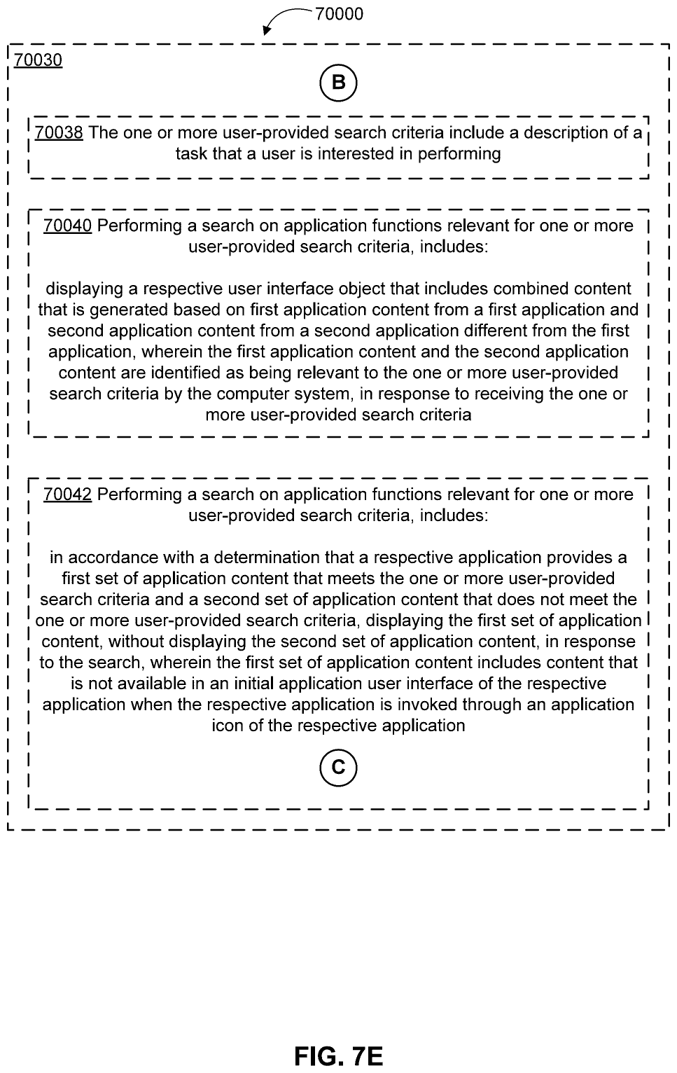

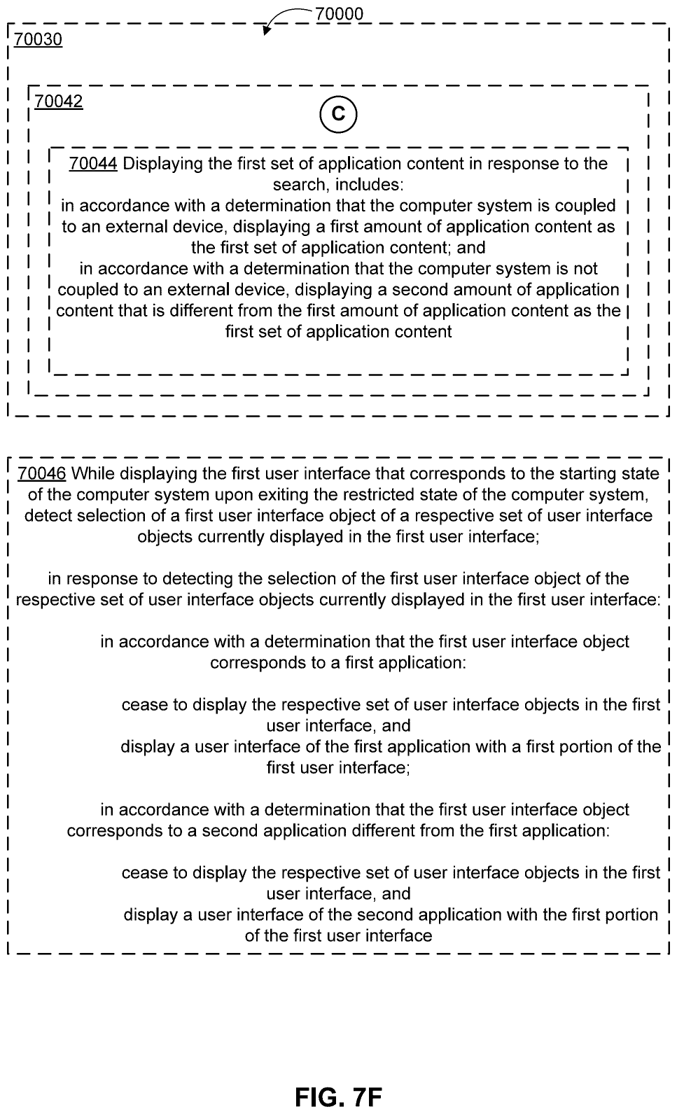

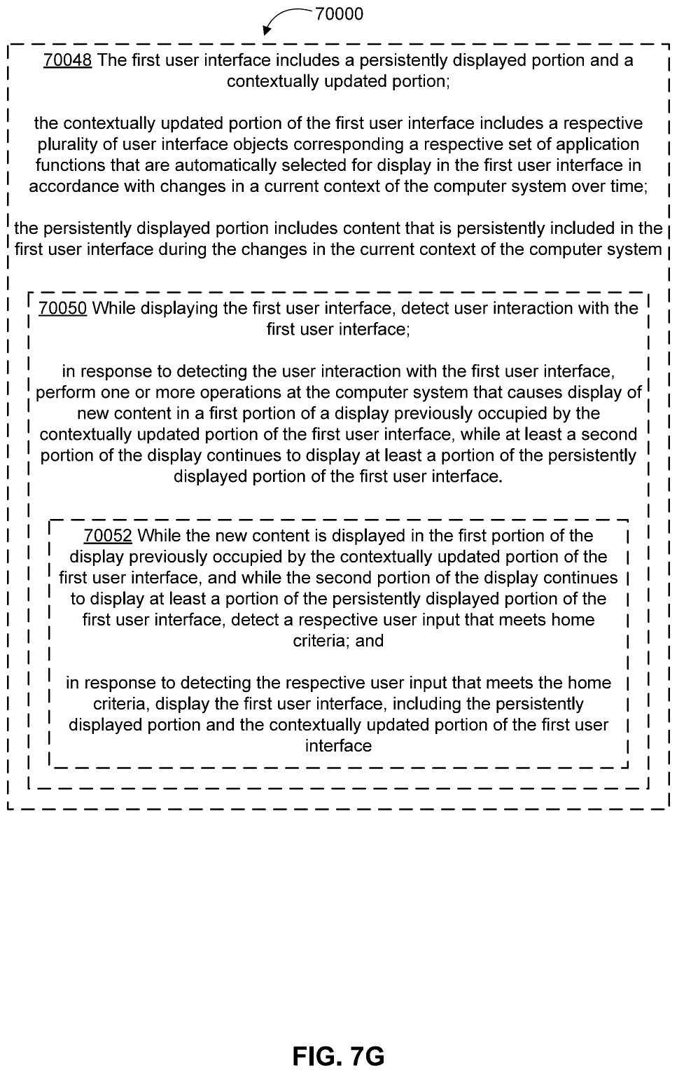

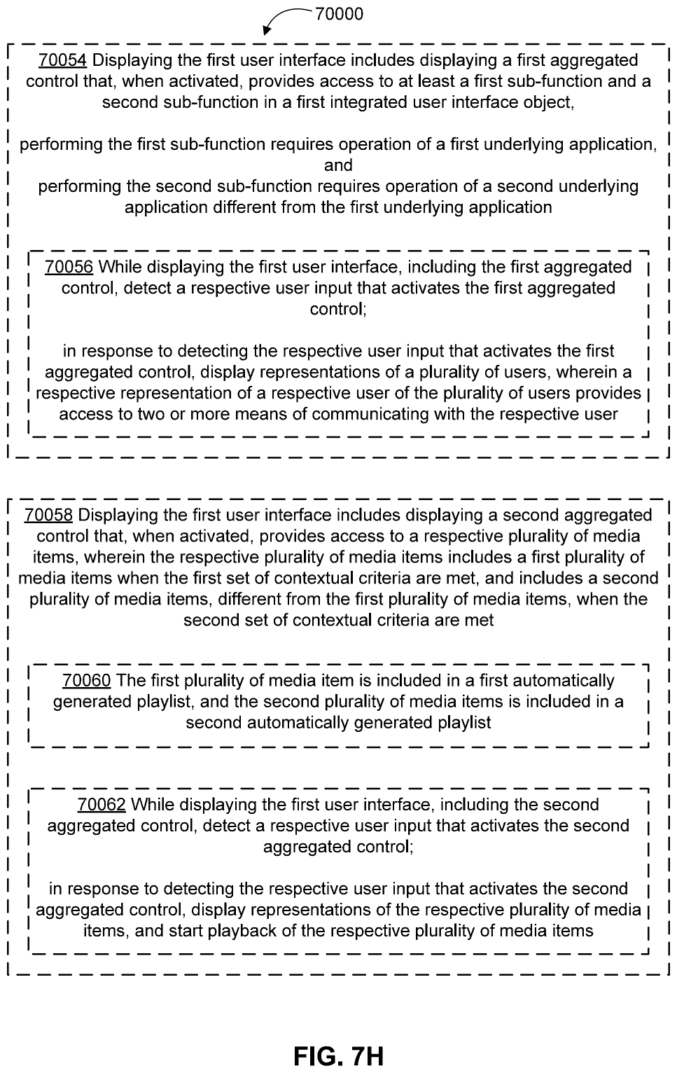

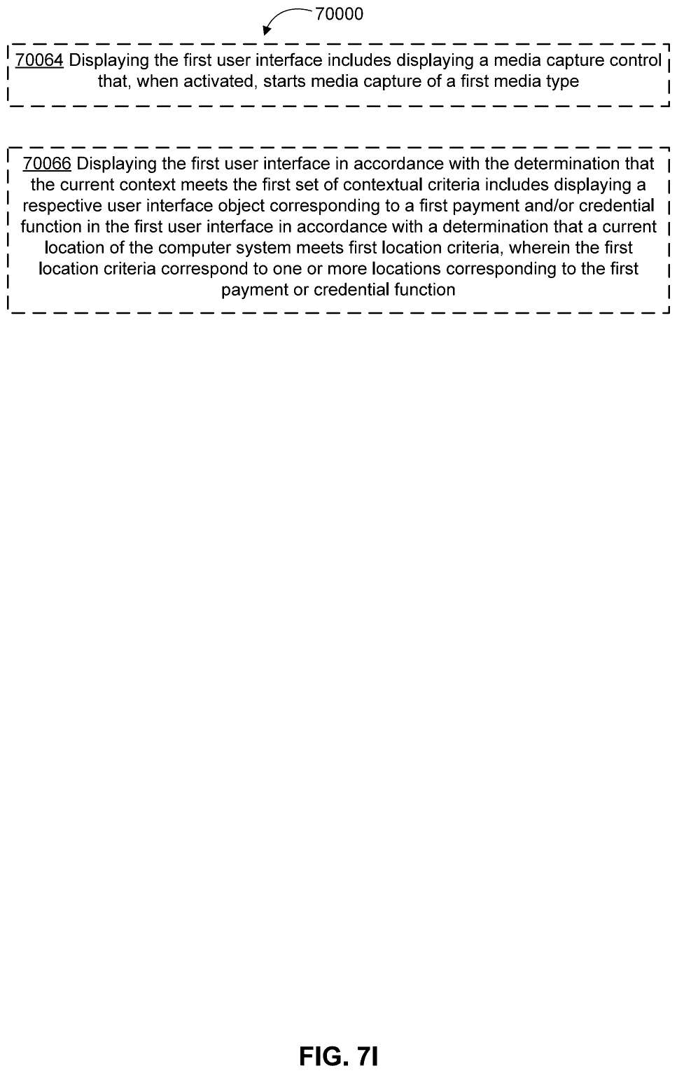

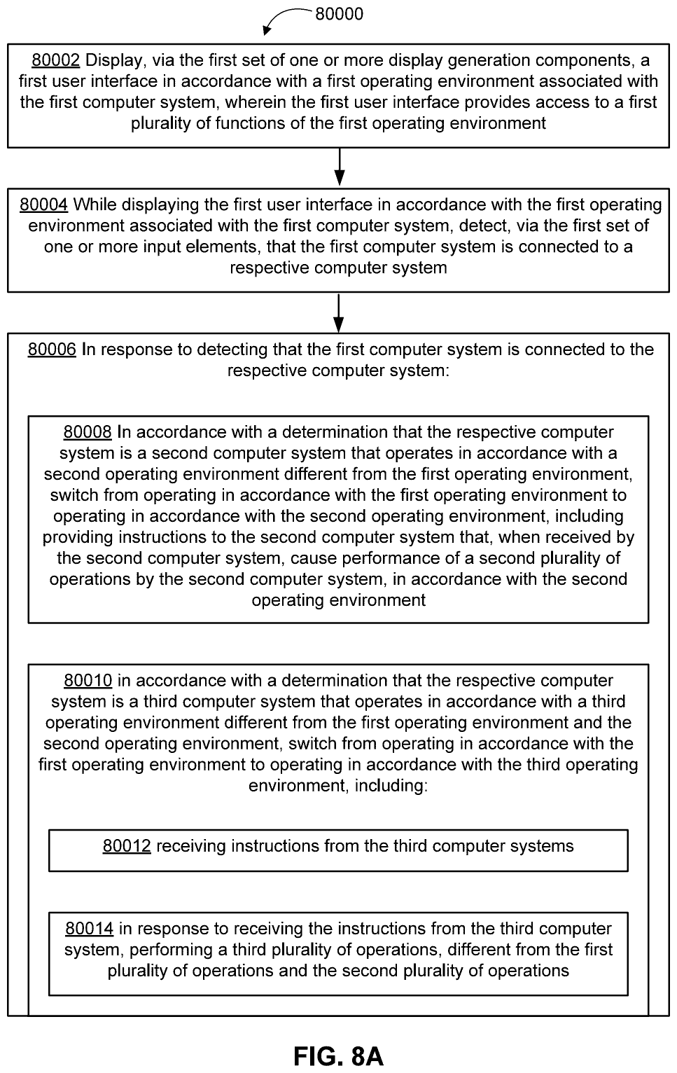

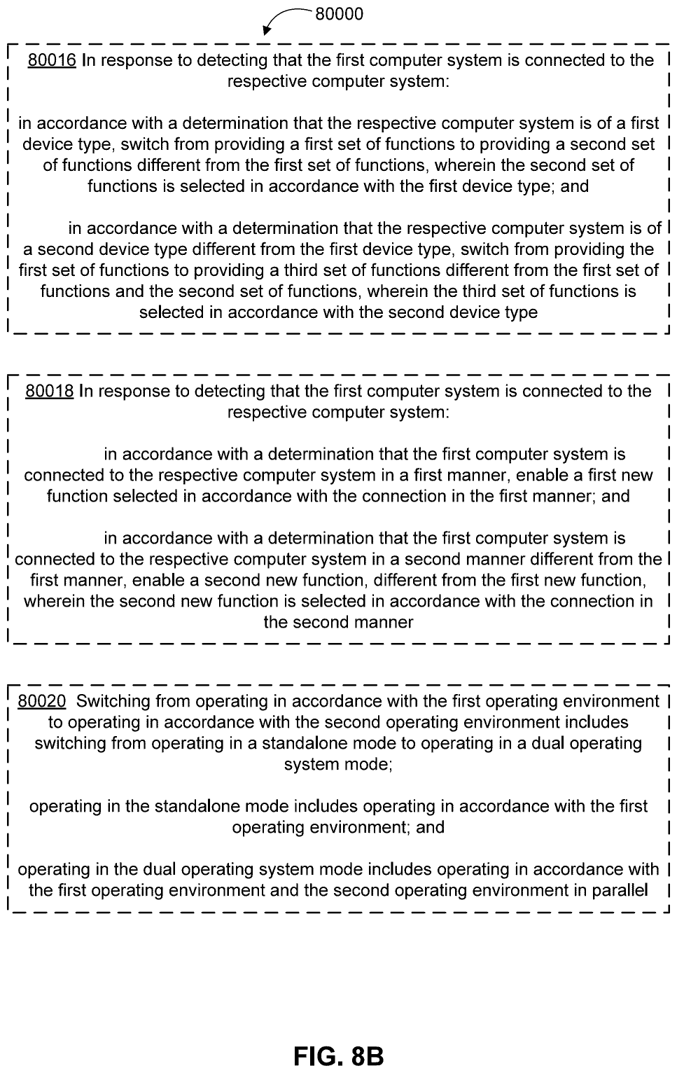

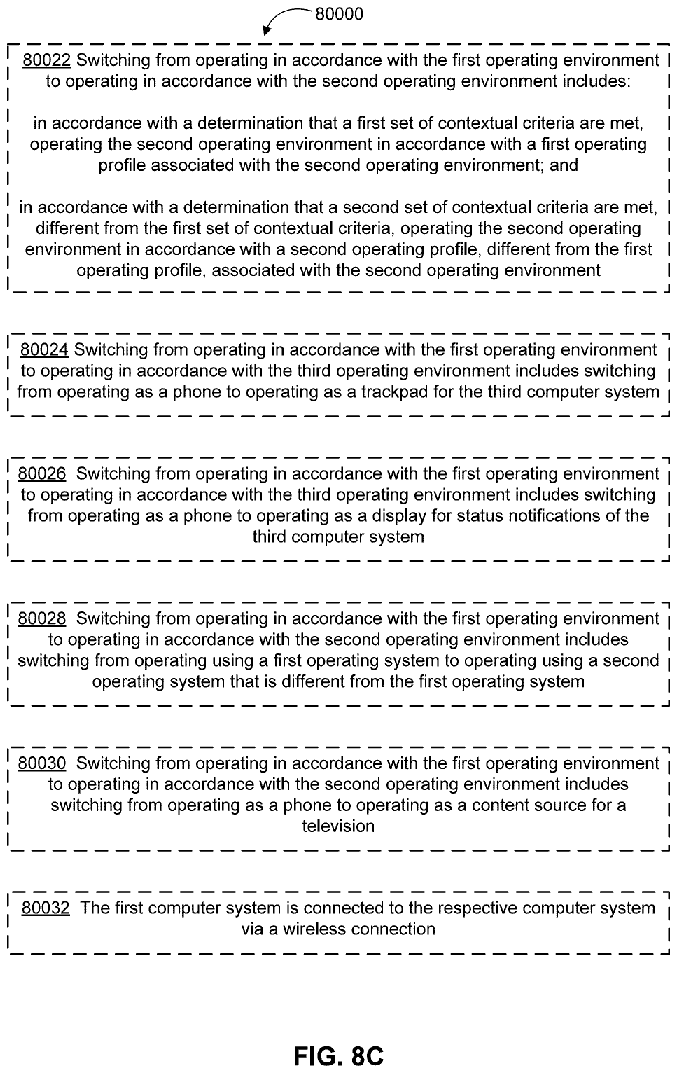

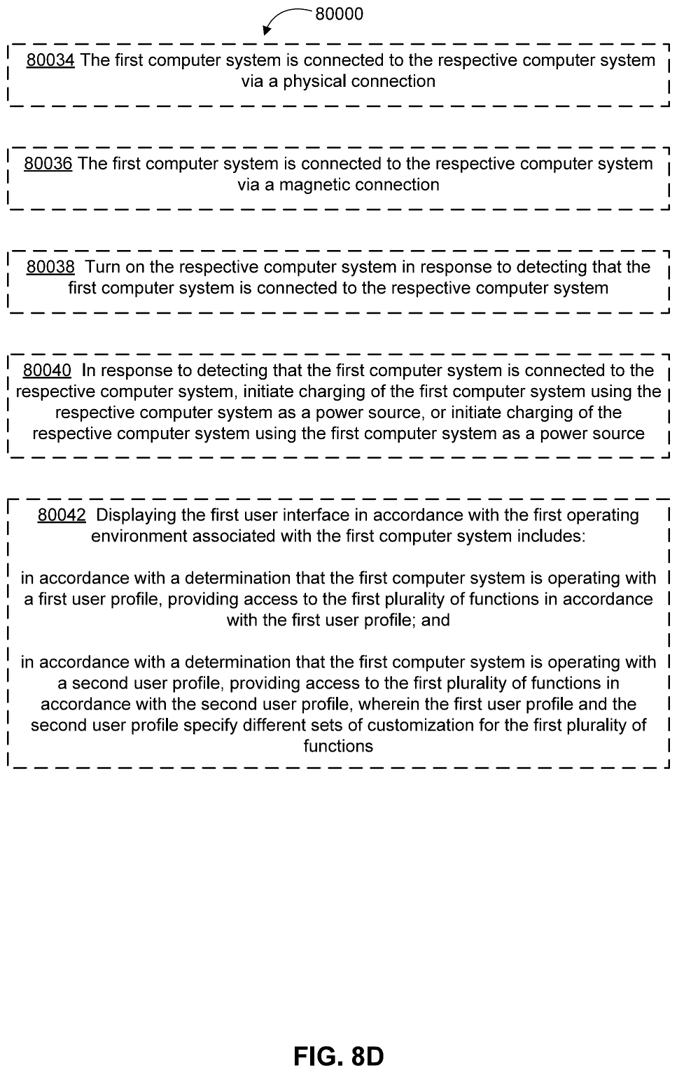

Below, FIGS. 1A-1B, 2, and 3A provide a description of example devices. FIGS. 3B-3G describe the use of Application Programming Interfaces (APIs) to perform operations. FIGS. 4A-4C2 and 5A-5AJ illustrate exemplary contextually-updated user interfaces and exemplary user interactions with said contextually-updated user interfaces, and FIGS. 6A-6M illustrate exemplary user interfaces and changes in function of a computer system, when the computer system is connected to different external computer systems, in accordance with various embodiments. FIGS. 7A-7I illustrate a flow diagram of a method for displaying and interacting with contextually-updated user interfaces, in accordance with some embodiments. FIGS. 8A-8D illustrate a flow diagram of a method for displaying different user interfaces and changing functions of a computer system, when connected to different external computer systems, in accordance with some embodiments. The user interfaces in FIGS. 5A-5AJ are used to illustrate the processes in FIGS. 7A-7I, and the user interfaces in FIGS. 6A-6M are used to illustrate the processes in FIGS. 8A-8D. In some embodiments, the features described with respect to FIGS. 5A-5AJ are applicable to the processes described with respect to FIGS. 8A-8D, and vice versa; and the features described with respect to FIGS. 6A-6M are applicable to the processes described with respect to FIGS. 7A-7I, and vice versa.

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices (and computer systems more generally), user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, a computer system in the form of an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of computer systems such as portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

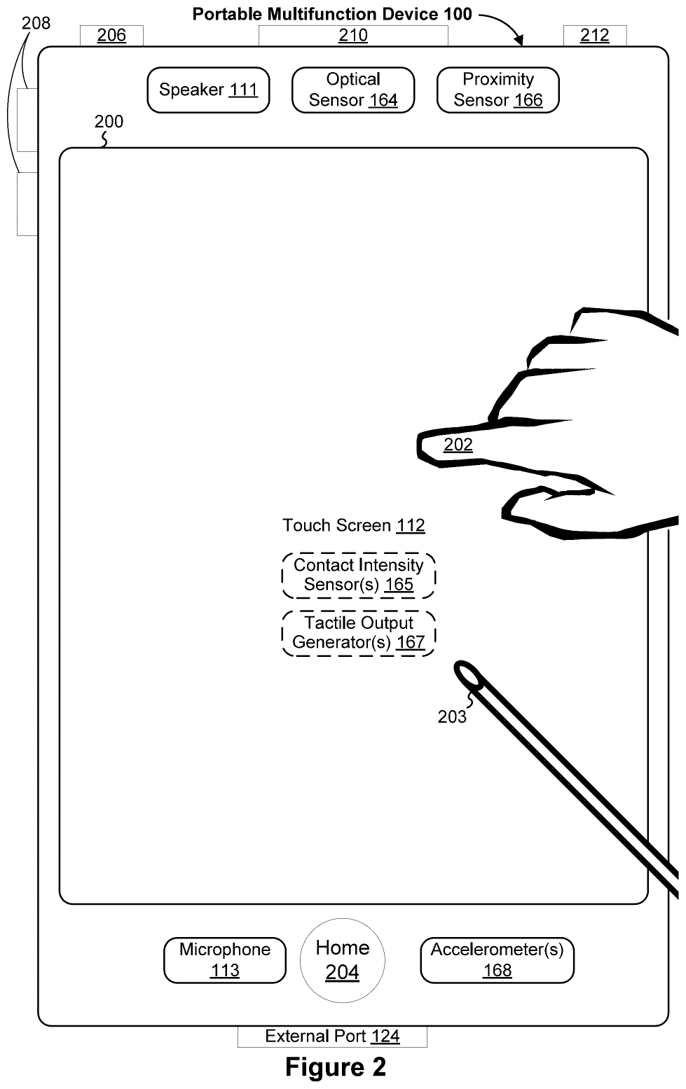

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button (e.g., a single button that rocks in opposite directions, or separate up button and down button) for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3A. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture is performed using a first hand of the user (e.g., a pinch input, a long pinch input, or a pinch and drag input), and, in conjunction with performing the pinch input using the first hand, a second pinch input is performed using the other hand (e.g., the second hand of the user's two hands). In some embodiments, movement between the user's two hands is performed (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture-which do not require that the intensity of the contact(s) meet a respective intensity threshold in order for the first gesture recognition criteria to be met—are in competition with second gesture recognition criteria for a second gesture-which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or.
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 370 (FIG. 3A) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display, or as a system gesture such as an upward edge swipe.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and/or docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3A is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API calling modules (e.g., including API-calling module 3180) that communicate with implementation module 3100. In some embodiments, API 3190 allows multiple API calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 70000 (FIGS. 7A-7I) and/or method 80000 (FIGS. 8A-8D) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-readable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, the example user interface shown in FIG. 4A is representative of a home screen user interface or a springboard user interface that is displayed when the portable multifunction device 100 exits a restricted state of the portable multifunction device 100. In some embodiments, instead of displaying the user interface for the menu of applications, portable multifunction device displays a contextual user interface in accordance with the methods and processes described with respect to FIGS. 5A-5AJ and FIGS. 7A-7I, and/or FIGS. 6A-6M and 8A-8D. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3A) with a touch-sensitive surface 451 (e.g., a tablet or touchpad 355, FIG. 3A) that is separate from the display 450. Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or the touch screen in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations, focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

In some embodiments, the response of the device to inputs detected by the device depends on criteria based on the contact intensity during the input. For example, for some “light press” inputs, the intensity of a contact exceeding a first intensity threshold during the input triggers a first response. In some embodiments, the response of the device to inputs detected by the device depends on criteria that include both the contact intensity during the input and time-based criteria. For example, for some “deep press” inputs, the intensity of a contact exceeding a second intensity threshold during the input, greater than the first intensity threshold for a light press, triggers a second response only if a delay time has elapsed between meeting the first intensity threshold and meeting the second intensity threshold. This delay time is typically less than 200 ms (milliseconds) in duration (e.g., 40, 100, or 120 ms, depending on the magnitude of the second intensity threshold, with the delay time increasing as the second intensity threshold increases). This delay time helps to avoid accidental recognition of deep press inputs. As another example, for some “deep press” inputs, there is a reduced-sensitivity time period that occurs after the time at which the first intensity threshold is met. During the reduced-sensitivity time period, the second intensity threshold is increased. This temporary increase in the second intensity threshold also helps to avoid accidental deep press inputs. For other deep press inputs, the response to detection of a deep press input does not depend on time-based criteria.

In some embodiments, one or more of the input intensity thresholds and/or the corresponding outputs vary based on one or more factors, such as user settings, contact motion, input timing, application running, rate at which the intensity is applied, number of concurrent inputs, user history, environmental factors (e.g., ambient noise), focus selector position, and the like. Example factors are described in U.S. patent application Ser. Nos. 14/399,606 and 14/624,296, which are incorporated by reference herein in their entireties.

FIGS. 4C1-4C2 illustrate an example state diagram 4000 of navigation between various user interfaces of the multifunction device 100 in accordance with some embodiments. In some embodiments, the multifunction device 100 displays a respective user interface from a plurality of different user interfaces, including a wake screen user interface 490 (also referred to as a coversheet user interface 496), a home screen user interface 492, a widget user interface 491, a control user interface 498, a search user interface 494, an application library user interface 497, and an application user interface 493 of a respective application (e.g., a camera application (e.g., camera application user interface 495), a flashlight application, a settings application, a messaging application (e.g., application user interface 493), a telephony application, a maps application, a browser application, or another type of application) of a plurality of applications. In some embodiments, the multifunction device operates in a standby mode that provides a simplified set of user interfaces and functions, when a set of conditions is met (e.g., device is charging, placed on a docking station, and/or is oriented in a landscape orientation).

In some embodiments, the multifunction device 100 does not display all of the user interfaces shown in FIGS. 4C1 and 4C2. For example, instead of displaying the home screen user interface 492 that includes a fixed arrangement of application icons and, optionally, widgets, the multifunction device 100 displays a contextual starting user interface that includes a set of user interface objects corresponding a set of contextually-selected application functions and device functions from a set of contextually-selected applications (e.g., including one or more system applications and/or one or more user applications), based on the current context. In another example, instead of displaying the home screen user interface 492, the multifunction device 100 displays a user interface that is configured based on the other computer system that is connected to the multifunction device 100. In some embodiments, the multifunction device 100 optionally can operate in a lightweight mode and a regular mode, and the user interfaces shown in FIGS. 4C1 and 4C2 correspond to the navigation in the regular mode, while the user interfaces shown in FIGS. 5A-5AJ correspond to the navigation in the lightweight mode. In some embodiments, the multifunction device 100 operates in only the lightweight mode in accordance with the methods and processes described in FIGS. 5A-5AJ and 7A-7I, when the multifunction device 100 is operating in the standalone mode, not connected to another device. In some embodiments, the multifunction device 100 operating in the lightweight mode in the standalone mode, can transition into operating in the regular mode when the multifunction device 100 is connected to another device, such as another multifunction device 100, a tablet computer, a desktop computer, a charging station, a stand, a dock, or other external devices. In some embodiments, when operating in the lightweight mode, the multifunction device 100 optionally do not display the widget user interface 491, the control user interface 498, the search user interface 494, the application library user interface 497, and the application user interface 493 of a respective application in the manner described in FIGS. 4C1-4C2. In some embodiments, when operating in the lightweight mode, the multifunction device 100 optionally does display at least some of the user interfaces shown in FIGS. 4C1-4C2, such as the control user interface 498, the search user interface 494, the application library user interface 497, and the application user interface 493 of a respective application in the manner described in FIGS. 4C1-4C2. In some embodiments, the standby mode is also available when the lightweight mode is the available or active mode of the computer system and multifunction device transitions into the standby mode from the wake screen (or a power-saving always-on screen) of the multifunction device 100 after certain criteria are met (e.g., a period of inactivity and the multifunction device is connected to a charging device).

FIGS. 4C1-4C2 illustrate the navigation states in the normal, non-standby mode, in accordance with some embodiments. In some embodiments, the multifunction device utilizes various portions of the display (e.g., touch-screen display 112, display 340 associated with a touch-sensitive surface, a head-mounted display, or another type of display) to display persistent content across multiple user interfaces. For example, in some embodiments, the display includes a dynamic status region 4002 (e.g., optionally, available in the regular mode and/or the lightweight mode) for displaying alerts, status updates, and/or current states for various subscribed and/or ongoing events, and/or for various application activities, in real-time or substantially real-time. In some embodiments, the display includes a static status region 4022 (e.g., optionally, available in the regular mode and/or the lightweight mode) for displaying status information for one or more system functions that is relatively stable over a period of time. In some embodiments, the dynamic status region 4002 changes (e.g., expands and/or shrinks) from a region that accommodate one or more hardware elements of the multifunction device (e.g., the camera lenses, microphone, and/or speakers). As described herein, although examples below are given with touch-gestures on a touch-screen display, similar functions can be implemented with a display that is associated with a touch-sensitive surface, where a location (e.g., a location on a top edge, a bottom edge, a left edge, a right edge, a top left portion, a bottom right portion, an interior portion, and/or another portion) on the touch-sensitive surface has a corresponding location (e.g., a location on a top edge, a bottom edge, a left edge, a right edge, a top left portion, a bottom right portion, an interior portion, and/or another portion) on the display (and/or on the user interface presented on the display). Furthermore, although the examples below are given with touch-gestures on a touch-screen display, similar functions can be implemented with a display that is associated with another type of input, such as a mouse inputs, a pointer inputs, gaze inputs (e.g., gazes with time and location characteristics that are directed to various portions of the displayed user interface and/or user interface elements) in conjunction with air gesture inputs (e.g., air tap, air swipe, air pinch, pinch and hold, pinch-hold and drag, and/or another type of air gestures). As described herein, although examples below are given with touch-gestures on a touch-screen display, similar functions can be implemented with a head-mounted display that displays the user interfaces in a three-dimensional environment and that is controlled with various input devices and sensors for detecting various types of user inputs (e.g., touch gestures, inputs provided by a pointer or controller, gaze inputs, voice inputs, and/or air gestures).

As shown in FIG. 4C1, when the multifunction device 100 is initially powered on (e.g., in response to a long press or other activation input 4100 on a power button 116a (FIG. 4A) of the multifunction device 100), the multifunction device displays (4100) the wake screen user interface 490 (e.g., optionally, available in the regular mode and/or the lightweight mode) that is the initially displayed system user interface of the multifunction device 100 when the multifunction device transitions from a power off state to a power on state, and/or from a power-saving state to a normal state.

In some embodiments, while the wake screen user interface 490 (e.g., optionally, available in the regular mode and/or the lightweight mode) is displayed after a period of time, the multifunction device 100 optionally transitions (4101) to a low power state, where the display of the multifunction device 100 is optionally turned off, or dimmed, as illustrated by user interface 489. In some embodiments, the wake screen user interface 490 remains displayed in a dimmed, always on state (e.g., optionally, with reduced user interface elements), while the multifunction device 100 is in the low power or power-saving state. For example, in the low power or power-saving state illustrated by user interface 489, the time indication and/or date indication continues to be displayed.

In some embodiments, the multifunction device 100 transitions (4101) into the low power state (e.g., turns off the display or displays the wake screen user interface 490 in the dimmed, always-on state) in response to activation of the power button 116a of the multifunction device 100 by a user input 4101 (e.g., while displaying the wake screen user interface 490, and/or any of the other user interfaces described herein).

In some embodiments, the multifunction device transitions (e.g., automatically after a period of inactivity, and/or in response to detecting a user input activating the power button 116a) into the low power state from the normal operating state in which any of a number of user interfaces (e.g., the wake screen user interface 490, the home screen user interface 492, the application user interface 493 of a respective application, or another system and/or application user interface) may be the last displayed user interface before the transition into the low power state.

In some embodiments, when the multifunction device 100 is in the low power state, the multifunction device continues to detect inputs via one or more sensors and input devices of the multifunction device (e.g., movement of the device, touch gestures (e.g., swipe, tap, or other touch input), gaze input, air gestures, impact on the device, press on the power button, rotation of a crown, or other types of inputs). In some embodiments, in response to detecting a user input via the one or more sensors and input devices of the multifunction device, the multifunction device transitions (4100) from the low power state to the normal operating state, and displays the wake screen user interface 490 (e.g., optionally, available in the regular mode and/or the lightweight mode) in a normal, undimmed state.

In some embodiments, when the multifunction device 100 is in the low power state illustrated in user interface 489, the multifunction device continues to detect events, such as arrival of notifications and status updates (e.g., notification for messages, incoming communication requests, and/or other application-generated events and system-generated events, and status updates for sessions, subscribed events, and/or other status changes that require the user's attention). In some embodiments, in response to detecting an event that generates an alert, a notification, and/or a status update, the multifunction device transitions from the low power state to the normal operating state, and displays the alert, notification, and/or status update on the wake screen user interface 490 (e.g., optionally, available in the regular mode and/or the lightweight mode) in the normal, undimmed state. In some embodiments, the multifunction device automatically returns to the low power mode after a short period of time after displaying the alert, notification, and/or the status update.

In some embodiments, the wake screen user interface 490 (e.g., optionally, available in the regular mode and/or the lightweight mode) displayed in the dimmed always-on state includes the same or substantially the same set of user interface elements as the wake screen user interface 490 (e.g., optionally, available in the regular mode and/or the lightweight mode) displayed in the normal operating state (e.g., as opposed to the dark screen shown in FIGs. 4C1 and 4C2). In some embodiments, the wake screen user interface 490 displayed in the dimmed, always-on state has fewer user interface elements than the wake screen user interface 490 displayed in the normal operating state. For example, in some embodiments, the wake screen user interface 490 displayed in the normal operating state includes a time element 4004 showing the current time, a date element 4006 showing the current date, one or more widgets 4008 that include content from respective applications that is updated from time to time without user intervention. In some embodiments, the wake screen user interface 490 displayed in the normal operating state includes one or more application icons corresponding to respective applications, such as an application icon 4010 for the flashlight application, an application icon 4012 for the camera application, or another system-recommended or user selected application. In some embodiments, the wake screen user interface 490 displayed in the normal operating state includes one or more shortcuts for accessing respective operations in one or more system-recommended and/or user-selected applications (e.g., shortcuts to play music using a media player application, to send a quick message using the messaging application, or turn on the DND or sleep mode using a system application). In some embodiments, the wake screen user interface 490 includes the dynamic status region 4002 that displays status updates or current state of an ongoing activity for one or more applications, such as a communication session, a charging session, a running timer, music playing session, delivery updates, navigation instructions, location sharing status, and/or status updates for subscribed application and system events. In some embodiments, the wake screen user interface 490 includes the static status region 4022 that displays status for one or more system functions, such as the network connection status, battery status, location sharing status, cellular signal and carrier information, and other system status information. In some embodiments, a dynamic status update (e.g., battery charging, screen recording, location sharing, and other status updates) is displayed in the dynamic status region 4002 first, and then moved to the static status region 4022 after a period of time. In some embodiments, in a dimmed always on state, the wake screen user interface 490 omits the dynamic status region 4002, static status region 4022, the application icons 4010 and 4012, and/or the shortcuts for application and/or system operations, and optionally disables interaction with remaining user interface elements (e.g., the wallpaper, the time element 4004, the date element 4006, and/or the widgets 4008) of the wake screen user interface 490.

In some embodiments, the wake screen user interface (e.g., optionally, available in the regular mode and/or the lightweight mode) includes one or more recently received notifications (e.g., notifications 4016, or other newly received notification(s)) that correspond to one or more applications. In some embodiments, the wake screen user interface displayed in the dimmed always on state transitions into the wake screen user interface 490 in response to detecting receipt or generation of a new notification (e.g., notification 4018, FIG. 4C2, or another one or more newly received notification(s)). In some embodiments, the notifications 4016 are grouped or coalesced based on event types and/or applications corresponding to the notifications. In some embodiments, user can interact with the notifications to dismiss the notifications, sent the notifications to notification history, and/or expand the notifications to see additional notification content (e.g., optionally after valid authentication data has been requested and/or obtained). In some embodiments, the notifications displayed in the wake screen user interface may, at various times, include un-summarized notifications where the notification content of an un-summarized notification includes application content corresponding to a respective event that triggered the notification, without including a summary of the application content, and/or summaries of notifications, where the summary content of a summary for a single event includes automatically generated summary of application content corresponding to a respective event that triggered the notification, and the summary of multiple related events includes automatically generated summary of application content corresponding to multiple related events that triggered multiple notifications.

In some embodiments, the wake screen user interface 490 (e.g., optionally, available in the regular mode and/or the lightweight mode) may be displayed while the multifunction device is in a locked state or an unlocked state. In some embodiments, when the wake screen user interface 490 is displayed while the multifunction device is in the locked state, a locked symbol 4020a is optionally displayed in the status region (e.g., dynamic status region 4002, static status region in the upper right corner of the display) or elsewhere (e.g., below the dynamic status region 4002, in the upper left corner, or in another portion of the display) in the wake screen user interface 490 to indicate that the multifunction device is in the locked state (e.g., shown in wake screen user interface 490 in FIG. 4C1), and that authentication data is required to dismiss the wake screen user interface 490 to navigate to the home screen user interface 492 or last-displayed application user interface. In some embodiments, the multifunction device automatically attempts to obtain authentication data via biometric scan (e.g., facial, fingerprint, voiceprint, and/or iris) when the wake screen user interface 490 is displayed (e.g., in the low power state, and/or the normal operating state), and automatically transitions into the unlocked state if valid authentication data is successfully obtained. In some embodiments, in conjunction with transitioning into the unlocked state, the multifunction device replaces the locked symbol 4020a with an unlocked symbol 4020b to indicate that the multifunction device is now in the unlocked state (e.g., shown in wake screen user interface 490 in FIG. 4C2).

In some embodiments, the multifunction device allows user interaction with the user interface elements of the wake screen user interface 490 when the wake screen user interface 490 is displayed in the normal operating mode.

For example, in some embodiments, selecting (e.g., by tapping, clicking, and/or air tapping) on a user interface element, such as one of the widgets 4008, status region 4002, notification 4018, and/or application icons 4010 or 4012, causes the multifunction device to navigate away from the wake screen user interface 490 and displays a respective user interface of the application that corresponds to the selected user interface element, or an enlarged version of the user interface element to show additional information and/or controls related to the initially displayed content in the selected user interface element. For example, as shown in FIG. 4C2, in response to a user input 4113 selecting message notification 4018, the computer system displays (4113) the application user interface 493 for the messaging application.

In another example, in some embodiments, an enhanced selection input 4112 (e.g., a touch and hold gesture, a light press input, or another type of input) on a respective user interface element, such as the time element 4004, the date element 4006, or a wallpaper of the wake screen user interface 490, causes the multifunction device to display a configuration user interface for configuring one or more aspects of the wake screen user interface 490 (e.g., selecting a wallpaper, configuring a color or font scheme of the user interface element, configuring how to layout the different elements of the wake screen user interface, configuring additional wake screen, selecting a previously configured wake screen, and view additional customization options for the wake screen user interface). In some embodiments, configuration of the wake screen user interface 490 is partially applied to the home screen user interface 492, and vice versa.

In some embodiments, an enhanced selection input (e.g., a touch and hold gesture, a light press input, or another type of input) on the flashlight application icon 4010 or the camera application icon 4012 causes the multifunction device to activate the flashlight of the multifunction device or display the camera user interface 495 of the camera application. For example, in response to detecting selection input 4104a on the camera application icon 4012 in the wake screen user interface 490, the multifunction device activates the camera application and displays (4104a) the camera application UI 495 (e.g., as shown in FIG. 4C1).

In some embodiments, if the multifunction device detects user interaction with the user interface elements shown in the wake screen user interface 490 and determines that the wake screen user interface is in the locked state, the multifunction device attempts to obtain authentication data from the user by displaying an authentication user interface (e.g., a passcode entry interface, a password entry user interface, and/or a biometric scan user interface). The multifunction device proceeds to navigate away from the wake screen user interface 490 and performs the operation in accordance with the user's interaction after valid authentication data has been obtained from the user.

In some embodiments, in addition to performing operations (e.g., navigating to application user interfaces, displaying expanded versions of user interface elements that show additional information, and/or displaying configuration options for a respective user interface element or the wake screen user interface), the multifunction device allows the user to navigate from the wake screen user interface 490 to other user interfaces (optionally, after valid authentication data has been obtained) in response to navigation inputs (e.g., swipe gestures or other types of navigation inputs that are directed to regions of the wake screen user interface that are not occupied by a user interface element, and/or regions of the wake screen user interface that are occupied by user interface element (e.g., widgets, application icons, and/or time elements) that do not respond to swipe gestures or said other types of navigation inputs).

For example, in some embodiments, an upward swipe gesture 4105 that starts from the bottom edge of the wake screen user interface 490 causes (4105) the multifunction device to navigate away from the wake screen user interface 490 and display the home screen user interface 492 or the last-displayed application user interface (optionally, after requesting and obtaining valid authentication data), in the regular mode as opposed to the lightweight mode of the multifunction device. In some embodiments, when the multifunction device is operating in the lightweight mode, or if the lightweight mode is the only active mode of the multifunction device (e.g., when the multifunction device is operating in the standalone mode and not connected to another device that changes the operating mode of the multifunction device), an upward swipe gesture that starts from the bottom edge of the wake screen user interface 490 causes the multifunction device to navigate away from the wake screen user interface 490 and display a contextual user interface that includes user interface objects corresponding to contextually selected subsets of application functions and/or device functions from contextually selected applications, as shown in FIGS. 5E and 5F, for example.

In some embodiments, the upward swipe gesture 4105 is a representative example of a home gesture or dismissal gesture (e.g., other examples include upward swipe gestures 4103a, 4103c, 4103d, 4103e, 4110a, and 4111a) that causes the multifunction device to dismiss the currently displayed user interface (e.g., the wake screen user interface 490, an application user interface (e.g., camera user interface 495, messages user interface 493, or another application user interface), the control user interface 498, the search user interface 494, the application library user interface 497, or the home screen configuration user interface) and navigate to the home screen user interface 492 or a last-displayed user interface (e.g., the wake screen user interface 490, the wake screen configuration user interface, the search user interface 494, an application user interface, or the home screen user interface 492) if the multifunction device is operating in the regular mode, or navigate to the contextual user interface if the multifunction device is operating in the lightweight mode.

In some embodiments, a downward swipe from a top edge (e.g., the central portion of the top edge, or any portion of the top edge) or an interior region of the wake screen user interface 490 (e.g., downward swipe 4106a, or another downward swipe) causes (4106a) the multifunction device to display the search user interface 494 that includes a search input region 4030 and one or more applications icons 4032 for recommended applications (e.g., recently used applications, and/or relevant applications based on the current context), as shown in FIG. 4C1. In some embodiments, in response to detecting a search input in the search input region 4030, the multifunction device retrieves and displays search results that include relevant application content (e.g., messages, notes, media files, and/or documents) from the different applications that are installed on the multifunction device, relevant applications (e.g., applications that are installed on the multifunction device and/or applications that are available in the app store), relevant webpages (e.g., bookmarked webpages and/or webpages newly retrieved from the Internet), and/or search results from other sources (e.g., news, social media platforms, and/or reference websites). In some embodiments, different sets of search results are provided depending on the locked and unlocked state of the multifunction device, and more details or additional search results may be displayed if the multifunction device is in the unlocked state when the search is performed. In some embodiments, the multifunction device attempts to obtain valid authentication data in response to receiving the search input, and displays different sets of search results depending on whether valid authentication data is obtained. In some embodiments, an upward swipe gesture 4103d that starts from the bottom edge of the search user interface (or another type of dismissal input) causes (4103d) the multifunction device to dismiss the search user interface 494 and redisplays the wake screen user interface 490 (e.g., since the wake screen user interface was the last displayed user interface), as shown in FIG. 4C1. In some embodiments, in response to a downward swipe 4106b from an interior region of the home screen user interface 492 causes (4106b) the multifunction device to display the search user interface 494; and in response to a subsequent upward swipe gesture 4103d from the bottom edge of the search user interface 494, the home screen user interface 492 is (4103d) redisplayed (e.g., since the home screen user interface was the last displayed user interface), as shown in FIG. 4C1.

In some embodiments, as shown in FIG. 4C1, a rightward swipe gesture 4102a that starts from a left edge or interior region of the wake screen user interface 490 causes (4102a) the multifunction device to navigate from the wake screen user interface 490 to a widget user interface 491 (or another system user interface other than the home screen user interface, such as a control user interface, a search user interface, or a notification history user interface). In some embodiments, the widget user interface 491 includes a plurality of widgets 4026 (e.g., including widget 4026a, widget 4026b and widget 4026c) that are automatically selected by the operating system and/or selected by the user for inclusion in the widget user interface 491. In some embodiments, the widgets 4026 displayed in the widget user interface 491 have form factors that are larger than the widgets 4008 displayed under the time element 4004 in the wake screen user interface 490. In some embodiments, the widgets 4026 displayed in the widget user interface 491 and the widgets 4008 displayed in the wake screen user interface 490 are independently selected and/or configured from each other. In some embodiments, the widgets 4026 in the widget user interface 491 include content from their respective applications and the content is automatically updated from time to time as the updates to the content becomes available in the respective applications. In some embodiments, selection of a respective widget (e.g., tapping on the respective widget, or providing other selection input directed to the respective widget) in the widget user interface causes the multifunction device to navigate away from the widget user interface 491 and displays a user interface of the application that corresponds to the respective widget (optionally, after valid authentication data is requested and/or obtained).

In some embodiments, an upward swipe gesture 4103a that starts from the bottom edge of the widget user interface 491 and/or a leftward swipe gesture 4103b that starts from the right edge or the interior region of the widget user interface 491 causes (4103a-1/4103b-1) the multifunction device to dismiss the widget user interface 491 and redisplay the wake screen user interface 490, as shown in FIG. 4C1.

In some embodiments, a leftward swipe gesture 4104b that starts from the right edge or interior portion of the wake screen user interface 490 causes (4104b) the multifunction device to navigate from the wake screen user interface 490 to a camera user interface 495 of the camera application (optionally, available in the regular mode, and/or the lightweight mode). In some embodiments, access to the photo library through the camera application is restricted in the camera user interface 495 unless valid authentication data has been obtained. In some embodiments, as shown in FIG. 4C1, an upward swipe gesture 4103c that starts from the bottom edge of the camera user interface 495 or another dismissal input causes (4103c) the multifunction device to navigate away from the camera user interface 495 and redisplay the wake screen user interface 490 (e.g., since the wake screen user interface 490 is the last displayed user interface prior to displaying the camera user interface 495).

In some embodiments, a downward swipe gesture 4109a that starts from the right portion of the top edge of the wake screen user interface (e.g., as illustrated in FIG. 4C2) causes (4109a) the multifunction device to display the control user interface 498 optionally, available in the regular mode, and/or the lightweight mode) overlaying or replacing display of the wake screen user interface 490. In some embodiments, the control user interface 498 includes status information for one or more static status indicators displayed in the static status region 4022, and respective sets of controls 4028 (e.g., including control 4028a, control 4028b, and control 4028c) for various system functions, such as network connections (WiFi, cellular data, airplane mode, Bluetooth, and other connection types), media playback controls, display controls (e.g., display brightness, color temperature, night shift, true tone, and dark mode controls), audio controls (e.g., volume, and/or mute/unmute controls, focus mode controls (e.g., DND, work, study, sleep, and other modes in which generation of alerts and notifications are moderated based on context and configurations, and application icons (e.g., flashlight, timer, calculator, camera, screen recording, and/or other user-selected or system recommended applications))). In some embodiments, an upward swipe gesture 4110a that starts from the bottom edge of the control user interface 498 (or another dismissal input) causes the multifunction device to dismiss the control user interface 498 and redisplay (4110a-1) the wake screen user interface 490 (e.g., since the wake screen user interface 490 is the last displayed user interface prior to displaying the control user interface 498).

In some embodiments, an upward swipe gesture 4107 that starts from the interior region of the wake screen user interface 490 and/or an upward swipe gesture that starts from the interior of the coversheet user interface 496 (e.g., optionally, when there are no unread notifications displayed in the coversheet user interface) causes (4107) the multifunction device to display the notification history user interface that includes a plurality of previously saved notifications and notifications that have been sent directly to notification history without first being displayed on the wake screen user interface 490. In some embodiments, the notification history user interface (optionally, available in the regular mode, and/or the lightweight mode) can be scrolled to reveal additional notifications in response to an upward swipe gesture 4118 directed to the notification history in the wake screen user interface 490 and/or the coversheet user interface 496. In some embodiments, the notification history is displayed as part of the wake screen user interface 490 and/or coversheet user interface 496, and a downward swipe gesture 4103f that is directed to the interior portion of the notification history causes the notification history to cease to be displayed and causes the wake screen user interface 490 and/or coversheet user interface 496 to be redisplayed without the notification history.

As described above, after navigating from the wake screen user interface 490 to a respective user interface other than the home screen user interface (e.g., in response to a swipe gesture in the downward, leftward, or rightward directions), an upward swipe gesture 4103 (e.g., 4103a, and 4103c through 4103f) that starts from a bottom edge of the respective user interface (e.g., an upward swipe gesture that starts from the bottom edge of the touch-sensitive display that displays a respective user interface in full screen mode, or an upward swipe gesture that starts from the bottom edge of a touch-sensitive surface that corresponds to the display that displays the respective user interface) causes the multifunction device to dismiss the respective user interface and returns to the wake screen user interface 490. In contrast, an upward swipe gesture 4105 that starts from the bottom edge of the wake screen user interface 490 causes (4105) the multifunction device to navigate away from the wake screen user interface 490 and displays the home screen user interface 492 or contextual user interface of the lightweight mode, and another upward swipe gesture that starts from the bottom edge of the home screen user interface 492 or contextual user interface of the lightweight mode does not cause the multifunction device to dismiss the home screen user interface 492 or the contextual user interface in the lightweight mode and return to the wake screen user interface 490. In other words, once the navigation from the wake screen user interface 490 to the home screen user interface 492 or the contextual user interface of the lightweight mode is completed, the multifunction device is no longer in the restricted state, and access to the application icons displayed on the home screen user interface 492, access to the application functions to the contextual user interface of the lightweight mode, and access to the content and functions of the computer system are unrestricted to the user. The upward swipe gesture that starts from the bottom edge of the currently displayed user interface is a representative example of a dismissal input that dismisses the currently displayed user interface and redisplays the last displayed user interface. The upward swipe gesture that starts from the bottom edge of the currently displayed user interface is also a representative example of a home gesture that dismisses the currently displayed user interface and displays the home screen user interface of the regular mode or the contextual user interface of the lightweight mode (e.g., irrespective of whether the home screen user interface of the regular mode or the contextual user interface of the lightweight mode was the last displayed user interface prior to displaying the currently displayed user interface).

As shown in FIG. 4C2, once the multifunction device navigates away from the wake screen user interface 490 and displays the home screen user interface 492 or the contextual user interface of the lightweight mode, the user can access the functions and applications of the multifunction device without restriction. For example, in some embodiments, the home screen user interface 492 of the regular mode includes multiple pages, and a respective page of the home screen user interface includes a respective set of application icons and/or widgets corresponding to different applications, and user selection of (e.g., by tapping on, clicking on, or otherwise selecting) a respective widget or application icon causes the multifunction device to display an application user interface of the application that corresponds to the respective widget or application icon.

In some embodiments, the home screen user interface 492 displays a search affordance 4034 (e.g., as illustrated in FIG. 4C1), and a tap on the search affordance 4034 causes the search user interface 494 described above to be displayed overlaying the home screen user interface 492. In some embodiments, in response to detecting an upward swipe gesture 4103d that starts from the bottom edge of the search user interface (or another dismissal input), the multifunction device dismisses the search user interface 494 and redisplays (4103d) the home screen user interface 492 (e.g., not the wake screen user interface 490, as the upward edge swipe gesture dismisses the currently displayed user interface and redisplays the last displayed system user interface).

In some embodiments, as shown in FIG. 4C1, a rightward swipe gesture 4102b that starts from the left edge of the first page of the home screen user interface 492 causes (4102b) the multifunction device to display the widget user interface 491 described above. In some embodiments, a leftward swipe gesture (e.g., gesture 4103b, or another leftward swipe gesture) that starts from the right edge or the interior region of the widget user interface or an upward swipe gesture (e.g., gesture 4103a, or another upward swipe gesture) that starts from the bottom edge of the widget user interface 491 causes (4103a-2/4103b-2) the multifunction device to navigate away from the widget user interface 491 and redisplays the first page of the home screen user interface 492 (e.g., when the home screen user interface 492 was the last displayed user interface prior to displaying the widget user interface 491).

In some embodiments, consecutive leftward swipe gestures 4116 on the home screen user interface 492, as shown in FIG. 4C2, navigates through consecutive pages of the home screen user interface 492 until the application library user interface 497 is (4116) displayed. In some embodiments, the application library user interface 497 displays application icons from multiple pages of the home screen user interface grouped into different categories. In some embodiments, the application library user interface 497 includes a search user interface element 4036 that accepts search criteria (e.g., keywords, image, and/or other search criteria) and returns application icons for relevant applications (e.g., applications that are stored on the multifunction device and/or available in the app store) as search results. In some embodiments, user selection of (e.g., by a tap input, a click input, or another type of selection input) on an application icon in the search results and/or in the application library causes the multifunction device to display the application user interface of the application that corresponds to the selected application icon.

In some embodiments, a downward swipe gesture 4109c that starts from the right portion of the top edge of the application library user interface 497 causes display of the control user interface 498 as described above. In some embodiments, an upward swipe gesture (e.g., upward swipe gesture 4110a, or another upward swipe gesture) that starts from the bottom edge of the control user interface 498 or another dismissal input causes the multifunction device to dismiss the control user interface 498 and redisplay the application library user interface 497 (e.g., since the application library user interface is the last displayed user interface before the display of the control user interface) (e.g., or redisplay another user interface (e.g., redisplay (4110a-1) the wake screen user interface 490 (e.g., if control user interface 498 is displayed in response to swipe gesture 4109a), redisplay (4110a-3) the home screen user interface 492 (e.g., if the control user interface is displayed in response to a downward swipe from the top right portion of the top edge of the display), or redisplay (4110a-2) the application user interface (e.g., if the control user interface is displayed in response to the downward swipe 4109b) that was the last displayed user interface prior to displaying the control user interface).

In some embodiments, a rightward swipe gesture 4115 that starts from the interior region or the left edge of the application library user interface 497 or an upward swipe gesture that starts from the bottom edge of the application library user interface 497 causes (4115) the multifunction device to dismiss the application library user interface 497 and redisplays the last page of the home screen user interface 492.

In some embodiments, a downward swipe gesture 4114 that starts from the interior region of the application library user interface 497 causes the multifunction device to display the application icons for applications stored on the multifunction device in a scrollable list (e.g., according to chronological or alphabetical order).

In some embodiments, an upward swipe gesture that starts from the bottom edge of the home screen user interface causes the multifunction device to display the first page of the home screen user interface 492 or display the multitasking user interface 488 (also referred to an application switcher user interface). In some embodiments, different criteria (e.g., criteria based on the speed, direction, duration, distance, intensity, and/or other characteristics) are used to determine whether to navigate to the first page of the home screen user interface 492 or to the multitasking user interface 488 in response to detecting the upward swipe gesture that starts from the bottom edge of the home screen user interface. For example, in some embodiments, a short flick and a slow and long swipe cause the multifunction device to navigate to the first page of the home screen user interface 492, while a slow and medium length swipe causes the multifunction device to display the multitasking user interface 488. In some embodiments, a navigation gesture is dynamically evaluated before the termination of the gesture is detected, and therefore, the estimated destination user interface of the navigation gesture continues to change and visual feedback regarding the estimated destination user interface continues to be provided to guide the user to conclude the gesture when the desired destination user interface is indicated by the visual feedback. In some embodiments, in response to a user input 4117 at a portion of the multitasking user interface 488 that does not correspond to an application, a last displayed user interface that is displayed before displaying the multitasking user interface 488 is displayed (e.g., home screen user interface 492 is displayed when the multitasking user interface 488 is displayed in response to user input 4111b).

In some embodiments, a reconfiguration mode of the home screen user interface 492 is displayed in which application icons and/or widgets can be repositioned in, removed from, or added to the different pages of the home screen user interface 492. In some embodiments, a touch and hold gesture or another enhanced selection input directed to the home screen user interface 492 for a respective threshold amount of time or another enhanced selection input directed to the home screen user interface 492 cause the multifunction device to display the home screen user interface 492 in the configuration mode. In some embodiments, selection of the search affordance 4034 in the home screen user interface 492 while the home screen user interface 492 is in the reconfiguration mode causes the multifunction device to display a page editing user interface for the home screen user interface in which pages of the home screen user interface may be reordered, deleted, hidden, or created. In some embodiments, a tap input on the home screen user interface in the reconfiguration mode, causes the home screen user interface to exit the reconfiguration mode. In some embodiments, a tap input on unoccupied portion of the page editing user interface causes the multifunction device to exist the page editing user interface and redisplays the home screen user interface in the reconfiguration mode. Another tap on the home screen user interface causes the home screen user interface to exit the reconfiguration mode and be redisplayed in the normal mode.

In some embodiments, while displaying the home screen user interface 492 or the contextual user interface of the lightweight mode, a downward swipe gesture 4108a that starts from the top edge of the home screen user interface 492 or the contextual user interface of the lightweight mode causes (4108a) the multifunction device to cover the home screen user interface 492 or the contextual user interface of the lightweight mode with the coversheet user interface 496 (also referred to as the wake screen user interface 490 if the user interface is displayed when transitioning from a normal mode to a low-power mode, and/or vice versa (e.g., due to inactivity, due to activation of the power button, and/or due to user input that corresponds to a request to wake or lock the device)) and the access to the home screen user interface or the contextual user interface of the lightweight mode is temporarily restricted by the coversheet user interface 496. In some embodiments, while the coversheet user interface 496 is displayed, an upward swipe gesture 4103e that starts from the bottom edge of the coversheet user interface 496 dismisses (4103e) the coversheet user interface 496 and redisplays the home screen user interface 492 or the contextual user interface of the lightweight mode (e.g., since the home screen user interface is the last displayed user interface). In some embodiments, the coversheet user interface has responses to user inputs in a manner analogous to those described with respect to the wake screen user interface 490.

In some embodiments, an application user interface of a respective application can be displayed in response to user inputs in a number of scenarios, such as tapping on a widget displayed in the home screen user interface or the widget user interface; tapping on an application icon displayed in the home screen, in the widget user interface, in the search result or recommended application portion of the search user interface, in the application library user interface or in the search results provided in a search in the application library user interface; tapping on a notification on the wake screen user interface or in the notification history; tapping on a representation of an application in the multitasking user interface; or selecting a link to an application in a user interface of another application (e.g., a link to a document, a link to a phone number, a link to a message, a link to an image, and other types of links). In some embodiments, a user interface of a single application is displayed in a full-screen mode. In some embodiments, user interfaces of two or more applications are displayed in a concurrent-display configuration, such as in a side-by-side display configuration where the user interfaces of the applications are displayed adjacent to one another to fit within the display, or in an overlay display configuration where the user interface of a first application is displayed in the full-screen mode while the user interfaces of other applications are overlaid on portion(s) of the user interface of the first application (e.g., in a single stack or separately on different portions).

In some embodiments, while displaying a user interface of an application, an upward swipe gesture (e.g., upward swipe gesture 4111a, or another upward swipe gesture) that starts from the bottom edge of the application user interface (e.g., messages user interface 493, or another user interface of an application) or another dismissal input or home gesture causes (4111a-1, or 4111a-2) the multifunction device to dismiss the currently displayed application user interface, and display either the home screen user interface (e.g., shown as transition 4111a-1) or the multitasking user interface (e.g., shown as transition 4111a-1) depending on the characteristics of the upward swipe gesture. In some embodiments, while displaying home screen user interface 492, an upward swipe gesture 4111b that starts from the bottom edge of the home screen user interface causes (4111b) the multifunction device to dismiss the currently displayed home screen user interface 492, and display the multitasking user interface 488.

In some embodiments, a horizontal swipe gesture in the leftward and/or rightward direction that is performed within a bottom portion of the application use interface(s) causes the multifunction device to switch to another previously displayed application user interface of a different application. In some embodiments, the same swipe gesture that starts from the bottom portion of a respective application user interface is continuously evaluated, to determine and update an estimated destination user interface among the multitasking user interface 488, the home screen user interface 492, or a user interface of a previously displayed application, based on the characteristics of the swipe gesture (e.g., location, speed, direction, and/or change in one or more of the above), and a final destination user interface is displayed in accordance with the estimated destination user interface at the termination of the swipe gesture (e.g., lift off of the contact, reduction in intensity of the contact, a pause in movement, and/or another type of change in the input).

In some embodiments, while displaying an application user interface of a respective application (or displaying application user interfaces of multiple applications in a concurrent-display configuration), a downward swipe gesture 4108b that starts from the top edge of the application user interface(s) causes (4108b) the multifunction device to display the coversheet user interface 496 (FIG. 4C1) (or the wake screen user interface 490 in FIG. 4C2) over the application user interface(s). The multifunction device dismisses the coversheet user interface 496 (or the wake screen user interface 490) and redisplays the application user interface(s) in response to an upward swipe gesture that starts from the bottom edge of the coversheet user interface (or another dismissal input).

In some embodiments, as shown in FIG. 4C2, a downward swipe gesture 4109b that starts from the static status region 4022 on the display cause (4109b) the multifunction device to display the control user interface 498 over the application user interface(s), and an upward swipe gesture 4110a that starts from the bottom edge of the control user interface 498 (or another dismissal input) dismisses the control user interface 498 and causes (4110a-2) the application user interfaces to be redisplayed (e.g., or the last displayed user interface that is displayed before displaying the control user interface 498).

In some embodiments, rotation of the display causes the multifunction device to display a different version of the currently displayed user interface (e.g., application user interface, home screen user interface, contextual user interface of the lightweight mode, wake screen user interface, control user interface, notification user interface, widget user interface, application library user interface, and other user interfaces described with respect to FIGS. 4C1-4C2) that have a differently layout (e.g., landscape version vs. portrait version). In some embodiments, rotation of the display has no effect on the orientation of the respective user interface that is currently displayed.

In some embodiments, when the device is placed on a docking station or is connected wirelessly or through a contact-based connection (e.g., via electronic connection, or magnetic connection) to a charging source, rotation of the display when the wake screen user interface is displayed and/or when the device is in the low power state, cause the device to enter a standby mode, where a different set of navigation states are made available. In some embodiments, swiping in the vertical direction causes the device to navigate between different versions of a functional “face” (e.g., a user interface that provides a primary function, such as a “clock” face, a “weather” face, a “calendar” face, a “stock” face, a “photos” face, a “widget” face, or user interface that provides another function), while swiping in the horizontal direction cause the device to navigate between different functional faces. In some embodiments, swiping downward from the upper right corner of the display causes the device to display a “control” face that includes controls for various control functions of the device. Swiping upward from the bottom edge of the display when the “control” face is displayed causes the device to dismiss the “control” face and redisplay the last displayed functional face.

The above description of the navigation between user interfaces and exact appearances and components of the various user interfaces are merely illustrative and may be implemented with variations in various embodiments described herein. In addition, the transitions between pairs of user interfaces illustrated in FIGS. 4C1-4C2 are only a subset of all transitions that are possible between different pairs of user interfaces illustrated in FIGS. 4C1-4C2, and a transition to a respective user interface may be possible from any of multiple other user interfaces, in accordance with a respective user input of a same type, directed to a same interaction region of the display, and/or in accordance with a different type of input or directed to a different interactive region, in accordance with various embodiments.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

### User Interfaces and Associated Processes

Attention is now directed towards embodiments of user interfaces (“UI”) and associated processes that may be implemented on an electronic device (or computer system more generally), such as portable multifunction device 100 or device 300, with a display, one or more input elements, including a touch-sensitive surface or touch-screen, (optionally) one or more tactile output generators for generating tactile outputs, and (optionally) one or more sensors to detect durations, movements, and/or intensities of contacts with the touch-sensitive surface.

FIGS. 5A-5AJ illustrate exemplary contextually-updated user interfaces and exemplary user interactions with said contextually-updated user interfaces, in accordance with some embodiments. FIGS. 6A-6M illustrate exemplary user interfaces and changes in function of a computer system, when the computer system is connected to different external computer systems, in accordance with some embodiments. The user interfaces in these figures are used to illustrate the processes described below, including the processes in FIGS. 7A-7I and 8A-8D. For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector, and/or in response to detecting other types of inputs performed using an input device (e.g., a hardware button, a controller, a mouse, a trackpad, or another control device) while a location or object is targeted, such as via a focus selector (e.g., a pointer, or a cursor, or a gaze) being on the location or object, and/or an air gesture performed using an input element such as hand(s) or finger(s) (e.g., a hand waving, a hand flipping, two hands moving toward each other, two fingers pinching, and/or one finger tapping) posed, changing pose, and/or moving in physical space while a location or object is targeted, such as when the location of the hand(s) and/or finger(s) are on or near the object or the location or while a focus selector is on the location or object.

FIGS. 5A-5AJ illustrate exemplary contextually-updated user interfaces, and user interactions interacting with these contextually-updated user interfaces, in accordance with some embodiments.

FIGS. 5A-5D illustrate an example regular mode of a computer system 100 (sometimes also referred to herein as a portable multifunction device 100). In the interaction shown in FIGS. 5A-5D, an example of a regular home screen user interface 5018 is displayed as an initial user interface of the computer system when the computer system exits a restricted state of the computer system in the regular mode, in accordance with some embodiments. The example regular home screen user interface 5018 is substantially static according to a system-specified or user-specified configuration and includes the same set of application icons in the same spatial arrangement that persist through multiple user sessions in different contexts (e.g., different times of time, different location, different recent interactions, different upcoming calendar information, different recent communication information, and/or other different contextual conditions). In some embodiments, the regular home screen user interface optionally includes one or more widgets or widget stacks at one or more user-specified or system-specified placement locations in accordance with a system-specified or user-specified configuration for the regular home screen user interface, but the locations and total numbers of the placement locations for the widgets and widget stacks remain unchanged through multiple user sessions in different contexts, even if the content within a standalone widget or a currently displayed widget in a widget stack may be updated from time to time based on the current context.

FIGS. 5E and 5F illustrate two example initial user interface 5020 and 5036 in a lightweight mode of the computer system 100, in accordance with various embodiments. In the interaction shown in FIGS. 5A-5C and 5E, or FIGS. 5A-5C and 5F, instead of displaying a regular home screen user interface 5018 as shown in FIG. 5D, the computer system displays the contextual user interface 5020 in FIG. 5E, or the contextual user interface 5036 in FIG. 5F, as the initial user interface of the computer system when the computer system exits the restricted state of the computer system. The contextual user interfaces 5020 and 5036 shown FIGS. 5E and 5F include respective sets of user interface objects that correspond to contextually-selected application functions and/or contextually-selected device functions, from contextually-selected applications, based on the current context of the computer system. In some embodiments, the user interface objects corresponding to different sets of the contextually-selected application functions and device functions for different contexts can vary in spatial arrangement and/or in total number of user interface objects concurrently presented in the contextual user interface, and/or integrated and/or grouped in various manners in the contextual user interface. In some embodiments, the contextual user interfaces described herein may also be referred to as a “home screen user interface” or “a lightweight home screen user interface,” because it is the initial user interface displayed after exiting the restricted state of the computer system.

It is to be noted that, although in some embodiments, the computer system 100 can selectively operate in both a regular mode and a lightweight mode based on various conditions; in some embodiments, the computer system 100 is a device that does not support the so-called “regular” mode, and always operates in the “lightweight” mode and displays the contextual user interface as the initial user interface when exiting the restricted mode of the device. In some embodiments, the computer system is a device that operates in the lightweight mode when operating in a standalone mode, and switches to operate in the regular mode when connected to another device, such as another multifunction device that, optionally, operates in the regular mode. In some embodiments, the computer system is a device that always operate in the lightweight mode, but can be connected to another device that operates in the regular mode and serves as a source of content or input as the other device and/or as extension of the other device that performs operations at the direction of the other device.

FIG. 5A shows a computer system 100 (sometimes also referred to herein as a portable multifunction device 100) while the computer system 100 is in a low-power state (e.g., a power-saving state, a sleep state, a dimmed always-on state, and/or other states to conserve battery power after a period of inactivity or in response to user request). In some embodiments, while in the low-power state, the computer system 100 displays a user interface 5000, which includes a plurality of user interface elements, such as a current time 5002, a current date 5012, a widget 5004, a widget 5006, and a widget 5008. In some embodiments, while in the low-power state, some user interface elements in the user interface 5000 are displayed with reduced visual prominence (e.g., to preserve battery power) as compared to when the computer system 100 is not in the low-power state (e.g., some user interface elements are continuously displayed when transitioning in and out of the low-power state, but with reduced visual prominence in the low-power state). In some embodiments, the display is completely dark or with minimal user interface elements, when in the low-power state.

FIG. 5B shows that, in response to detecting a user input 5010 (e.g., a tap input, a swipe input, or another touch input on the touch-screen of the computer system 100), the computer system 100 exits the low-power state. As compared to FIG. 5A, in FIG. 5B, the user interface 5000 is displayed with a different appearance (e.g., a brighter appearance and/or with user interface elements displayed with an increased level of prominence as compared to that in the low-power state). In some embodiments, the computer system 100 exits the low-power state in response to a different type of user input (e.g., a user lifting or raising the computer system 100, or a press of the power button to turn on the display). The user interface 5000 shown in FIG. 5B is an example of a wake screen user interface, as it is the initial user interface that is displayed when the computer system exits the low-power state (or “wakes” from the power-saving state or sleep state). In some embodiments, the widgets 5004, 5006, and 5008 (e.g., an “Up Next” widget, a daily exercise widget, and a local weather widget) are user interface objects that displays application content from respective applications (e.g., a calendar application, a workout application, and a weather application) associated with the widgets, and the application content is automatically updated from time to time as new or updated content (e.g., new upcoming calendar events, newly collected workout data, and weather updates) become available in the respective applications. In some embodiments, the time element 5002 and date element 5012, are updated based on the current time and date. In some embodiments, the user interface 5000 includes a status region that includes real-time or substantially real-time updates of one or more on-going events, such as an ongoing phone call, progress of media recording or playback in progress, navigation instructions for an ongoing navigation session, or other ongoing events that generates time-sensitive and/or real-time updates. In some embodiments, the user interface 5000 includes an indicator (e.g., a lock symbol in either the locked state or unlocked state) indicating the current authentication state of the computer system 100, such as a locked or unauthenticated state, and an unlocked or authenticated state. In some embodiments, the user interface 5000 is referred to as a user interface that corresponds to the restricted state of the computer system. In some embodiments, the user interface 5000 is only displayed when the computer system is in the locked/unauthenticated state, and authentication information (e.g., biometric data such as fingerprint, voiceprint, or facial identification, or passcode or gesture) is required to exit the restricted state of the computer system.

FIG. 5C shows that, in response to detecting a user input 5014 (e.g., an upward swipe input that is started from a bottom edge portion of the user interface 5000, or a press on a “home” button of the computer system) directed to the user interface 5000, the computer system 100 initiates a process to exit the restricted state of the computer system. In some embodiments, in the process to exit the restricted state of the computer system, the computer system displays a user interface 5016 to obtain a valid authentication information to unlock the computer system. In some embodiments, the user interface 5016 is an authentication user interface that requires user input (e.g., for inputting a pin, passcode, or password) and the computer system is unlocked once correct authentication information is received via the user interface 5016. In some embodiments, the user interface 5016 is optionally not displayed, and authentication information is automatically captured, e.g., via facial recognition, fingerprint scanning, or other user biometrics, without requiring the user's explicit action. In some embodiments, authentication information is automatically captured before the user input 5014 is detected, and/or the computer system enters into the unlocked/authenticated state before the user input 5014 is detected. In some embodiments, authentication information is automatically captured after and/or in response to the detection of the user input 5014, and/or the computer system enters into the unlocked/authenticated state after the authentication information is verified.

FIG. 5D shows a user interface 5018 that is displayed in response to detecting a sequence of one or more user inputs that correspond to a request to exit the restricted state shown in FIG. 5B and that the computer system is unlocked and in an authenticated state (e.g., successfully authenticated, by receiving a passcode via the user interface 5016 in FIG. 5C, or by successful facial recognition or fingerprint recognition without displaying the user interface 5016). In some embodiments, the user interface 5018 is a home screen user interface that includes a plurality of application icons arranged in accordance with a predetermined layout, and a respective application icon (e.g., when activated by a tap input or other selection input) provides access to a respective application (e.g., causes the computer system 100 to display an application user interface corresponding to the respective application, and allowing the user to navigate within the full user interface hierarchy of the respective application in accordance with the design of the respective application). Although in FIG. 5D, the home screen user interface only includes application icons in respective placement locations in the home screen user interface, sometimes, adjacent the placement locations for application icons optionally can be combined into a respective placement location for a widget or widget stack, and displays a user-specified widget or widget stack. In some embodiments, the user interface 5018 shown in FIG. 5D is also referred to as a “regular” home screen user interface or a “full-function” home screen user interface, in contrast to the “contextual” and/or “lightweight” home screen user interfaces describe below with respect to FIGS. 5E-5F.

FIG. 5E illustrates an alternative to FIG. 5D, where the computer system 100 exits the restricted state of the computer system (e.g., as shown in FIG. 5B) and displays a contextual user interface 5020 (e.g., instead of the user interface 5018 in FIG. 5D), in accordance with some embodiments. As shown in FIG. 5E, in some embodiments, the contextual user interface 5020 includes a stable portion and a contextually updated portion, where the stable portion includes the same set of user interface objects (e.g., same identities and quantities of user interface objects), such as the current time, and/or the current date, affordance 5022, affordance 5024, and affordance 5026. In some embodiments, the affordance 5022 corresponds to a set of communication options (e.g., contacts and/or communication modes), affordance 5024 corresponds to a set of media playback options (e.g., playback controls, and/or media items), and affordance 5024 corresponds to a set of media capture options (e.g., media capture controls and/or viewfinder of a camera application). In some embodiments, the affordances and/or their corresponding functions that are included in the stable portions of the contextual user interface are configurable by a user in a configuration user interface of the computer system, and do not change between user sessions and/or within a current user session even if the current context of the computer system changes. In some embodiments, the contextually updated portion of the user interface 5020 includes user interface objects that are contextually selected, configured, and/or updated, based on the current context of the computer system when the computer system exits the restricted state and, optionally, while the user interface 5020 remains displayed and/or is redisplayed after some user interaction with the user interface 5020. In some embodiments, the user interface objects in the contextually updated portion of the user interface 5020 includes contextually selected and/or configured application-specific widgets. In some embodiments, the user interface objects in the contextually updated portion of the user interface 5020 includes at least one contextually configured and/or updated user interface object that integrates application functions and/or device functions from multiple applications.

In some embodiments, the contextually updated portion of the user interface 5020 includes widget user interface 5030 that corresponds to one or more contextually selected widgets based on the current context of the computer system. In FIG. 5E, a currently displayed widget user interface is a first widget user interface 5030-a of a plurality of contextually selected widget user interfaces. In some embodiments, the initially displayed widget user interface has a higher contextual relevance than other contextually-selected widget user interfaces in the plurality of contextually selected widget user interfaces. In some embodiments, the total number and/or identities of the constituent widget user interfaces, and the order of the constituent widget user interfaces, included in the widget user interface 5030 differ based on different contexts (e.g., current location, current time of day, recent communications, recent and upcoming calendar information, recent and current user activities, and/or other contextual information) of the computer system.

In some embodiments, the user interface 5020 includes a search interface, e.g., a search bar 5032 or a digital assistant interface, through which a user can search for application functions and device functions, using one or more search keywords and/or criteria. In some embodiments, the search interface is directly displayed in the user interface 5020 without requiring an additional user input to interact with the user interface 5020 (e.g., without requiring a swipe input on the user interface 5020). In some embodiments, the digital assistant interface performs a search in response to a speech input without requiring the user to interact with a user interface element displayed on user interface 5020. In some embodiments, the user interface 5020 includes a voice input affordance 5034, and the digital assistant interface is invoked when the voice input affordance 5034 is selected by a user. In some embodiments, voice input is transcribed into text and entered into the search bar 5032, when the voice input affordance 5034 is selected by a user before the voice input is detected.

In some embodiments, the user interface 5020 includes an affordance 5028, which when activated, causes the computer system 100 to display (e.g., and/or redisplay) the user interface 5018 (e.g., a “regular,” “full-function,” non-simplified, and/or otherwise different home screen user interface). In some embodiments, the affordance 5028 is not provided in user interface 5020 when the computer system exits the restricted state, and the computer system optionally displays the affordance 5028 or displays the regular home screen user interface 5018 when (e.g., in response to, and/or in accordance with a determination that) the computer system is connected to another computer system (e.g., another computer system that runs the same type of operating system, or a different type of operating system from the computer system 100). In some embodiments, the affordance 5028 is not provided in user interface 5020 when the computer system exits the restricted state, and the computer system optionally displays the affordance 5028 or displays the regular home screen user interface 5018 when (e.g., in response to, and/or in accordance with a determination that) the computer system detects a respective type user input, such as activation of a home button, or another home gesture on the user interface 5020 (e.g., an upward swipe gesture that starts from the bottom edge of the user interface 5020, or another system gesture).

FIG. 5F illustrates an alternative user interface to that shown in FIG. 5E, in accordance with some embodiments. In FIG. 5F, following FIGS. 5A-5C, the computer system displays a contextual user interface 5036 as the initial user interface when the computer system exits the restricted state of the computer system, in accordance with some embodiments. In some embodiments, the user interface 5036 is displayed in response to a scroll input directed to the contextually updated portion of the user interface 5020 (e.g., a swipe gesture on the currently displayed widget user interface 5030-a, or a tap input on a respective navigation affordance corresponding another widget user interface among the plurality of contextually displayed/generated widget user interfaces in the contextually updated portion of the user interface 5020). In some embodiments, in response to the scroll input directed to the contextually updated portion of the user interface 5036, the stable portion of the user interface 5036 is reduced in visual prominence, e.g., reduced in size, moved to a less prominent region of the display, and/or moved into the background layer, relative to the contextually updated portion of the user interface 5036. In some embodiments, the contextually updated portion of the user interface 5036 includes multiple concurrently displayed (e.g., partially overlapping in a stack, or tiled side by side) user interface objects that correspond to different contextually selected application content, for different subsets of application functions and device functions available from one or more applications. In some embodiments, another user input (e.g., a downward swipe gesture, or selection of an affordance for collapsing the expanded view of the contextually updated portion) directed to the contextually updated portion of the user interface 5036 optionally restores it to the state shown in FIG. 5E. In some embodiments, the user interface 5036 is the initial user interface of the computer system when the computer system exits the restricted state of the computer system, and it optionally includes and/or displays the affordance 5028 in the manner as described with respect to the affordance 5028 in FIG. 5E.

In FIG. 5F, the user interface 5036 concurrently includes multiple individual user interface objects (e.g., weather user interface 5038, browser user interface 5040, and maps user interface 5042) in a partially overlapping manner, in accordance with some embodiments. The three concurrently displayed user interface objects (e.g., weather user interface 5038, browser user interface 5040, and maps user interface 5042) have been automatically selected and/or constructed for display in the contextually updated portion of the user interface 5036 based on the current context (e.g., the context of the computer system at the current time, at the time when the computer system exited the restricted state, and/or at the time that the user input 5014 for exiting the restricted state was received). In some embodiments, the weather user interface 5038 of FIG. 5F corresponds to the widget user interface 5030-a, the browser user interface 5040 of FIG. 5F corresponds to a widget user interface 5030-b, discussed in greater detail with respect to FIG. 5O; and the maps user interface 5042 of FIG. 5F corresponds to a widget user interface 5030-c, discussed in greater detail with respect to FIG. 5T.

In some embodiments, in response to detecting a user input 5034 (e.g., an upward swipe input, or another scroll input), the computer system 100 scrolls the display of user interfaces (e.g., to display additional contextually selected and/or generated user interfaces, similar to the user interfaces 5030, 5040, and 5042, which are not currently visible in FIG. 5F). The descriptions below with reference to the user interface 5020 are generally applicable to the user interface 5036, and interactions with the widget user interfaces 5030-a, 5030-b, and 5030-c are applicable to the user interface 5038, 5040, and 5042, respectively.

FIG. 5G is analogous to FIG. 5E, but shows an optional user input 5048 (e.g., a tap input, or another selection or activation input) directed to the affordance 5028. In some embodiments, in response to detecting the user input 5048, the computer system 100 displays the home screen user interface 5018 (e.g., the user interface 5018 shown in FIG. 5D). In some embodiments, the contextual user interface 5020 is available for display, as an alternative home screen user interface, in addition to the user interface 5018 in FIG. 5D (e.g., a user of the computer system 100 can select whether to display the user interface 5020, or the user interface 5018 as the initial user interface displayed when exiting the restricted state, and/or when a home gesture or home button activation is detected). In some embodiments, the contextual user interface 5020 is the only home screen user interface available for display, and the affordance 5028 is optionally not displayed (e.g., as indicated by the dashed outline of the affordance 5028). In some embodiments, the contextual user interface 5020 is the only home screen user interface available for display, and activation of the affordance 5028 causes display of an application library user interface showing application icons for all available applications on the computer system arranged in different application categories or arranged in alphabetical order.

FIG. 5H shows that, in response to detecting a user input 5046 (e.g., a user input 5046 directed toward the affordance 5022 in FIG. 5G), the computer system 100 displays the user interface 5050. In some embodiments, the user interface 5050 replaces display of the user interface 5020 or is overlaid on top of user interface 5020. In some embodiments, as shown in FIG. 5H, the user interface 5050 is displayed overlaid over a portion of the user interface 5020, such as the contextually updated portion of the user interface 5020, while the stable portion of the user interface 5020 remains displayed with the user interface 5050.

In some embodiments, as shown in FIG. 5H, the user interface 5050 includes contact information stored in memory of the computer system 100. For example, the user interface 5050 includes a contact 5052 (e.g., a contact “Jane Adams”), a contact 5054 (e.g., a contact “Brian Armstrong”), a contact 5056 (e.g., a contact “Scott Cameron”), a contact 5058 (e.g., a contact “Amy Elliot”), a contact 5060 (e.g., a contact “Michael Fisher”), a contact 5062 (e.g., a contact “Lisa Forrest”), and a contact 5064 (e.g., a contact “Zach Gibson”). In some embodiments, the user interface 5050 includes additional contacts (e.g., more contacts that cannot be concurrently displayed at a single time), and the user can access the additional contacts by performing a user input, such as an upward swipe input or other inputs to navigate and/or scroll through a list of stored contacts.

In some embodiments, the individual contacts are displayed with corresponding affordances for initiating communications in different manners (e.g., messaging, e-mail, voIP, video call, telephone call, and/or shared three-dimensional experiences, using different communication applications). For example, the contact 5056 for “Scott Cameron” includes a phone affordance 5066 (e.g., for calling the contact “Scott Cameron”), a messaging affordance 5068 (e.g., for sending a text message to the contact “Scott Cameron”) and an affordance 5070 (e.g., for accessing additional functions and/or contact information for the contact “Scott Cameron”). In some embodiments, each respective contact in the user interface 5050 includes affordances for interacting with the respective contact (e.g., each contact has the same affordances described above with reference to the contact 5056). In some embodiments, the contacts in the listing of contacts shown in FIG. 5H are optionally prioritized based on the current context (e.g., based on frequency and/or recency of communications, the current time of day, the current location, upcoming calenda events, recent communications, and/or other contextual information relevant for contacts and communications). In some embodiments, the general modes of communication (e.g., telephone call, and text messaging) shown in the user interface 5050 are optionally uniform across the different contacts.

FIG. 5I following FIG. 5H shows that, while displaying the user interface 5050, the computer system detects a user input 5072 directed to the contact 5056 for “Scott Cameron;” and in response to detecting the user input 5072, the computer system 100 displays a user interface 5076. In some embodiments, the user interface 5076 replaces display of the user interface 5050 (e.g., and is displayed overlaid over a portion of the user interface 5020, such as the contextually updated portion of the user interface 5020). In some embodiments, the stable portion of the contextual user interface 5020 is reduced in visual prominence, e.g., reduced in size and moved into a less prominence portion of the display, relative to the contextually updated portion, when the user is interacting with the contextually updated portion or a newly displayed user interface. In some embodiments, the stable portion of the contextual user interface 5020 always remains visible, as the contextually updated portion changes and/or as new user interfaces are displayed in response to interaction with the stable portion and/or the contextually updated portion.

In some embodiments, the user interface 5094 includes contact information (e.g., phone numbers, email addresses, social media handles, names, nicknames, addresses, and/or other contact-related information). In some embodiments, the user interface 5076 includes one or more affordances for initiating a communication session with the contact “Scott Cameron” via different protocols. For example, the user interface 5076 includes an affordance 5078 for initiating a text message with the contact “Scott Cameron” (e.g., when activated by a user input 5086), an affordance 5080 for initiating a phone call with the contact “Scott Cameron” (e.g., when activated by a user input 5088), an affordance 5082 for initiating a video call with the contact “Scott Cameron” (e.g., when activated by a user input 5090), and an affordance 5084 for sending an email message to the contact “Scott Cameron” (e.g., when activated by a user input 5092). In some embodiments, the communication protocols and/or applications used to provide the communication interfaces are selected based on which contact is being displayed and based on past communications between the computer system and the displayed contact. In some embodiments, the computer system 100 ceases to display the user interface 5076, in response to detecting a user input 5093 at a location that is outside of the user interface 5076. In some embodiments, the computer system 100 ceases to display the user interface 5076 in response to detecting a user input 5094 (e.g., a downward swipe gesture, optionally detected at a top portion of the user interface 5076).

FIG. 5J shows that, in response to detecting a user input (e.g., the user input 5093 or the user input 5094 in FIG. 5I), the computer system 100 ceases to display the user interface 5076 (e.g., and redisplays the portions of the user interface 5020 that were overlaid by the user interface 5076). A user performs a user input 5096 (e.g., a tap input) directed to the affordance 5024 in the stable portion of the contextual user interface 5020.

FIG. 5K shows that, in response to detecting the user input 5096, the computer system displays a user interface 5098, overlaid over a portion of the user interface 5020 (e.g., optionally, in the same position and with the same configuration as the user interface 5050 of FIG. 5H, and/or the user interface 5076 of FIG. 5I.

In some embodiments, the user interface 5098 is a media user interface that includes contextually selected media items (e.g., music, videos, audio books, and/or other media items corresponding to the current context), optionally in contextually selected playback modes (e.g., playing, paused, routing destination, repeat mode, volume, with or without closed caption, and/or other playback preferences, corresponding to the current context). For example, in FIG. 5K, the user interface 5098 includes music content and music information corresponding to music media (e.g., stored in memory of the computer system 100). In some embodiments, the user interface 5098 includes content and/or information corresponding to other types of media (e.g., and/or a mix of different types of media), such as photos, videos, movies, books, audio books, and/or voice recordings. In some embodiments, the computer system 100 automatically begins playing media when the user interface 5098 is displayed (e.g., in response to detecting the user input 5096).

In an example, as shown in FIG. 5K, a song 5100 (e.g., “Song A”) is currently playing at the computer system 100 (e.g., automatically begins playing in conjunction with display of the user interface 5098 in response to user input 5096). The user interface 5098 includes affordances for additional songs, such as a song 5102 (e.g., “Song B”) and a song 5104 (e.g., “Song G”), which optionally are songs to be played (e.g., played next) in a playlist of songs. In some embodiments, the playlist of songs is a user-selected playlist (e.g., a playlist created by the user of the computer system 100). In some embodiments, the playlist of songs is automatically generated by the computer system 100 (e.g., optionally, based on a current context, such that different automatically generated playlists are available in different contexts). In some embodiments, the computer system 100 generates the playlist from songs stored in memory of the computer system 100. In some embodiments, the computer system 100 generates the playlist by downloading or streaming music from the internet (e.g., optionally, based on music previously played by and/or purchased by the user of the computer system 100).

In some embodiments, the user of the computer system 100 manually initiates playing of the selected media (e.g., the user manually selects and/or initiates playing of a respective song (e.g., the user performs a user input directed toward the song 5100 to being playing “Song A”). In some embodiments, the user of the computer system 100 can perform user inputs to change a currently playing song (e.g., to cease playing “Song A” and begin playing a different song, optionally, regardless of whether “Song A” started playing automatically or was manually played by the user of the computer system 100). The user interface 5098 includes media playback controls 5108 (e.g., optionally including one or more of a previous track control, a rewind control, a play control, a pause control, a next track control, and/or a fast forward control) and a volume control 5110 (e.g., which optionally displays a current volume level for the playing audio, in addition to providing access to volume adjustment functionality).

In FIG. 5L, in response to detecting a user input 5112 (e.g., a downward swipe input) in FIG. 5K, the computer system 100 ceases to display the user interface 5098. In some embodiments, the computer system 100 displays a media user interface 5116 (e.g., as a part of and/or inside the user interface 5020). In some embodiments, the media user interface 5116 includes a subset of information and/or controls available in the user interface 5098. In some embodiments, in response to detecting a user input directed toward the media user interface 5116, the computer system 100 redisplays the user interface 5098 (e.g., with the same appearance and/or location as shown in FIG. 5K).

In some embodiments, user interface 5020 includes a status region that indicates the current status of ongoing activities or events on the computer system. In the example shown in FIG. 5J-5L, in accordance with the start of media playback (e.g., triggered by user input 5096 and/or selection of a playback control in user interface 5098), the status region 5114 of the contextual user interface 5020 is updated (as shown in FIG. 5L) to indicate that media playback is ongoing and/or shows the title and waveform of the currently played media. In some embodiments, if more than one events and/or activities (e.g., communication sessions, navigation sessions, media recording, delivery updates, and/or other ongoing events) are active, the user interface 5020 optionally includes status indicators of multiple ongoing events in the status region 5114; and optionally, include respective user interface objects corresponding to the multiple ongoing events above the contextually displayed and/or generated user interface objects 5030. In some embodiments, when the computer system detects that an ongoing activity has terminated (e.g., media playback has ended, media capture has ended, delivery has completed, or other termination due to natural progression of an activity, or due to an external event or an input from the user), the user interface object corresponding to the terminated activity automatically ceases to be displayed in the user interface 5020, without requiring the user to manually dismiss it.

FIG. 5M following FIG. 5L shows that, in response to detecting a user input 5118 (e.g., a tap input or another selection or activation input) directed toward the affordance 5026, the computer system 100 displays a user interface 5120. In some embodiments, the user interface 5120 is displayed overlaid over a portion of the user interface 5020 (e.g., such that the portions of the user interface 5020 that are not overlaid (e.g., the stable portion of the user interface 5020), continue to provide access to one or more functions of the computer system 100, which are independent of the user interface 5120). In some embodiments, the user interface 5120 is a camera user interface that provides access to one or more camera functions of the computer system 100 (e.g., a subset, less than all, of camera functions of the computer system 100), such as a preview function (e.g., which shows a preview of a field of view of one or more cameras of the computer system 100), a camera capture function, and/or a video capture function. In some embodiments, the user interface 5120 includes an affordance 5122, which when activated (e.g., by a user input 5124 directed toward the affordance 5122), performs a camera-related function of the computer system 100 (e.g., captures a photo, or begins recording a video).

In some embodiments, in response to detecting the user input 5118, the computer system 100 automatically initiates a media capture function (e.g., camera capture and/or video capture), and displays the user interface 5120 to show the captured media (e.g., or the media that is in the process of being captured). For example, the user interface 5120 can include a photo that was automatically taken by the computer system 5118, in response to detecting the user input 5118. In some embodiments, the user interface 5120 includes the affordance 5122 (e.g., to enable further media capture). In some embodiments, the user interface 5120 does not include the affordance 5120 (e.g., media capture is initiated via the affordance 5026). In some embodiments, the user interface 5120 is displayed and/or media capture is started in response to activation of a hardware affordance on the computer system 100, such as a side button, a solid button, and/or a touch-sensitive input region, that is outside of the touch-screen of the computer system, without requiring inclusion of the affordance 5026 in the user interface 5020 and/or without requiring activation of the affordance 5026 by a user input. In FIG. 5M, the status region 5114 optionally continues to show the current status of the media playback activity; as the media capture is in progress, the status region 5114 is updated to include the current status of the media capture activity.

FIG. 5N shows that, in response to detecting a user input 5126 (e.g., a downward swipe input) in FIG. 5M, the computer system 100 ceases to display the user interface 5120 (e.g., and redisplays the portion of the user interface 5020 that was overlaid by the user interface 5120). FIG. 5N also shows a user input 5128 (e.g., an upward swipe input) directed toward the widget user interface 5030-a (e.g., a weather widget showing local weather, or another contextually displayed widget user interface).

FIG. 5O shows that, in response to detecting the user input 5128, the computer system ceases to display the widget user interface 5030-a and displays a widget user interface 5030-b. In some embodiments, the computer system 100 displays an animated transition of the widget user interface 5030-a transforming or transitioning to the widget user interface 5030-b. For example, the widget user interface 5030-a is shown as scrolling or sliding off of a portion of the user interface 5020, and the widget user interface 5030-b scrolling or sliding into the portion of the user interface 5020. In some embodiments, the widget user interface 5030-b is one widget user interface in a stack of widget user interfaces that includes multiple widget user interfaces (e.g., a widget stack 5030, that includes the widget user interface 5030-a, the widget user interface 5030-b, and a widget user interface 5030-c). In some embodiments, the widget user interface 5030-b includes a visual indication regarding the placement and/or order of widget user interfaces that are available for display. For example, the widget user interface 5030-b includes a visual indication that includes two black dots and a white dot. The total number of dots (e.g., 3 dots) indicates the total number of widget user interfaces available for display. The white dot corresponds to the widget user interface 5030-b, and indicates that the widget user interface 5030-b is the second of three available widget user interfaces (e.g., the location of the white dot indicates the ordering of the widget user interface 5030-b relative to other available widget user interfaces). Similarly, in FIG. 5N, the white dot corresponds to the widget user interface 5030-a, and indicates that the widget user interface 5030-a is the first of three available widget user interfaces.

In some embodiments, the stack of widget user interfaces includes a widget user interface that corresponds to a respective application that is not currently installed on the computer system. In some embodiments, the computer system 100 is in communication with an external device that provides information and/or instructions to the computer system 100 (e.g., the respective application is installed on the external device, which transmits information and/or content to the computer system 100). For example, if the computer system 100 is at a retail location (e.g., and within communication range of a point of sale or other external device), the computer system 100 can receive information and/or content to enable payment functionality (e.g., or other retail functions, such as promotions, product reviews, providing feedback, price lookup, or inventory/product searching) via a widget user interface, without requiring the user of the computer system 100 to download and/or install an application corresponding to the retail location. In some embodiments, the widget user interface that is automatically displayed in the contextually updated portion of the user interface 5020 also ceases to be displayed when it is no longer contextually relevant (e.g., when the user leaves the retail location, when the user has completed performing a task provided by the widget user interface, such as finished a payment, finished a survey, downloaded a coupon).

In some embodiments, a respective widget user interface that is contextually displayed in the user interface 5020 has one or more interactive elements, such as affordances, links, and/or controls. For example, in FIG. 5O, the widget user interface 5030-b corresponding to a browser application includes a link 5131 to “www.apple.com” and a link 5133 to “www.uspto.gov,” which a user can interact with (e.g., via a user input 5130, directed toward the link 5131). In some embodiments, the content of the widget user interface 5030-b is automatically compiled and included into the widget user interface 5030-b based on the current context, and can change (e.g., displaying different links or providing other types of application content) over time based on the changing context of the computer system.

FIG. 5P shows that, in response to detecting the user input 5130 (e.g., a tap input or another type of selection or activation input) directed toward the link 5131, the computer system 100 displays a user interface 5142. In some embodiments, the user interface 5142 is a web browser user interface that includes a main window region (e.g., for displaying web content corresponding to the link 5131), an address region 5135 (e.g., for displaying and/or entering a web address corresponding to the web content displaying or to be displayed in the main window region), a back affordance 5132 (e.g., for navigating to a previously visited web page, if any), a forward affordance 5134 (e.g., for navigating to the web page that was displayed prior to detecting activation of the back affordance 5134), a share affordance 5136 (e.g., for sharing a link to the current web page with another contact), a reading list affordance 5138 (e.g., managing a reading list of saved web pages for future reading), and a tab affordance 5140 (e.g., for switching between, opening, and/or closing tabs in the user interface 5142).

In some embodiments, the user interface 5142 is displayed overlaid over a portion of the user interface 5020. In some embodiments, in response to detecting a user input 5144 (e.g., an upward swipe input at an edge portion of the user interface 5142, or selection of an expansion affordance in user interface 5142), the computer system 100 displays an expanded version of the user interface 5142 (e.g., as shown in FIG. 5R, optionally replacing or obscuring the contextual user interface completely).

FIG. 5Q shows a method of displaying an expanded version of a user interface shown in a portion of the contextual user interface 5020, such as the user interface 5142 in FIG. 5P, that is alternative to those described with respect to FIG. 5P, in accordance with some embodiments. FIG. 5Q shows examples of external devices with which the computer system 100 can communicate (e.g., with connections requiring direct contact, close proximity, wireless connection, type of external device, and/or spatial configuration, that meet preset criteria). For example, the computer system 100 can communicate with a personal computer system 5148 (e.g., a desktop or laptop computer that display repositionable windows and have various types of ports for I/O devices), a television 5150 (e.g., or an external monitor or display that operate as a streaming device or output device of a content source), and/or a portable computing device 5152 (e.g., a tablet device, a smartphone, a smartwatch, a wearable device, or a head-mounted AR/VR display, that have limited screen size and limited ports for I/O devices, in the interest of increased mobility and portability). In some embodiments, the computer system 100 displays content in a first layout and/or with a first size (e.g., an unexpanded user interface 5142) when the computer system 100 is not connected to and/or in communication with an external device, or the connection does not meet preset criteria. In some embodiments, in response to detecting that the computer system 100 is connected to and/or in communication with an external device (e.g., and optionally, while the computer system 100 remains in communication with the external device) and/or the connection meets and continues to meet the preset criteria, the computer system 100 displays the content with a different layout and/or with a different size (e.g., an expanded version of the user interface 5142).

FIG. 5R shows the expanded version of the user interface 5142 (e.g., displayed in response to detecting the user input 5144 in FIG. 5P). In some embodiments, the expanded version of the user interface 5142 includes the same user interface elements as the user interface 5142 shown in FIG. 5P (e.g., the back affordance 5132, the forward affordance 5134, the address region 5135, the share affordance 5136, the tab affordance 5140). In some embodiments, the expanded version of the user interface 5142 includes a different layout for the user interface elements (e.g., in contrast to FIG. 5P, the back affordance 5142 and the forward affordance 5135 are not in line with the share affordance 5136 or the tab affordance 5140). In some embodiments, the expanded version of the user interface 5142 includes one or more additional controls (e.g., in FIG. 5R, the expanded version of the user interface 5142 includes a home affordance 5156 (e.g., for navigating to a user selected or default home page), a bookmark affordance 5158 (e.g., for managing bookmarks), an affordance 5160 (e.g., for accessing additional functions of the web browser), a privacy affordance 5166 (e.g., for activating and/or toggling a private or incognito browsing mode), a new tab affordance 5162, and an affordance 5164 (e.g., an affordance for navigating between different open tabs and/or tab groups of the web browser).

FIG. 5S shows that, in response to detecting a user input 5163 (e.g., a downward swipe input) in an edge portion of the expanded version of the user interface 5142 (e.g., as shown in FIG. 5R), the computer system 100 redisplays the user interface 5020. In some embodiments, instead of the user input 5163, the computer system optionally redisplays the user interface 5020 in response to detecting that the connection to the external device that triggered the expansion of the user interface 5142 has terminated.

In FIG. 5S, while displaying the user interface 5020, the computer system 100 detects a user input 5170 (e.g., an upward swipe input, or another scroll input) directed to the currently displayed widget user interface 5030-b. FIG. 5T shows that, in response to detecting the user input 5170, the computer system 100 ceases to display the widget user interface 5030-b and displays the widget user interface 5030-c (e.g., the next widget user interface in the collection of contextually displayed/generated widget user interfaces based on the current context). In some embodiments, the widget user interface 5030-c is a maps widget user interface. In some embodiments, the content of the widget user interface 5030-c is included and/or generated based on the current context. For example, the widget user interface 5030-c includes a map of a location (e.g., a current location of the computer system 100, a meeting location of an upcoming calendar event, a location of a navigation session that is ongoing, or other contextually relevant location), an affordance 5172 (e.g., a search affordance for searching for a particular destination or nearby location of interest), and an affordance 5174 (e.g., an affordance for displaying information and/or locations for nearby restaurants or other points of interests). The affordance 5172 and the affordance 5174 (e.g., one or more elements of the widget user interface 5030-c) can be activated by a user input, such as a user input 5176 (e.g., a tap input directed toward, and activating, the affordance 5172) to trigger display of additional user interface(s) to capture user inputs and/or display additional information. In some embodiments, the map of the location displayed in the widget user interface 5030-c is also available for user interaction, via a user input 5178 (e.g., a tap input or another type of selection input directed to the map displayed in the widget user interface 5030-c).

FIG. 5U shows that, in response to detecting the user input 5178 in FIG. 5T, the computer system 100 displays a user interface 5180. In some embodiments, the user interface 5180 is displayed over at least a portion of the user interface 5020 (e.g., the contextually updated portion, or a portion that is outside of the stable portion of the user interface 5020). The user interface 5180 includes similar information to the widget user interface 7030-c, such as the map of the location (e.g., but with an enlarged size and/or increased detail), but also includes additional functionality available via the widget user interface 7030-c. For example, while the user interface 5180 includes a search bar 5190 (e.g., for performing a search function within the maps application, as opposed to searching application content and functions across multiple applications installed on the device and/or outside of the device), the user interface 5180 also includes other controls for functions of the maps application, such as an affordance 5182 (e.g., a shortcut for displaying the location of and/or directions to a saved “home” location), an affordance 5184 (e.g., a shortcut for displaying the location of and/or directions to a saved “work” location), an affordance 5186 (e.g., for displaying nearby points of interest), and an affordance 5188 (e.g., for saving additional locations). In some embodiments, the affordances displayed in the user interfaces 5180 are selected and included in the user interface 5180 (e.g., by the operating system of the computer system) in accordance with the current context, and are optionally located in different native user interfaces of the maps application.

In some embodiments, the user interface 5180 can be expanded (e.g., in response to detecting a user input 5192 such as an upward swipe input or selection of an expansion affordance, and/or connection to an external device), and/or restored, in an analogous manner as described above with reference to FIG. 5P-5R. In some embodiments, additional functions are accessible in response to detecting a user input 5194 directed toward the search bar 5190.

FIG. 5V shows a user interface 5196, displayed in response to detecting the user input 5194 in FIG. 5U. The user interface 5196 includes some functions that are the same as the user interface 5190, such as the affordance 5182, the affordance 5184, the affordance 5186, and the affordance 5188. The user interface 5196 also includes additional functionality, including an affordance 5198 (e.g., for displaying the location of and/or directions to nearby gas stations), an affordance 5200 (e.g., for displaying the location of and/or directions to nearby grocery stores), an affordance 5202 (e.g., for displaying the location of and/or directions to nearby fast food locations), and an affordance 5204 (e.g., for displaying the location of and/or directions to nearby restaurants). In some embodiments, the user interface 5196 includes additional exploration and/or search-related functionality. For example, as shown in FIG. 5V, the user interface 5196 includes a “City Guides” portion, which can include information (e.g., or access to information) relating to a current city (e.g., descriptions, directions, and/or operating hours for landmarks, museums, wildlife preserves, hiking trails, public parks, and/or other visitor attractions; and/or links to webpages and/or articles relating to notable locations for the current city).

In FIG. 5V, in response to detecting a user input 5206 directed to the search bar 5190, the computer system 100 enables text input from a user of the computer system 100 (e.g., to enter a search term, such as a location name and/or address). In some embodiments, the computer system 100 displays a text keyboard to facilitate the text input from the user. In some embodiments, the computer system performs the search using the maps application, and does not provide search results outside of the capabilities of the maps application. In some embodiments, the user interface 5020 in FIG. 5V optionally continues to include the search bar 5032 and affordance 5034 shown in the user interface 5020 in FIG. 5T to allow the user to perform search across multiple applications, in addition to the search within the maps application.

FIG. 5W shows that, in response to receiving an input from the user (e.g., after detecting the user input 5206, such as a search query “San Francisco airport” or “SFO” in FIG. 5V, or in response to detecting activation of a control in widget user interface 5030, such as selection of an address link in a calendar reminder or communication message, or selection of a direction control in an electronic boarding pass, displayed in the contextually updated portion of the user interface 5020), the computer system 100 displays (e.g., redisplays) the user interface 5180 including a map from the maps application, where the map corresponds to a location indicated in the input from the user (e.g., a search term or location entered via the text input, a location indicated in the address link, or an airport corresponding to the flight on the boarding pass). In some embodiments, if a search is performed using the search bar 5190, the computer system 100 displays a listing of search results (e.g., different terminals for the SFO airport) corresponding to the search input, and the visual shown in FIG. 5W is displayed in response to the user selecting an individual search result).

As compared to FIG. 5U, in FIG. 5W, the user interface 5180 includes different functionality (e.g., because in FIG. 5W, the map corresponds to a searched location (e.g., and/or a selected search result), rather than the current location of the computer system 100), and includes a region 5208 that includes an affordance 5210 (e.g., for initiating a navigation function and/or displaying instructions for navigating to the searched location or a location of interest), and an affordance 5212 (e.g., for accessing additional functionality related to the searched location or location of interest). For example, if the search input or the location of interest corresponds to SFO, the user interface 5180 includes a map of the SFO airport and surrounding areas.

FIG. 5X shows that, in response to detecting a user input 5211 directed toward the affordance 5120 (e.g., a request for initiating a navigation session for the search location or location of interest), the computer system 100 ceases to display the user interface 5180 (e.g., and redisplays the portion of the user interface 5020 that was overlaid by the user interface 5180). In contrast to FIG. 5T, the widget user interface 5030-c (e.g., a widget for the maps application) is updated and displays directions for (e.g., and map information relating to) navigating to the searched location or location of interest (e.g., “SFO Terminal 1”). In some embodiments, the widget user interface 5030-c updates from time to time (e.g., periodically, and/or in real-time) to provide updated navigation instructions (e.g., as the computer system 100's current location changes over time, as the navigation instructions are updated or changes, and/or if the user of the computer system 100 does not follow the provided instructions and the planned route is modified). In some embodiments, instead of showing the updated navigation content in the widget user interface 5030-c, the computer system generates a user interface object that presents analogous content as the widget user interface 5030-c, but is displayed above the contextually updated portion of the user interface 5020, as one of the ongoing activities, or displayed in a reduced form in the status region 5114.

FIG. 5Y shows an alternative appearance of the contextual user interface 5020, as compared to the appearance in FIGS. 5A-5X, based on the current context (e.g., at a second time 6:47, which is different from a first time of 6:07 in FIGS. 5A-5X), in accordance with some embodiments. For example, FIGS. 5A-5X show a first appearance of the user interface 5020 (e.g., where three widget user interfaces 5030-a, 5030-b, and 5030-c are available for display in the contextually updated portion of the user interface 5020), in a first context (e.g., the user of the computer system 100 is at a first location and/or searches for directions to the SFO airport). FIG. 5Y shows a second appearance of the user interface 5020 (e.g., where four widget user interfaces are available for display in the contextually updated portion of the user interface 5020, including a widget user interface 5216-a, among other contextually selected and/or contextually generated widget user interfaces) in a second context (e.g., the user of the computer system 100 is now at a second location, such as the SFO airport, and the current time is a second time that corresponds to an upcoming flight).

In some embodiments, the appearance (e.g., layout of displayed user interface elements, and/or selection of displayed user interface elements) of the user interface 5020 changes as the context of the computer system changes over time. In some embodiments, one or more user interface elements of the user interface 5020 are shared (e.g., are the same) between different contexts. In some embodiments, one or more user interface elements are different between different contexts. For example, in FIG. 5Y, the user interface 5020 includes the affordance 5022, the affordance 5024, the affordance 5026, the search bar 5032, and the affordance 5034 (e.g., which are also included in the user interface 5020 in FIGS. 5A-5X). These are referred to as components of the stable portion(s) of the user interface 5020. In contrast to FIGS. 5A-5X, however, the user interface 5020 in FIG. 5Y includes a user interface object 5214 (e.g., in lieu of and/or in place of the affordance 5028, in FIGS. 5A-5X), and a widget stack 5216 that includes a widget user interface 5216-a (e.g., in lieu of and/or in place of the widget stack 5030 that includes the widget user interfaces 5030-a, 5030-b, and 5030-c). In some embodiments, the user interface object 5214 is a notification that is displayed as a reminder for an upcoming flight. In some embodiments, instead of taking on the form of a notification, the user interface object 5214 is displayed as an ongoing activity (e.g., a flight tracking activity) that receives continuous update over time. The user interface object 5214 and the widget stack 5216 are referred to as components of the contextually updated portion(s) of the user interface 5020. In some embodiments, the user interface objects corresponding to notifications are displayed or cease to be displayed based on whether the notifications are newly received, and/or whether the notifications have been manually dismissed or dismissed automatically after they have been viewed. In some embodiments, the user interface objects corresponding to ongoing events are displayed or cease to be displayed based on whether the ongoing activities have been started and are ongoing (e.g., receiving updates), and/or whether the activities have been terminated due to natural progression of the activity or due to user request. In some embodiments, the widget user interfaces included in the contextually updated portion of the user interface 5020 are displayed or cease to be displayed based on changing contexts of the computer system and changing contextual relevance of the content of the widget user interfaces, without requiring user input directed to the user interface 5020 or the contextually updated portion thereof. In some embodiments, notifications are not part of the contextually updated portion of the user interface 5020, and notifications and the contextually updated portion of the user interface 5020 can exist independent of each other at a given time.

In some embodiments, the user interface object 5214 replaces display of the affordance 5028, and optionally, the affordance 5028 is not displayed when contextually relevant content (e.g., ongoing activities, and/or other contextually displayed application content) is available for display in the contextual user interface 5020. In some embodiments, the user interface object 5214 displays content that is periodically updated over time (e.g., the user interface object 5214 in FIG. 5Y updates to reflect the current estimated remaining time until boarding, as time passes, and/or the user interface object 5214 includes terminal and/or gate information that updates in case of a gate change for flight 1234).

In some embodiments, the widget user interface 5216-a is displayed at the top of the widget stack 5216 because the widget user interface 5216-a is the first widget user interface that is identified as relevant for the current context (e.g., as shown as the white dot at the top of the three black dots). In some embodiments, the widget user interface 5216-a is displayed because the computer system 100 determines that the widget user interface 5216-a is contextually relevant (e.g., optionally, the most contextually relevant of the available widget user interfaces) based on the second context. For example, in FIG. 5Y, the computer system 100 determines that the computer system 100 is at a location that corresponds to an airport (e.g., the SFO airport), and based off other contextual information (e.g., a boarding pass for a flight that boards in 55 minutes, as shown by the user interface object 5214), the computer system 100 determines that weather information is contextually relevant and displays the weather widget user interface with current local weather for the airport.

In some embodiments, in the second context (e.g., context of FIG. 5Y, or another context), the widget stack 5216 may include the same number of widget user interfaces as in FIGS. 5A-5X (e.g., three widget user interfaces), but includes different widget user interfaces than in FIGS. 5A-5X (e.g., at least one widget user interface other than the widget user interface 5030-a, the widget user interface 5030-b, and/or the widget user interface 5030-c). In some embodiments, the user interface 5020 in FIG. 5Y is displayed in response to the user authenticating via the user interface 5016 in FIG. 5C (e.g., FIG. 5Y replaces FIG. 5E, based on context, such as when the computer system 100 is at a location corresponding to the SFO airport). In other words, in some embodiments, the number of contextually displayed user interface objects included in the contextual user interface 5020 are not fixed and may change automatically depending on the current context. In addition, the relevant user interface objects or relative order of the relevant user interface objects included in the contextual user interface 5020 are also not fixed, and may change automatically depending on the current context.

FIG. 5Z shows a third appearance of the user interface 5020, in a third context (e.g., after some time has passed since the time shown in FIG. 5Y). In comparison to FIG. 5Y, the appearance of the user interface 5020 retains the same layout (e.g., the user interface object 5214 is still displayed and optionally updated based on the progress of an ongoing activity corresponding to the user interface object 5214); but based on the changing context, the computer system 100 displays a widget user interface 5216-b (e.g., a different widget user interface as compared to widget user interface 5216-a in FIG. 5Y). In some embodiments, the widget user interface 5216-b is automatically promoted (e.g., displayed, optionally, at the top of a “stack” of available widget user interfaces) based on context. In some embodiments, the user can configure whether the computer system 100 can automatically change the displayed widget user interface (e.g., whether the computer system 100 can automatically promote and/or demote widget user interfaces, based on context).

In FIG. 5Z, the widget user interface 5216-b includes boarding pass information, which the computer system 100 determines to be contextually relevant (e.g., more contextually relevant than displaying current weather information, as in the second context of FIG. 5Y) based on a status (e.g., “Now Boarding”) of flight 1234 (e.g., the flight corresponding to the user interface object 5214). In some embodiments, the widget user interface 5216-b (e.g., and/or one or more other available widget user interfaces) includes automatically surfaced content that is also available via a lock screen or wake screen (e.g., boarding passes or other transit tickets; identification cards, such as driver's licenses, student identification card, and/or employee identification cards; payment cards, such as credit cards, debit cards, loyalty cards, and/or rewards cards; digital keys, such as home keys, car keys, and/or hotel keys; and/or event passes or event tickets, or other user interface that is quickly accessible while the computer system 100 is in a restricted or locked state), subject to privacy and authentication restrictions (e.g., content is fully displayed after authentication is completed via facial recognition, fingerprint recognition, or password entry), which automatically provides quick access to contextually-relevant content.

FIG. 5AA shows a fourth appearance of the user interface 5020, in a fourth context (e.g., at a different time, such as after the user of the computer system 100 lands from the flight corresponding to the user interface object 5214 in FIG. 5Z). In contrast to FIG. 5Z, the user interface 5020 no longer includes the user interface object 5214 (e.g., because the user interface object 5214 is no longer relevant and/or the flight tracking activity is terminated, as the user of the computer system 100 has already boarded, and landed, on the flight referenced by the user interface object 5214), and displays the affordance 5028 (e.g., because there is no other relevant content to display in place of the affordance 5028). The user interface 5020 also includes a widget user interface 5218-a, which is one of five available widget user interfaces (e.g., in contrast to the four available widget user interfaces in FIG. 5Z). In some embodiments, the widget user interface 5218-a is a calendar widget that displays upcoming calendar appointments.

FIG. 5AB shows that, in response to detecting a user input 5220 (e.g., a downward swipe input or another scroll input), the computer system 100 displays a widget user interface 5218-b (e.g., and ceases to display the widget user interface 5218-a, in an analogous manner as described above with reference to FIGS. 5N and 5O). In some embodiments, the widget user interface 5218-a is the same as the widget user interface 5216-a in FIG. 5Y (e.g., both widget user interfaces are the same weather widget user interface), but displaying weather information corresponding to a current location of the computer system 100 (e.g., Los Angeles in FIG. 5AB, as compared to San Francisco in FIG. 5Y). In some embodiments, one or more widget user interfaces are available in multiple different contexts (e.g., the weather widget user interface is available in both FIG. 5AB and FIG. 5Y), even if they are included in a different set of contextually relevant widget user interfaces (e.g., four available widget user interfaces in the context of FIG. 5Y, and five available widget user interfaces in the context of FIG. 5AB) and/or in a different position among the same set of available widget user interfaces, depending on the context.

In FIG. 5AB, while displaying the user interface 5020, the computer system 100 detects a user input 5222 directed toward the search bar 5032. In some embodiments, the user input 5222 is a request to activate a search function (e.g., a text-based search function) of the computer system 100. In some embodiments, in response to detecting a user input 5224 directed toward the affordance 5034, the computer system 100 performs an analogous search function based on a spoken user input (e.g., verbal input or voice command).

FIG. 5AC shows the text “Rideshare” entered into the search bar 5032, in response to detecting the user input 5222 (e.g., and additional user inputs entering text inputs specifying the search criteria). In some embodiments, the text “Rideshare” appears in the search bar 5032 as search criteria in response to detecting the user input 5224 directed toward the affordance 5034, in combination with a spoken user input of “rideshare.”

FIG. 5AD shows that, in response to detecting entry of a search term into the search bar 5032, the computer system 100 displays a user interface 5226 that includes one or more search results corresponding to the search term “Rideshare” (e.g., optionally, concurrently with the search term “Rideshare”), including a search result 5228 corresponding to a rideshare application, and a search result 5230 corresponding to a taxi application. In some embodiments, the search results are displayed and updated in real-time and/or periodically, as the user inputs the search query into the search bar 5032 (e.g., optionally, FIG. 5AC is skipped, and the computer system 100 instead displays the user interface 5226 in response to detecting the user input 5222 in FIG. 5AB, or the first text input after the user input 5222). For example, when the partial search query of “Ride” is entered, the computer system 100 may display the search result 5228 (e.g., due to matching the “ride” portion of the search query), optionally, without displaying the search result 5230 (e.g., which is displayed once the user completes the text inputs to complete the search query). In some embodiments, in response to detecting a user input (e.g., a tap input 5236 or another selection input) directed to a respective search result (e.g., the search result 5228, or another search result), the computer system 100 performs a function corresponding to an application corresponding to the respective search result. Such functions are described in greater detail below, with reference to FIGS. 5AH-5AJ, in accordance with some embodiments.

FIG. 5AE is an alternative to FIG. 5AD, in accordance with some embodiments. In contrast to FIG. 5AD, where the user performs a direct search using search keywords as search criteria and the search results (e.g., applications, or other types of content) match the search keywords in the search criteria, in FIG. 5AE, the user inputs a search query using functional language (e.g., natural language describing a desired outcome, and/or a request or need that needs to be fulfilled). For example, instead of searching for a rideshare application using search keywords as in FIG. 5AD, the user instead provides a command or request in natural language “Take me to hotel X” in FIG. 5AE. In some embodiments, searching using functional language as opposed to search keywords allow the computer system to provide a broader range of search results that may be relevant to the task or outcome that is desired by the user.

FIG. 5AF shows that, in response to detecting entry of the search query into the search bar 5032, the computer system displays the user interface 5226 in the user interface 5020, which includes one or more search results satisfying the functional language in the search query. For example, the search results include a search result 5240 (e.g., optionally the same search result as the search result 5228, and corresponding to the same rideshare application), a search result 5242 (e.g., corresponding to a map and/or navigation application), and a search result 5244 (e.g., corresponding to a train or public transportation application). In some embodiments, the search result 5240, the search result 5242, and/or the search result 5244 correspond to specific subsets of functions of their respective applications based on the content of the search query (e.g., the search result 5240 automatically searches for rideshares to hotel X using the rideshare application; the search result 5242 automatically provides directions to hotel X using the map and/or navigation application; and/or the search result 5244 automatically searches for trains and/or public transportations to locations near hotel X), as opposed to generic and/or default user interfaces of the respective applications.

In some embodiments, the computer system 100 displays one or more search results where a respective search result of the one or more search results combines relevant content from multiple different applications. For example, the computer system 100 displays a search result (e.g., in the form of a single widget user interface or a user interface object of an ongoing event displayed above the widget user interfaces, in the contextually updated portion of the user interface 5020) that, when activated, uses the navigation application to provide directions for navigating to a nearby train station, then uses the train application to provide trains to stations near hotel X and corresponding train schedules (e.g., and then the navigation application provides directions for walking to hotel X from the destination train station).

In some embodiments, if (e.g., in response to and/or in accordance with a determination that) the computer system 100 is connected to (e.g., via direct contact, wirelessly, through a communication interface, through a hardware interface, and/or via other connection means) an external device (e.g., a personal or desktop computer, a TV, an external display, a smartphone, a table device, and/or another multifunction device), the computer system 100 displays additional detail in the search user interface 5226. For example, when connected to a desktop computer or another multifunction device, the computer system 100 can leverage the additional processing power of the desktop computer or the other multifunction device, to generate additional search results and/or additional content corresponding to a particular search result (e.g., the search result 5240 may include pricing information for different rideshare options; the search result 5242 may provide previews and/or information corresponding to potential routes to hotel X; and/or the search result 5244 may display some upcoming trains and/or departure times for trains heading towards hotel X). In some embodiments, when connected to an external display, the computer system 100 can leverage the external display to display the generated search results with a higher level of detail (e.g., and/or a larger size).

In some embodiments, the user can scroll through displayed search results (e.g., the number of search results that satisfy the search query is greater than can be concurrently displayed within the user interface 5226 at a given time). For example, in FIG. 5AF, the user can perform a user input (e.g., an upward or downward swipe, or another scroll input) to display additional search results (e.g., the search results could include the search result 5230, or an analogous search result to the search result 5230, corresponding to the taxi application, which also provides a method of reaching hotel X). In some embodiments, in response to detecting a user input 5236 (e.g., a tap input or another selection or activation input) directed to a respective search result (e.g., the search result 5240, or another search result), the computer system 100 performs a function corresponding to an application corresponding to the respective search result (e.g., using the rideshare application to order a ride to Hotel X, opening the rideshare application with “Hotel X” entered into a destination input region, or perform another relevant operation provided by the respective application corresponding to the respective search result).

FIG. 5AG is an alternative to FIGS. 5AD and 5AE. In FIG. 5AG, the user inputs a search query for a specific application and/or application function (e.g., uses a functional language search that includes a specific application and/or application function as keywords). For example, the user inputs a search query of “Call Rideshare to take me to hotel X,” which references a specific application (e.g., the rideshare application).

FIG. 5AH shows that, in response to detecting entry of the search query in the search bar 5032, the computer system displays a user interface 5250, which is a user interface corresponding to the rideshare application. In some embodiments, the computer system 100 automatically performs a function corresponding to the entered search query (e.g., without displaying search results corresponding to the search query). In some embodiments, the computer system 100 automatically enters the location for hotel X as the “to” location (e.g., and the current location of the computer system 100 as the “from” location), and displays rideshare options for a trip to hotel X, which includes an option 5252, an option 5254, and an option 5256 (e.g., different options corresponding to different tiers or ride types, which are available in the rideshare application). It is to be noted that, the user interface 5250 and the options 5252, 5254, and 5256 presented in FIG. 5AH are optionally different from a native user interface displayed in the rideshare application when the rideshare application is invoked from an application icon of the rideshare application in a conventional home screen user interface or application library user interface.

FIG. 5AI shows that, in response to detecting a user input 5258 (e.g., a tap input, or another selection or activation input) directed toward the option 5252 (e.g., and selecting the option 5252), the computer system displays the user interface 5020 with a fifth appearance (e.g., corresponding to a fifth context, where an active rideshare trip is in progress). As time goes on, in FIG. 5AI, the user interface 5020 includes a user interface object 5260 that provides updated status information relating to the active rideshare trip (e.g., the rideshare trip initiated by the user input 5258 in FIG. 5AH), and displays a contextually relevant widget user interface 5218-c (e.g., optionally, a widget user interface that was available, but not displayed in, the user interface 5020 of FIG. 5AA-5AH). In some embodiments, the widget 5218-c is a contextually relevant widget user interface (e.g., selected from all available widget user interfaces for the computer system 100) based on the current context (e.g., new location, new time, and/or what is nearby). In some embodiments, the widget user interface 5218-c is (or has become) the most contextually relevant widget user interface of the five available widget user interface (e.g., in the user interface 5020 in FIG. 5AA-5AH), due to the change in context. For example, the widget user interface 5218-c corresponds to a restaurant review application and displays content relating to customer reviews and comments of nearby restaurants.

FIG. 5AJ shows that the user interface object 5260 shown in the user interface 5020 updates from time to time (e.g., periodically, and/or as new information related to the ongoing activity is received) to provide new information related to the ongoing activity (e.g., the status of the requested ride, or the status of another ongoing activity represented in the user interface object 5260). For example, at 9:40 shown in FIG. 5AI, the rideshare application indicates a status of “Finding Driver” in the user interface object 5260; and at 9:42 shown in FIG. 5AJ, the rideshare application indicates a new status of “Pickup in 2 min” in the user interface object 5260 (e.g., as a driver has been found and/or assigned for this trip, and said driver is two minutes from a pickup location).

Although particular applications, application functions, and contexts are used as examples in FIGS. 5A-5AJ, it is to be understood that these examples are for illustrative purposes, and may be replaced with other applications, application functions, and contexts, in actual implementations.

FIGS. 6A-6M show examples of a computer system 100 that performs different functions in different contexts, in accordance with some embodiments. In some embodiments, the different functions refer to different primary functions, and/or include functions that are not available in a different context, such as in the standalone mode of the computer system (e.g., when the computer system 100 is not connected to an external device or not connected to certain types of external devices that causes the computer system to change its operating mode), or in one or more connected modes (e.g., when the computer system is connected to a respective external device of one or more different external devices (e.g., different types of external devices and/or using different manners of connections, that cause the computer system to change its operating mode).

FIG. 6A is analogous to FIG. 5E, and shows the computer system 100 operating in a first mode (e.g., in a standalone mode, a lightweight mode, providing access to a first set of functions and/or functioning as a first type of device). For example, in FIG. 6A, the computer system 100 operates as a mobile phone (e.g., or smartphone), using a first mobile phone operating system, and provides access to smartphone-related functions (e.g., for accessing and/or initiating communication with one or more contacts, and providing applications and application widgets in one or more full-screen user interfaces, in accordance with some embodiments. It is to be noted that, even though the computer system 100 may be in communication with one or more external devices for various basic functions of the computer system 100, such as a cellular transmitter for a cellular network, one or more network devices that provide Internet or local area network connections, and/or one or more servers of various network services, these functions are controlled by the primary operating system of the computer system (e.g., a smartphone operating system, or a lightweight smartphone operating system) in the standalone mode of the computer system.

FIG. 6B is analogous to FIG. 5Q, and shows that the computer system 100 can be in communication with one or more external devices, including the personal computer system 5148 (e.g., a desktop or laptop computer), the television 5150, the tablet device 5152, an external display 6000, and/or a speaker 6002. Connections to other types of external devices are possible, and are not enumerated in the interest of brevity. Additional details regarding communication with, and optionally connection to, such external devices are described in greater detail below, with reference to FIGS. 6C-6M, in accordance with some embodiments. As described herein, when the external device and/or the type of connection meets certain criteria, the computer system changes its operating mode (e.g., primary function, operating system, and/or available functionality), based on the type of external device, the type of connection, and/or the manner of the connection, that is established between the computer system 100 and the external device, in accordance with some embodiments.

In some embodiments, prior to connecting to (e.g., and/or establishing communications with) a respective external device of the one or more external devices, the computer system 100 provides a first set of functions (e.g., and/or operates in the first mode) in accordance with a first operating environment of the computer system 100. For example, the computer system 100 operates as a mobile phone and/or smartphone, and provides phone-based functions (e.g., functionality for placing phone calls, sending text messages, accessing the internet via a mobile browser, or other phone-based functions) in accordance with a mobile phone operating system.

In some embodiments, once the computer system 100 connects to (e.g., establishes communications with, using a first type and/or manner of connection) a respective external device of the one or more external devices, the computer system 100 provides a second set of functions that is different than the first set of functions (e.g., operates in a second mode that is different than the first mode, and optionally, operates as a different type of device) in accordance with a second operating environment of the computer system 100 (e.g., the second operating environment may be an operating system of the respective external device, or another operating system of the computer system 100). In some embodiments, at least some functions are common between the first set of functions and the second set of functions (e.g., the computer system 100 retains some types of functionality regardless of whether the computer system 100 is or is not connected to an external device that triggers the change of the operating environment of the computer system 100). In some embodiments, the second set of functions includes contextually relevant functions that are selected based on characteristics of the external device (e.g., the type of external device, the type and/or manner of connection, and/or the relative strengths of certain hardware capabilities between the computer system and the external device) to which the computer system 10 is connected. In some embodiments, once the computer system 100 connects to a respective external device of the one or more external devices, the computer system 100 operates in a dual operating system mode that control the computer system and the external device in accordance with two different operating systems (e.g., as opposed to a single or standalone operating system mode, in which the computer system 100 operates when not connected to an external device).

FIG. 6C shows an example where the computer system 100 is in communication with, and connected to, the television 5150, in accordance with some embodiments. The computer system 100 is physically moved into close proximity of the television 5150 (e.g., the dotted outline shows the computer system 100 at a distant location that is not in proximity to the television 5150).

FIG. 6D shows a side view of the computer system 100 and the television 5150 when the computer system 100 is in close proximity with the television 5150, in accordance with some embodiments. In some embodiments, the computer system 100 is physically connected to the television 5150 (e.g., via a port, a cable, or other physical connection interface). In some embodiments, the computer system 100 is wirelessly connected to the television 5150, e.g., via a Bluetooth connection, a WiFi connection, or another type of wireless connection. In some embodiments, the computer system 100 is magnetically connected to the television 5150 (e.g., or a portion, such as a stand or base portion, an edge, or a soundbar, of the television 5150). In some embodiments, the television 5150 includes a magnetic connector 6004, which can be used to charge, be charged by, and/or exchange information with, the computer system 100.

FIG. 6E shows a user interface 6006 (e.g., displayed via the television 5150) and a user interface 6008 (e.g., displayed via the computer system 100), while the computer system 100 is connected to the television 5150 (e.g., in the manner shown in FIGS. 6C and 6D, and/or with another manner of connection). In some embodiments, the user interface 6006 includes television media (e.g., a television show, a movie, a sports broadcast, or other television content), and the user interface 6008 displays information corresponding to the television media (e.g., a television show name, a season number, and/or an episode number), and optionally includes playback information such as a progress bar 6010 (e.g., that displays a total run time, a remaining run time, a current progress, and/or a current time stamp, corresponding to the playing television media).

In some embodiments, the computer system 100 provides the television media to the television 5150 (e.g., transmits content to be displayed by the television, while retrieving the content from a remote service provider or from a local storage device). In some embodiments, the computer system 100 receives media information about the television media from the television 5150 (e.g., the television retrieves media content from a remote service provider or local storage device, while sending media information to the computer system 100). In some embodiments, the computer system 100 provides instructions (e.g., playback instructions, and/or TV adjustment instructions) and/or content (e.g., media content and/or streaming content that is displayed on the television) to the television 5150 and the television 5150 receives the instructions and/or the content from the computer system 100, in accordance with the operating environment of the computer system 100. In some embodiments, the computer system 100 provides instructions (e.g., playback instructions, and/or TV adjustment instructions) and/or content (e.g., media content and/or streaming content that is displayed on the television) to the television 5150 and the television 5150 receives the instructions and/or the content from the computer system 100, in accordance with the operating environment of the television 5150. In some embodiments, the television 5150 provides instructions (e.g., status display instructions and/or control display instructions) and/or content (e.g., playback status information, and/or media content metadata) to the computer system 100 and the computer system 100 receives the instructions and/or content from the television 5150, in accordance with the operating environment of the computer system 100. In some embodiments, the television 5150 provides instructions (e.g., status display instructions and/or control display instructions) and/or content (e.g., playback status information, and/or media content metadata, such as show name, season and episode number, timestamp) to the computer system 100 and the computer system 100 receives the instructions and/or content from the television 5150, in accordance with the operating environment of the television 5150.

In some embodiments, before the computer system 100 is connected to the television 5150, the television is in a power off and/or low-power state (e.g., in FIG. 6C, the display of the television 5150 is off as the computer system 100 is being moved to connect to the television 5150). In response to connecting the computer system 100 to the television 5150 (e.g., when the computer system 100 makes contact with the base of the television, or establishes another type of connection that meets connection criteria), the television 5150 is automatically turned on (e.g., and/or exits the low-power state), and optionally, automatically begins playing media content (e.g., as shown in FIG. 6E), without requiring the user to manually turn on the television using a power button or remote control of the television 5150.

FIG. 6F shows an alternative to FIG. 6E, where the computer system 100 instead displays a user interface 6012, in accordance with some embodiments. The user interface 6012 can be used to display contextually relevant information and/or time-sensitive information, without affecting the display of the user interface 6006 on the television 5150. For example, in FIG. 6F, the user interface 6012 includes a visual display indicating the remaining time for a running timer (e.g., based on and/or using a timer function of the computer system 100, e.g., a function of the computer system 100 unrelated and independent of the television 5150), which optionally includes a progress bar for additional visual feedback. The user interface 6012 optionally includes an affordance 6014 (e.g., which when activated, pauses the running timer) and an affordance 6016 (e.g., which when activated, stops or cancels the running timer). The computer system 100 also displays a notification 6018 or status indicator, which indicates that the computer system 100 is currently charging (e.g., optionally, via the connection to the television 5150), and optionally provides additional status information such as a current battery level (e.g., 38%). In some embodiments, the user interface 6012 displays status notifications (e.g., notifications generated by the computer system 100, the television 5150, and/or another device connected to the computer system 100).

In some embodiments, the computer system 100 is operating in a dual operating system mode. For example, the computer system 100 operates in a television operating system mode, and transmits instructions and/or television content to the television 5150 for display in accordance with the television operating system. The computer system 100 simultaneously operates in a phone operating system mode, in which the computer system 100 continues to receive and display notifications (e.g., relating to text messages, phone calls, video calls, or other phone-based functions, including functions of applications installed on the phone operating system).

FIG. 6G shows an alternative to FIGS. 6C and 6D, where the computer system 100 is wirelessly connected to the television 5150, in accordance with some embodiments. In some embodiments, in response to detecting that the computer system 100 is wirelessly connected to the television 5150 (e.g., as opposed to being connected to the television in the manner shown in FIGS. 6C and 6D), the television automatically displays a user interface 6020 that includes a plurality of options for available content (e.g., a Movie 1, a Movie 2, a Movie 3, and a Movie 4). The computer system 100 display a user interface 6008 for navigating between different categories of available content (e.g., between television content, content of a media application, and/or video or movie content). In some embodiments, the computer system 100 operates in the phone operating system mode, when connected to the television 5150 in this wireless manner. In some embodiments, the computer system 100 operates in the television operating system mode, when connected to the television 5150 in this wireless manner. In some embodiments, the computer system 100 operates in the dual operating system mode, when connected to the television 5150 in this wireless manner.

FIG. 6H shows the computer system 100 in a portrait orientation while connected wirelessly to the television 5150, in accordance with some embodiments. In some embodiments, the computer system 100 displays a different user interface based on an orientation of the computer system 100 (e.g., landscape vs. portrait, supine vs. prone, and/or other different sets of orientations). For example, in FIG. 6G, in accordance with a determination that the computer system 100 is in a landscape orientation when connected to the television (e.g., wirelessly, and/or via direct contact), the user interface 6008 for navigating between different categories of content is displayed. In contrast, in FIG. 6H, in accordance with a determination that the computer system 100 is in a portrait orientation when connected to the television (e.g., wirelessly, and/or via direct contact), the computer system 100 displays a user interface 6030 for providing a plurality of controls corresponding to the television 5150. Such controls optionally include an affordance 6032 (e.g., a power affordance for turning on or turning off the television 5150), an affordance 6034 (e.g., a play/pause affordance, and/or other media control affordance, for controlling media playback), an affordance 6036 (e.g., a mute affordance), an affordance 6038 (e.g., for increasing or decreasing a volume of the television 5150, or for navigating between different television channels), and an affordance 6040 (e.g., for navigating in and/or between menus of the television 5150). In some embodiments, the computer system displays the user interface 6030 and 6008 in accordance with the primary operating system of the computer system 100 (e.g., the phone operating system, or another operating system if the computer system 100 is a different type of device), and controls the television (e.g., based on the user interaction with the controls in the user interface 6030 and 6008) in accordance with the operating system of the television 5150 (e.g., the computer system 100 activates a secondary operating system that is the same as the operating system of the television 5150 to control the television 5150).

FIG. 6I shows the computer system 100 with a physical connection to the personal computer system 5148. In some embodiments, the computer system 100 is connected to the personal computer system 5148 via a physical connector 6042 (e.g., a cable, a port, or another physical connector).

FIG. 6J shows that, when (e.g., in response to and in accordance with a determination that) the computer system 100 is connected to the personal computer system 5148, the computer system 100 is operated as a type of peripheral device of the personal computer system 5148, in accordance with some embodiments. In FIG. 6J, the computer system 100 displays a user interface 6045, where the computer system 100 is used as an external trackpad or other input device for interacting with the personal computer 5148. While the personal computer 5148 displays a user interface 6044 using its own display, and the user of the computer system 100 can perform inputs on and/or with the computer system 100, to control (e.g., move and/or reposition) a cursor 6046 (e.g., sometimes referred to herein as a “focus selector”) in the user interface 6044 of the personal computer 5148. For example, the user performs a user input 6047 (e.g., along a touch-sensitive surface such as a touch screen, of the computer system 100) that moves from a first location (e.g., as shown in the dashed outline, at the beginning of the arrow) to a second location (e.g., the solid outline at the end of the arrow). In response to detecting the user input 6047, the computer system 100 moves the cursor 6046 moves from a first location (e.g., marked by the dashed outline at the beginning of the arrow in the user interface 6044) to a second location (e.g., the solid outline at the end of the arrow) in the user interface 6044 of the personal computer system. In some embodiments, the cursor 6046 moves by an amount that is proportionate (e.g., and in the same direction as) the movement of the user input 6047. In some embodiments, the computer system 100 sends the control instructions to the personal computer in accordance with the operating system of the personal computer (e.g., a desktop or laptop computer operating system). In some embodiments, the user interface 6044 displayed on the display of the personal computer 6044 is a user interface displayed in accordance with the operating system of the computer system 6044 and the control instructions sent to the personal computer is also in accordance with the operating system of the computer system 6044 (e.g., in accordance with a determination that the computer system 100 has a more processing power than the computer system 6044, while the computer system 6044 has a better display than the computer system 100).

FIG. 6K shows the computer system 100 connected to the external display 6000 (e.g., via a physical or wireless connection) in a first context (e.g., a first location and/or at a first time). In some embodiments, while connected to the external display 6000, the computer system 100 (e.g., in response to, and in accordance with a determination that the computer system is connected to the external display 6000) provides content to be displayed via the external display 6000 (e.g., the computer system 100 switches from operating as a phone with a single small display and displaying content in a full screen mode, prior to connecting to the external display 6000, to functioning as a device that has extended display areas that support a desktop with multi-window display mode, after the connection to the external display 6000. In some embodiments, while connected to the external display 6000, the computer system 100 (e.g., in response to, and in accordance with a determination that the computer system is connected to the external display 6000) provides content to be displayed via the external display 6000 (e.g., the computer system 100 switches from operating a phone operating system, prior to connecting to the external display 6000, to operating a tablet operating system, a personal computer operating system, or a hybrid operating system combining a phone operating system and a tablet or personal computer operating system, after the connection to the external display 6000. For example, in some embodiments, the computer system 100 displays an affordance 6054 (e.g., corresponding to a mail application and/or email content), an affordance 6056 (e.g., corresponding to a web browser application and/or web content), an affordance 6058 (e.g., corresponding to a stocks application and/or stocks content), and an affordance 6060 (e.g., corresponding to a notepad application and/or notes content), optionally in an application library or home screen user interface of the phone operating system such as that shown in FIG. 5D, or a simplified or lightweight application launcher user interface such as the user interface shown on the display of the computer system 100 in FIG. 6K or a contextual user interface 5020 shown in FIGS. 5A-5AJ. In some embodiments, the computer system 100 also functions as an input device (e.g., a trackpad or other navigation-related input device) for the user interface(s) shown on the external display 6000, and the user can perform user inputs such as a user input 6064 in a region 6062 (e.g., the computer system 100 simultaneously operates as a desktop computer (or a tablet computer), providing instructions to the external display 6000, and as an input device, in accordance with a desktop computer operating or tablet computer operating system). FIG. 6K shows that, in response to detecting a user input 6066 (e.g., a tap input or another type of selection or activation input) directed toward the affordance 6054, the computer system 100 causes the external display 6000 to display a mail user interface 6048 (e.g., that includes mail content, such as emails), optionally in a window on a desktop. In some embodiments, the computer system also causes the external display 6000 to display a dock 6050 that includes a plurality of affordances for accessing different content that is available for display (e.g., the same content that can be accessed via the affordance 6054, the affordance 6056, the affordance 6058, and/or the affordance 6060, of the computer system 100, and/or other content available via the computer system 100).

In some embodiments, the computer system 100 displays a visual indication 6056 corresponding to a respective user profile of two or more user profiles for the computer system 100. In some embodiments, different content is available and/or can be customized for different user profiles. In some embodiments, a user can switch between different user profiles and changing the content shown via the display of the computer system 100 and/or the external display 6000, by interacting with (e.g., tapping on or otherwise performing user inputs directed toward) the visual indication 6056. In some embodiments, the computer system 100 provides different content, on the display of the computer system and/or on the external display 6000, in different contexts (e.g., when different user profiles are selected, and/or based on other criteria such as a current time or a current location).

FIG. 6L shows the computer system 100 connected to the external display 6000 (e.g., via a physical or wireless connection) in a second context (e.g., a second location and/or at a second time, different from the first location and/or the first time). In contrast to FIG. 6K, in FIG. 6L, the computer system 100 displays an affordance 6078 (e.g., corresponding a video application and/or video content), an affordance 6082 (e.g., corresponding to a media application and/or media content), an affordance 6084 (e.g., corresponding to a fitness application and/or health and fitness content), and an affordance 6086 (e.g., corresponding to a music application and/or music content). In some embodiments, the computer system displays a contextual user interface 5020 in accordance with the description provided with respect to FIGS. 5A-5AJ, for example. In some embodiments, one or more user interface elements (e.g., affordances and/or other application content) are shared across different contexts (e.g., displayed in a stable portion of the contextual user interface 5020, or another portion of the user interface displayed on the display of the computer system 100 in 6K-6M). For example, the affordance 6056 and the region 6062 appear in both FIG. 6K (e.g., the first context) and FIG. 6L (e.g., the second context).

In response to detecting a user input 6088 (e.g., a tap input or another type of selection or activation input) directed toward the affordance 6078, the computer system 100 causes the external display 6000 to display a video user interface 6068 (e.g., a video user interface of a media player application, a streaming service application, or another application or video content source available to the computer system 100), in accordance with some embodiments. The video user interface 6068 includes different categories of available video content, such as a horror category 6070, an action category 6072, a cooking category 6074, and a sports category 6076, in accordance with some embodiments. In some embodiments, the external display 6000 displays a dock 6050 that includes a plurality of affordances for accessing different content that is available for display based on a current context (e.g., in contrast to the first context of FIG. 6K, the dock 6050 includes a different plurality of affordances in the second context of FIG. 6L). In some embodiments, the region 6062 is the touch-screen of the computer system 100 continues to serve as an input region for interacting with the user interface(s) displayed on the external display 6000, in accordance with an active operating system of the computer system (e.g., a tablet operating system, or a personal computer operating system), in parallel to the smartphone operating system or instead of the smartphone operating system of the computer system 100.

FIG. 6M shows the computer system 100 connected to the external display 6000 (e.g., via a physical or wireless connection) in a third context (e.g., where a different user profile is active). A visual indication 6100 indicates that a user profile LK is in use for the computer system 100. The computer system 100 displays a different set of affordances, including the affordance 6078, and the affordance 6086 (e.g., but not other affordances available in FIG. 6K or 6L). For example, the user profile LK may correspond to a child's user profile, and so a different (e.g., smaller) amount of content is available while the user profile LK is in use. In response to detecting a user input 6098 directed toward the affordance 6078, the external display 6000 displays a video user interface 6090. In contrast to the video user interface 6068 in FIG. 6L, the video user interface 6090 in FIG. 6M includes different categories, such as a learning category 6092, a cartoon category 6094, and a nature category 6096, in accordance with some embodiments.

In FIGS. 6A-6M, although some device types are used in the examples to describe the functions of the computer system 100 and the functions of the external device connected to the computer system 100, it is to be understood that, in various embodiments, the device type of the device mentioned in the examples can be replaced and/or changed to trigger analogous behaviors of the computer system 100 and the external device connected to the computer system 100. In addition, although in the examples, the computer system 100 is sometimes described as being connected to another device that is of a different device type or running a different operating system from the computer system 100, in various embodiments, the external device can also be a device that has the same type of operating system as the computer system 100. In such a scenario, one of the computer system 100 and the external device can dominate the operations and control the other device, or the operations can be coordinated between the two devices, as if they are controlled by a single operating system but perform different roles under the single operating system.

FIGS. 7A-7I are flow diagrams illustrating method 70000 for displaying and interacting with contextually-updated user interfaces, in accordance with some embodiments. Method 70000 is performed at a computer system or electronic device (e.g., device 300, FIG. 3A, or portable multifunction device 100, FIG. 1A) that is in communication with one or more display generation components (e.g., touch-screen displays, projectors, LCD displays, displays with optical and/or video passthrough portions, and/or other types of displays) and one or more input elements (e.g., input devices and/or sensors for detecting user inputs, such as touch-sensitive surfaces, touch-screen displays, solid-state input regions, buttons, levels, image sensors, gyros, motion sensors, proximity sensors, pressure sensors, touch-sensors, orientation sensors, fingerprint sensors, microphones, temperature sensors, ambient light sensors, geolocation sensors, and/or other types of input elements). In some embodiments, the computer system is a smartphone device that provides a telephony function using a cellular network. In some embodiments, in addition to the first user interface describe herein, the computer system provides a full-function home user interface that includes application icons corresponding to different system applications and user-installed applications, where the computer system displays default or native user interfaces of the applications on a display of the computer system when a user launches the applications using their respective application icons. In some embodiments, the application icons that are included in the full-function home screen user interface are arranged based on prior user configuration and remain substantially unchanged in location and number unless user reconfigures the locations of the application icons in a home screen reconfiguration mode and saves the new configuration of the home screen user interface. In some embodiments, the full-function home user interface also includes one or more widgets or widget stacks, where a respective standalone widget or a currently displayed widget in a widget stack provides a subset of application functions and application content from a corresponding application of the respective standalone widget or currently displayed widget in the widget stack. Similar to application icons in the full-function home user interface, the standalone widgets and widget stacks do not change in location and number, unless a user moves, removes, or adds widgets or widget stacks in the home user interface in a home screen reconfiguration mode and saves the changes. In some embodiments, in addition to the full-function home user interface, or, optionally, instead of the full-function home user interface, the computer system provides a light-version of the home user interface that directly provides contextually selected application functions that may differ in the selected applications, the selected subset of application functions, the number of selected applications and/or application functions, and/or how the selected applications and functions are arranged in a contextually updated portion of the light-version of the home user interface. As used herein, a home user interface refers to an initial user interface that is displayed when the computer system exits a restricted state of the computer system in response to a user request received while the computer system was in the restricted state, where the computer system automatically enters the restricted state of the computer system after a period of inactivity by a user or when the user locks the computer system after interacting with the computer system in the normal mode, e.g., by pressing a power button or lock button to turn off the display or send the computer system from a normal mode into a low-power mode. In some embodiments, the computer system does not provide a full-function home screen, and the computer system operates in the light-version of the home user interface by providing interactive content and application functions in a contextually updated portion of the light-version of the home user interface. In some embodiments, the computer system optionally provides the full-function home screen and default user interfaces of the applications installed on the computer system, only after the computer system is coupled to or paired with another device, such as another smartphone, a display, a tablet device, a laptop, a projector, a smart home device, and/or a desktop computer, e.g., as described in other parts of the present disclosure. In some embodiments, the computer system optionally provides an affordance to access the full-function home screen in the light-version of the home screen user interface, and exits the light-version of the home screen user interface when the affordance is selected by a user input. In some embodiments, the computer system automatically activates a first mode in which the full-function home user interface is used when exiting the restricted mode, or a second mode in which the light-version of the home user interface is used when exiting the restricted mode, depending on the context, such as the location (e.g., indoor or outdoor, traveling or settled, on the beach or in the city), the time (e.g., working hours or off duty hours, work day or weekends, nonvacation or vacation), and the other contextual conditions. In some embodiments, the display generation component is a touch-screen display and the touch-sensitive surface is on or integrated with the display generation component. In some embodiments, the display generation component is separate from the touch-sensitive surface. Some operations in method 70000 are, optionally, combined and/or the order of some operations is, optionally, changed.

As described below, the method 70000 includes displaying a first user interface that includes a respective plurality of user interface objects corresponding to a respective set of application functions provided by a respective plurality of applications, in accordance with a determination that a current context of the computer system meets a respective set of contextual criteria, which automatically provides access to contextually relevant application functions without requiring additional user inputs (e.g., additional user inputs to enable or disable different application functions in different contexts). The number of contextually relevant application functions are automatically adjusted based on the current context and availability of contextually relevant application functions, without requiring additional user inputs, and without unnecessarily cluttering up the user interface and/or omitting contextually relevant application functions.

While the computer system is in a restricted state (e.g., in a power-saving mode, in a low-power mode, in a dimmed always-on state, displaying a wake screen user interface, displaying a lock screen user interface, displaying a coversheet user interface, or in another state in which access to applications and functions of applications is restricted until the computer system exits the restricted state in response to a user request), the computer system detects (70002), via the one or more input elements, a first event that corresponds to a request to exit the restricted state of the computer system (e.g., the computer system detects a user input that unlocks the computer system and/or dismisses the restriction on access to the computer system, such as a swipe on the wake screen user interface to dismiss the wake screen user interface, and/or receipt of authentication information, such as a valid fingerprint, a valid facial recognition result, and/or a valid password, while a lock screen user interface is displayed). For example, in some embodiments, the user input 5014 in FIG. 5B, optionally, in combination with additional user inputs to authenticate the device via the user interface 5016 in FIG. 5C, is detected when the device is in a restricted state.

In response to detecting the first event, the computer system displays (70004), via the one or more display generation components, a first user interface that corresponds to a starting state of the computer system upon exiting the restricted state of the computer system (e.g., the first user interface is an application launching user interface, a home screen user interface, or another default initial user interface that displays applications and functions that are available for access to the user right after exiting the restricted state of the computer system) (e.g., such as the user interface 5020 in FIG. 5E that is displayed in response to the user input and authentication information received in FIGS. 5B and 5C).

Displaying the first user interface includes: in accordance with a determination that a current context of the computer system meets a first set of contextual criteria (e.g., first contextual criteria that are based on the location, user identity, time, previous user interactions, unread notifications, and/or other settings and current state of the computer system), displaying (70006), via the one or more display generation components, a first plurality of user interface objects (e.g., application user interfaces, widgets, and/or user interface objects, that provide access to a subset of application functions) corresponding to a first set of application functions provided by a first plurality of applications (e.g., a subset of application functions that are relevant to the current context, e.g., as determined by artificial intelligence and/or other computational processes), wherein the first plurality of user interface objects includes a first number of user interface objects (e.g., in FIG. 5E, the user interface 5020 includes a widget stack 5030 that includes three widget user interfaces that are determined to be relevant to the current context); and in accordance with a determination that the current context meets a second set of contextual criteria (e.g., second contextual criteria that are based on the location, user identity, time, previous user interactions, unread notifications, and/or other settings and current state of the computer system), different from the first set of contextual criteria, displaying (70008), via the one or more display generation components, a second plurality of user interface objects corresponding to a second set of application functions provided by a second plurality of applications (e.g., a subset of application functions that are relevant to the current context, e.g., as determined by artificial intelligence and/or other computational processes).

The second plurality of user interface objects includes (70010) a second number of user interface objects that is different from the first number of user interface objects (e.g., in FIG. 5Y, the user interface 5020 includes a widget stack 5216 that includes four widget user interfaces that are determined to be relevant to the current context, as compared to the three widget user interfaces of the widget stack 5030 determined according to a different current context in FIG. 5E).

The second set of application functions are (70012) different from the first set of application functions (e.g., in FIG. 5Z, the widget user interface 5216-b corresponds to an application function that is not available via the widget user interface 5030-a, the widget user interface 5030-b, or the widget user interface 5030-c, in FIGS. 5A-5X, due to the different current contexts for which the widget user interfaces 5126 and 5030 were displayed). In some embodiments, the current context of the computer system (e.g., internal state, recent activities on the computer system, recent notifications, recent updates on monitored ongoing events, states of one or more image or audio sensors, orientation of device, ambident environment, location, type of location, changes in location, current time, current time of day, ownership, authentication state, authenticated user profile, and/or other internal and external states and/or history of the computer system) is a context of the computer system at the time or within a respective time window of when the first event was detected (e.g., a time window that includes at least some amount of time before detecting the first event, a time window that includes both an amount of time before and an amount of time after detecting the first event, and/or a time window that includes a period of time after the first event was detected and before the computer system reenters the restricted state, (e.g., due to user input, or passage of time with inactivity)). In some embodiments, the computer system automatically selects the applications and/or relevant user interfaces from the applications to provide application functions that are relevant to the current context, such as user interfaces of one or more communication applications for reviewing and replying recently received communications, user interface of navigation from one or more maps applications when the computer system is traveling with a user on a highway or inside of vehicle, or user interfaces for managing deliveries and/or purchases from one or more online payment applications when the computer system is placed in proximity to a POS point-of-sale device and/or one or more frequently visited stores. In some embodiments, the computer system determines the relative relevance of available application functions for different contexts using various generative artificial intelligence and machine learning processes, based on aggregated user interaction data and/or interaction history of individual users with adequate user consent. In some embodiments, depending on the context, different sets of applications, and/or different sets of application functions are identified as being relevant to the current context, and as a result, different numbers of user interface objects may be displayed to provide access to the relevant application functions for the current context. In other words, the computer system does not necessarily provide a fixed number of user interface objects in the starting state after exiting the restricted state of the computer system, but instead, the computer system determines which application functions are relevant to the current context, and generate the user interface objects to provide access to these relevant application functions in the starting user interface of the computer system. In some embodiments, displaying the first/second plurality of user interface objects in accordance with the current context meeting the first/second set of contextual conditions includes concurrently displaying a portion of two or more of the first/second plurality of user interface objects, and scrolling through the first/second plurality of user interface objects in response to one or more scrolling inputs (e.g., swiping, tapping on different ones of the first/second plurality of user interface objects). In some embodiments, displaying the first/second plurality of user interface objects includes displaying at least one of the first/second plurality of user interface objects along with a respective indication of a total number of objects included in the first/second plurality of user interface objects, and scrolling through the first/second plurality of user interface objects in response to one or more scrolling inputs. In some embodiments, displaying the first/second plurality of user interface objects includes displaying individual objects of the first/second plurality of user interface objects in a stack, representations of each individual object are concurrently visible, and a respective user interface object can be brought to the top of the stack by a selection input on the representation of the respective user interface object. In some embodiments, the disclosures regarding the respective characteristics and interaction behaviors of a user interface object from the first plurality of user interface objects are illustrative and are also applicable to another user interface object from the first plurality of user interface object, and/or user interface objects from other pluralities of user interface objects displayed in other contexts, and are not repeated for each user interface object in the interest of brevity. In some embodiments, some of the respective characteristics and interaction behaviors are common across different user interface objects; and some of the respective characteristics and interaction behaviors are analogous but have different object-specific features.

In some embodiments, displaying the first user interface includes (70014), in accordance with a determination that the current context meets a third set of contextual criteria, different from the first set of context criteria and the second set of contextual criteria, displaying a third plurality of user interface objects corresponding a third set of application functions provided by a third plurality of applications (e.g., a subset of application functions that are relevant to the current context, e.g., as determined by artificial intelligence or other computational processes). The third plurality of user interface objects includes a third number of user interface objects that is the same as the first number of user interface objects or the second number of user interface objects, and the third set of application functions are different from the first set of application functions and the second set of application functions. In some embodiments, depending on the context, different sets of applications, and/or different sets of application functions are identified as being relevant to the current context. Sometimes, the number of user interface objects that may be displayed to provide access to the relevant application functions for the current context can be the same as the number of user interface objects that were displayed to provide access to the relevant application functions for a previous, different, context. In other words, the computer system does not necessarily provide a fixed number of user interface objects in the starting state after exiting the restricted state of the computer system, but instead, the computer system determines which application functions are relevant to the current context, and generate the user interface objects to provide access to these relevant application functions in the starting user interface of the computer system, which may be more than, fewer than, or equal in number to, the relevant application functions provided in a different context. In an example, as described with reference to FIG. 5Y, in some embodiments, in the different context (e.g., of FIG. 5Y), the user interface 5020 includes a stack of widget user interfaces that includes the same number of widget user interfaces as in FIGS. 5A-5X (e.g., three widget user interfaces), but the stack of widgets includes different widget user interfaces than in FIGS. 5A-5X (e.g., at least one widget user interface in place of the widget user interface 5030-a, the widget user interface 5030-b, and/or the widget user interface 5030-c). Displaying a third plurality of user interface objects in accordance with a determination that the current context meets a third set of contextual criteria, wherein the third plurality of user interface objects includes the same number of user interface objects as a first or second plurality of user interface objects, which are displayed in accordance with a determination that the current context meets a first or second set of contextual criteria, respectively, and wherein the third plurality of user interface objects corresponds to a third set of application functions which are different from a first or second set of application functions that correspond to the first or second plurality of user interface objects, respectively, automatically provides access to contextually relevant application functions without requiring additional user inputs (e.g., additional user inputs to enable or disable different application functions in different contexts).

In some embodiments, the first plurality of user interface objects includes (70016) at least a first user interface object providing access to a first application function of a first application and a second user interface object providing access to a second application function of a second application, and the first application function of the first application and the second application function are identified and provided in the starting state by the computer system in accordance with the first set of contextual criteria. In some embodiments, the second plurality of user interface objects includes a third user interface object providing access to a third application function of a third application and a fourth user interface object providing access to a fourth application function of a fourth application. The third application function of the third application and the fourth application function of the fourth application are identified and provided in the starting state by the computer system in accordance with the second set of contextual criteria. In some embodiments, the first application function of the first application and/or the second application function of the second application are not included in the second plurality of user interface objects by the computer system, in accordance with the second set of contextual criteria (e.g., deemed insufficiently relevant for the current context based on the second set of contextual criteria); and the third application function of the third application and/or the fourth application function of the fourth application are not included in the first plurality of user interface objects by the computer system, in accordance with the first set of contextual criteria (e.g., deemed insufficiently relevant for the current context based on the first set of contextual criteria). In an example, as shown in FIG. 5O, the user interface 5020 includes a first user interface object (e.g., the widget user interface 5030-b) that provides access to a first application function of a first application (e.g., a reading list function of a web browser application), and in FIG. 5T, the user interface 5020 includes a second user interface object (e.g., the widget user interface 5030-c) that provides access to a second application function of a second application (e.g., a search function of a map application). For example, in FIG. 5F, the user interface 5036 (e.g., which is analogous to the user interface 5020 in FIGS. 5O and 5T) includes the individual user interface 5040 (e.g., that corresponds to the widget user interface 5030-b in FIG. 5O) and the individual user interface 5042 (e.g., that corresponds to the widget user interface 5030-c in FIG. 5T), which are concurrently displayed. The computer system displays a first plurality of user interface objects, including at least a first user interface object providing access to a first application function and a second user interface object providing access to a second application function, in accordance with a first set of contextual criteria, automatically provides access to contextually relevant application functions without requiring additional user inputs (e.g., additional user inputs to enable or disable different application functions in different contexts).

In some embodiments, displaying the first plurality of user interface objects in the first user interface includes (70018) displaying the first plurality of user interface objects concurrently with a portion of the first user interface that includes first content (e.g., background, live activities, current time, a search affordance or input region, and/or preselected widgets), and displaying the second plurality of user interface objects in the first user interface includes displaying the second plurality of user interface objects concurrently with the portion of the first user interface that includes the first content (e.g., background, live activities, current time, a search affordance or input region, and/or preselected widgets). In some embodiments, the portion of the first user interface that includes the first content includes a background of the first user interface and optionally one or more user interface objects that are persistently displayed for across different contexts, and with different sets of contextually displayed user interface objects. In some embodiments, the one or more user interface objects of the first user interface that are persistently displayed across different contexts includes a time element that displays the current time, one or more preselected widgets that displays application content that is updated from time to time based on updates provided by their corresponding applications. In some embodiments, the one or more user interface objects of the first user interface includes one or more live activities that provide updates on one or more ongoing events or activities that have been selected by the user, and that cease to be displayed when the events or activities end. In an example, as shown in FIG. 5T, the widget user interface 5030-c is displayed concurrently with the search bar 5032, the affordance 5022, the affordance 5024, the affordance 5026, and the time element. For example, in FIG. 5F, the user interface 5038 (e.g., and the user interface 5040, and the use interface 5042) is concurrently displayed with the search bar 5032, the affordance 5022, the affordance 5024, the affordance 5026, and the time element. Displaying a first plurality of user interface objects with a portion of the first user interface that includes first content, and displaying a second plurality of user interface objects with the first user interface that includes the first content, provides a combination of consistent content (e.g., for frequently viewed content, frequently accessed status information, and/or frequently performed operations) in combination with a contextually relevant content, which reduces the number of user inputs needed to perform appropriate functions (e.g., the computer system automatically provides concurrent access to frequently used functions, frequently viewed content, and contextually relevant content).

In some embodiments, while displaying the first user interface including the first plurality of user interface objects (or another plurality of user interface objects that are selectively displayed in accordance with a set of contextual criteria suitable for the current context), the computer system detects (70020), via the one or more input elements, selection of the first user interface object (e.g., detecting a tap gesture on the touch-screen display at the location of the first user interface object that causes selection of the first user interface object, or detecting another type of selection input that is directed to the first user interface object and that meets selection criteria, that causes the selection of the first user interface object); and in response to detecting the selection of the first user interface object, the computer system increases visual prominence (e.g., increase the size, display area, and/or content) of the first user interface object relative to the second user interface object (e.g., other user interface objects different from the first user interface object among the first plurality of user interface objects, e.g., optionally, while maintaining display of at least a portion of the first user interface with the first user interface object). For example, in some embodiments, when the first user interface object is selected by the user, the first user interface and user interface objects other than the first user interface object are pushed back into the background of the expanded first user interface object. In some embodiments, at least a portion of the first user interface remains accessible to user inputs (e.g., a tap to bring back the default view of the first user interface, or a tap on the search user interface to provide search inputs) outside of the bounds of the expanded first user interface object. In some embodiments, increasing the visual prominence of the first user interface object relative to the second user interface object and other user interface objects of the first user interface includes reducing visual prominence of the second user interface object and other user interface objects by reducing their sizes, opacity, and complexity of these user interface objects. In some embodiments, increasing the visual prominence of the first user interface object relative to the second user interface object includes displaying the first user interface object or an expanded version thereof at a reduced depth from the viewpoint of the user, and/or displaying the first user interface and/or other user interface objects or reduced versions thereof at increased depths from the viewpoint of the user. As an example in accordance with some embodiments, in FIG. 5T, the computer system 100 detects the user input 5176 (e.g., directed toward and selecting the affordance 5172 in the widget user interface 5030-c), and in FIG. 5U, in response to detecting the user input 5176, the computer system 100 displays the user interface 5180 (e.g., displaying content corresponding to the widget user interface 5030-c with greater detail and at a larger size). Increasing visual prominence of a first user interface object relative to a second user interface object, in response to detecting selection of the first user interface object, provides additional control options and/or content without cluttering the UI with persistently displayed controls and/or content regions (e.g., increasing the visual prominence includes expanding a display area and/or providing access to additional controls, which are displayed in response to a user input, rather than persistently displayed).

In some embodiments, while displaying the first user interface object in the first user interface, the computer system detects (70022), via the one or more user input elements, user interaction with the first user interface object (e.g., and in some embodiments, detecting the user interaction with the first user interface object includes providing detecting textual or speech to text input into input fields within the first user interface objects, activating a process or operation using one or more controls displayed within the first user interface object, navigating to additional application content within the first application from the first user interface object, and/or other interactions with the first user interface object and application functions accessible through the first user interface object). In response to detecting the user interaction with the first user interface object, the computer system performs a first operation using the first application function of the first application in accordance with the user interaction with the first user interface object, and while the first operation is ongoing, the computer system displays, via the one or more display generation components, a representation of the first operation in the portion of the first user interface that includes the first content. In some embodiments, the first user interface object is a user interface object including map information and a control for starting a navigation process, and the user interaction with the first user interface object specifies a destination and starts a navigation process to the destination; and once the navigation process is started, the first user interface object is reduced in size and moves into a region of the first user interface that persistently displays representations of ongoing activities that are updated from time to time as updates regarding the ongoing activities become available in their corresponding applications. For example, in some embodiments, the first user interface object is reduced into a navigation widget that shows the relevant portion of the map, navigation instructions based on the updates to the current location of the computer system, and/or traffic alerts, as the computer system is moving in the real world toward the destination in accordance with the navigation instructions. In another example, the first user interface object includes one or more controls for one or more appliances and/or devices, such as lights, garage door, speaker, thermostat, security cameras, doorbell, locks, and/or network equipment, in a smart home application, and if the user interaction includes activation of a control for opening the garage door, and/or changing the thermostat temporarily for a period of time, the computer system adds one or more widgets showing the status for the garage door and/or thermostat and optionally controls for closing the garage door and restores the thermostat settings to the portion of the first user interface that is consistently displayed across different contexts (e.g., while the first user interface object is still displayed on the first user interface, after the first user interface object is no longer displayed in the first user interface, and/or after the first user interface is replaced with another user interface on the display, e.g., as context changes or when the user dismisses the first user interface object or the first user interface). In another example, the first user interface object includes media files and playback controls for playing media files, and the user interaction with the first user interface object selects a media file and starts playing back the media file (e.g., outputting the media playback to one or more output devices coupled to the computer system). While the media file is playing, the computer system displays a widget of the media player application and/or an indicator of the media playback progress and playback controls in the portion of the first user interface that is persistently displayed across different contexts (e.g., while the first user interface object is still displayed in the first user interface, after the first user interface object is no longer displayed in the first user interface, and/or after the first user interface is replaced with another user interface on the display, e.g., as context changes, or when the user dismisses the first user interface object or the first user interface). In an example, as shown in FIG. 5X, the computer system 100 displays the widget user interface 5030-c, which includes directions for navigating to a searched location (e.g., and the directions were not displayed in the widget user interface 5030-c in FIG. 5T, prior to the user searching for the searched location). Performing a first operation using a first application function of a first application, and displaying a representation of the first operation in a portion of a first user interface that includes first content, while the first operation is ongoing, reduces the number of user inputs to display and/or access information regarding the first operation (e.g., by automatically displaying relevant information in the portion of the first user interface) and provides improved visual feedback to the user (e.g., improved visual feedback regarding a state, status, and/or progress of the first operation).

In some embodiments, displaying the first plurality user interface objects corresponding the first set of application functions provided by the first plurality of applications includes (70024) concurrently displaying, via the one or more display generation components, first application content of a first application of the first plurality of applications, and displaying, via the one or more display generation components, a first control of the first application with the first application content (e.g., the first application content and the first control are part of a first application user interface of the first application, the first application content and the first control are arranged in accordance with the first application user interface of the first application, the first application content and the first control are related to each other in the first application, and/or the first application content provides the context and/or subject of an action operation triggered by the first control). While displaying, as a result of detecting the first event, the first application content and the first control from the first application of the first plurality of applications, the computer system detects, via the one or more input elements, a first user input activating the first control. In response to detecting the first user input activating the first control, the computer system displays, via the one or more display generation components, second application content from the first application with a second control from the first application. The second application content and the second control are selected for display in accordance with an operation of the first application triggered by activation of the first control (e.g., the first application receives the input for activating the first control and determines what second application content and second controls to display in response to the activation of the first control). In some embodiments, the second application content and the second controls have lower levels in the user interface hierarchy of the first application than the first application content and the first control, and the second application content and the second controls are not directly available in a default starting user interface of the first application when the first application is launched from an application icon or widget of the first application. In other words, the first control provides access to deeper content and functionality of the first application that usually are displayed after multiple levels of navigation in the user interface hierarchy of the first application from the default starting user interface of the first application. Providing context-dependent deep links into the first application in the first user interface object allows the user quicker access to relevant content and functionality based on the current context, without requiring the user to navigate through multiple levels of the application hierarchy level by level in the first application to reach the relevant content and functionality. In an example, as shown in FIG. 5T, the computer system 100 detects the user input 5176 directed toward a first control (e.g., the affordance 5172), and in response, the computer system 100 displays the user interface 5180 in FIG. 5U, which includes second content (e.g., an expanded map display, and/or the search bar 5190) and a second control (e.g., the affordance 5182, the affordance 5184, the affordance 5186, and the affordance 5188), where the second application content and the second control are context-dependent and are deep application content that is accessible in the first application though a multiple-stage user interface interaction starting from a default starting user interface of the first application. Displaying second content from a first application with a second control from the first application, in response to detecting a user input activating a first control that is concurrently displayed with first content of a first application, provides additional control options without persistently displaying additional controls (e.g., the second content and the second control need to be persistently displayed, and can be selectively displayed when needed by activating the first control).

In some embodiments, the first plurality of applications includes (70026) one or more applications that are not currently installed on the computer system. For example, the one or more applications are installed on one or more devices that are related to the computer system, e.g., by a respective user account, by a family account that includes multiple user accounts including the account of the computer system, by proximity of location to the computer system (e.g., a point of sale device that is located close to the computer system, or another device that is within device-pairing range or Bluetooth broadcasting range of the computer system), and/or by other contextual conditions. In some embodiments, another device provides the recommendations or suggestions to the computer system (e.g., a coupon or store application from a point of sale device in a store in which the computer system is currently located, a ticketing app pushed to the computer system on a train or in a train station, or a payment or ordering application pushed to the computer system in a restaurant or vehicle charging station), and the computer system determines whether to display the user interface objects of the applications based on the current context. In an example, as described with reference to FIG. 5O, in some embodiments, the stack of widget user interfaces includes a widget user interface that corresponds to a respective application that is not currently installed on the computer system. In some embodiments, the computer system 100 is in communication with an external device that provides information and/or instructions to the computer system 100 (e.g., the respective application is installed on the external device, which transmits information and/or content to the computer system 100) to display the corresponding user interface objects for the applications that are not installed on the computer system. In some embodiments, the computer system displays a visual indication of the availability of one or more of these applications that are not installed on the computer system and displays the application clips for one or more of these applications after receiving certain confirmation actions or inputs from the user, such as the user raising the display toward his/her face, shaking the computer system, tapping on the visual indication, or moving the computer system toward an external device that provides one or more of the applications. In some embodiments, interaction with the application clips or visual indications causes the computer system to download and install one or more of the applications and enable interaction with the one or more applications after they are installed. Displaying a first user interface that includes a respective plurality of user interface objects corresponding to a respective set of application functions provided by a respective plurality of applications, including one or more applications that are not currently installed on the computer system, in accordance with a determination that a current context of the computer system meets a respective set of contextual criteria, automatically provides access to contextually relevant application functions without requiring additional user inputs (e.g., additional user inputs to enable or disable different application functions in different contexts).

In some embodiments, the first plurality of user interface objects includes (70028) a first widget stack, and the second plurality of user interface objects includes a second widget stack. The first widget stack includes multiple widgets that are included in the first widget stack in accordance with the first set of contextual criteria, and the second widget stack includes multiple widgets that are included in the second widget stack in accordance with the second set of contextual criteria. In some embodiments, the first widget stack and the second widget stack are located at the same location on the display (e.g., in the same region, and/or having substantially the same spatial relationship relative to (e.g., above, below, to the left of, to the right of, between, and/or adjacent to) other persistent user interface elements in the first user interface), and includes different sets of widgets based on the difference in current context. In an example, as shown in FIG. 5G, the user interface 5020 includes a stack of multiple widgets, including the widget 5030-a (currently displayed in FIG. 5G), the widget 5030-b (e.g., as shown in FIG. 5O) and the widget 5030-c (e.g., as shown in FIG. 5T). In different contexts, such as in FIG. 5Y or FIG. 5AA, the user interface 5020 includes a different widget stack (e.g., with a different number of widgets). For example, in FIG. 5Y, the widget stack includes four contextually relevant widgets, and in FIG. 5AA, the widget stack includes five contextually relevant widgets. Displaying a first user interface that includes a respective plurality of user interface objects that includes a respective widget stack that includes multiple widgets in accordance with a respective set of contextual criteria, in accordance with a determination that a current context of the computer system meets the respective set of contextual criteria, automatically provides access to contextually relevant application functions without requiring additional user inputs (e.g., additional user inputs to enable or disable different widgets in different contexts).

In some embodiments, displaying the first user interface that corresponds to the starting state of the computer system upon exiting the restricted state of the computer system includes (70030), displaying a first search interface for performing a search on application functions relevant for one or more user-provided search criteria. In some embodiments, the first user interface that corresponds to the starting state of the computer system upon exiting the restricted state of the computer system not only provides contextually relevant user interface objects that are automatically generated according to artificial intelligences and/or machine learning processes, but also allow the user to provide additional inputs and information to retrieve contextually relevant user interface objects using a search interface provided in the first user interface. Since the first user interface is automatically constructed based on the current context, there is a greater likelihood that a user may wish to search for content and/or functionalities that are not automatically provided, and therefore, providing a search interface directly on the starting user interface, as opposed to providing the search interface in response to a user request after displaying the starting user interface, improves the efficiency of the human-machine interface and reduces the time and number of inputs required for the user to gain access to a desired functionality. In some embodiments, the computer system performs a search on application functions relevant for one or more user-provided search criteria in response to receiving user inputs corresponding to the user-provided search criteria (e.g., textual input, text-to-speech input, images, and/or trigger words such as “Search,” “Find”, “Action,” “Assistant,” followed by a description of task, action, and/or search criteria). In an example, as shown in FIG. 5E, the user interface 5020 includes the search bar 5032 (e.g., for performing a search on application functions). Similarly, in FIG. 5F, the user interface 5036 includes the search bar 5032. Displaying a first search user interface for performing a search on application functions relevant for one or more user provided search criteria provides additional control option (e.g., application functions) without cluttering the UI with additional displayed controls (e.g., individual controls for each available application function).

In some embodiments, the computer system receives (70032) a first set of search criteria via the search interface (e.g., the computer system receives, via the one or more input elements, a first set of inputs directed to the search interface, where the first set of inputs specify the first set of search criteria). In response to receiving the first set of search criteria via the search interface, the computer system displays (e.g., concurrently displaying), via the one or more display generation components, a plurality of search results corresponding to the first set of search criteria, the plurality of search results including a respective user interface object corresponding to a respective application function that corresponds to the first set of search criteria (e.g., an application clip that includes application content and/or application controls relevant to the first set of search criteria, a widget that provides an application function relevant to the first set of search criteria, and/or an another types of user interface object that provides one or more application functions of one or more applications that are relevant to the first set of search criteria). In some embodiments, the display of the plurality of search results replaces the display of the first or second plurality of user interface objects that were automatically displayed in the first user interface in response to the first event. In some embodiments, the search interface includes a search input field for receiving search keywords and/or other search criteria via text, voice, and/or images. In some embodiments, the search interface includes an affordance that when selected, causes display of the search input fields and optionally automatic suggestions and/or recommendations for search criteria and/or application functions. In one example, in some embodiments, the first set of search criteria includes one or more keywords or a natural language description of a desired function or task (e.g., “airport,” “directions,” “good restaurants here,” “call mom,” or “find locksmith,” or other search criteria), and the plurality of search results includes widgets and/or native application user interfaces from one or more applications, an integrated user interface object that includes content and controls from multiple applications, and/or other user interface objects relevant to the searched keywords and/or descriptions (e.g., a map user interface and/or directions with a destination specified by the search criteria, mom's contact information with controls for initiating communication via different available means of communications, and/or an integrated user interface object with contact information and reviews for different locksmiths in the current area that are extracted from multiple applications). In some embodiments, the search interface starts capturing search inputs in response to an input that moves input focus to a representation of the search interface displayed in the first user interface, such as a gaze directed to the representation of the search interface, a tap gesture directed to the representation of the search interface, or a keyword spoken by the user (e.g., “Search” or “Find”). In an example, in some embodiments, as shown in FIG. 5AD, in response to detecting textual input of a search query “Rideshare” (e.g., defining the first set of search criteria) in the search input field displayed in the first user interface, the computer system 100 displays the search result 5228 and the search result 5230 that correspond to the search query. Displaying a plurality of search results that includes a respective user interface object corresponding to a respective application function that corresponds to a first set of search criteria, in response to receiving the first set of search criteria via a search interface, provides additional control options (e.g., application functions) without cluttering the UI with additional displayed controls (e.g., individual controls for each available application function.

In some embodiments, the computer system receives (70034) a second set of search criteria via the search interface (e.g., the computer system receives, via the one or more input elements, a second set of inputs directed to the search interface, where the second set of inputs specify the second set of search criteria). In response to receiving the second set of search criteria via the search interface, the computer system performs one or more operations corresponding to the second set of search criteria (e.g., without requiring additional user inputs other than the second set of search criteria before starting performance of the one or more operations) and displays content (e.g., a start of the operations waiting for additional user inputs, a status of the ongoing performance of the operations, and/or confirmation of completion of the one or more operations) corresponding performance of the one or more operations. For example, in some embodiments, the user enters a set of search criteria that describes a task (e.g., “draft a message telling David that I can't make to his party tonight”), and in response to this set of search criteria entered into the search interface, the computer system performs operations to accomplish to task without displaying a plurality of search results. For example, in response to the request to draft a message to David, the computer system retrieves the original party invitation from David and generates a reply to the invitation with a draft message (e.g., “Dear David, thank you for the invitation. Unfortunately, I cannot make it because . . . ”) displayed in a user interface object, where the user interface object corresponds to an application that was used to receive the invitation, or the user interface object provides selectable options corresponding to different applications (e.g., email, instant messages, web interface, or other communication means) through which the reply can be sent to David. In some embodiments, the search interface starts capturing search inputs in response to an input that moves input focus to a representation of the search interface displayed in the first user interface, such as a gaze directed to the representation of the search interface, a tap gesture directed to the representation of the search interface, or a keyword spoken by the user (e.g., “Action” or “Assistant”). In some embodiments, the one or more operations that correspond to the second set of search criteria are not provided by the user interface objects that are automatically displayed in the first user interface based on the current context. In some embodiments, a subset, less than all, of the one or more operations that correspond to the second set of search criteria, is provided by the user interface objects that are automatically displayed in the first user interface based on the current context, and the computer system activates suitable controls in one or more currently displayed user interface objects to perform the subset of the one or more operations in response to the receipt of the second set of search criteria. In an example, as shown in FIG. 5AH, in response to detecting entry of a search query “Call Rideshare to take me to hotel X,” the computer system 100 automatically performs a function (e.g., calls a ride via a rideshare application), optionally, without displaying search results corresponding to the search query. Performing one or more operations corresponding to a second set of search criteria, and displaying content corresponding to performance of the one or more operations, in response to receiving the second set of search criteria via a search interface, reduces the number of user inputs needed to perform the one or more operations (e.g., the user does not need to perform separate user inputs to first open an application, search for and/or access the relevant application function, and select and/or initiate the relevant application function).

In some embodiments, performing a search on application functions relevant for one or more user-provided search criteria, includes (70036), in accordance with a determination that, among multiple application functions available to the computer system, a first subset of the multiple application functions are relevant to the one or more user-provided search criteria, and a second subset of the multiple application functions are not relevant to the one or more user-provided search criteria, generating a respective set of search results for the one or more user-provided search criteria based on the first subset of the multiple application functions, rather than the second subset of multiple application functions. For example, in some embodiments, the search criteria include the keywords “navigate to Infinite Loop” and the computer system performs searches among available application functions relevant to the search criteria. The computer system identifies the maps applications as providing a navigation function, and identifies “Infinite Loop” as the destination of interest, and as a result, the computer system displays a user interface object that displays navigation instructions, relevant traffic conditions, and relevant portions of the map for navigating to the destination “Infinite Loop” and does not include other application functions, such as an address search function, nearby business recommendation function, or the terrain map available within the maps applications (e.g., functions that are provided within the same user interface as the navigation function in the maps applications). In addition, the computer system identifies that a message in the messages application that includes a discussion regarding navigating to “Infinite Loop,” and the computer system identifies the messaging function as a relevant application function based on the message content and displays a user interface object that displays the message content and a reply affordance for replying to the message; however, the messaging application itself is not identified as a relevant application for navigation and is not included in the search results, and other messages unrelated to navigating to Infinite Loop are also not displayed among the search results. In some embodiments, the search interface allows a user to access relevant application functions and relevant content from multiple applications, without displaying user interfaces of those multiple applications and without opening those applications, e.g., by providing and/or arranging excerpts of relevant application content and/or relevant application controls in a dynamically-created user interface object that is not available in any of the multiple applications. In an example, as illustrated in FIG. 5AF, in response to detecting entry of a search query “Take me to hotel X,” the computer system 100 displays search results for applications and/or application functions for travelling to hotel X (e.g., the search result 5240 automatically searches for rideshares to hotel X using the rideshare application; the search result 5242 automatically provides directions to hotel X using the map and/or navigation application; and/or the search result 5244 automatically searches for trains and/or public transportations to locations near hotel X). Generating a respective set of search results for one or more user provided search criteria based on a first subset of multiple application functions and not based on a second subset of multiple application functions, provides additional control options (e.g., application functions) without cluttering the UI with additional displayed controls (e.g., individual controls for each available application function).

In some embodiments, the one or more user-provided search criteria include (70038) a description (e.g., a natural language description, or a phrase) of a task that a user is interested in performing (e.g., “get home,” “play music,” “take a photo,” or other functional language). In some embodiments, the search criteria do not include a name or identifier of an application. In some embodiments, if the search criteria include a name or identifier of an application, a user interface object including a default application user interface of the application is displayed among the search results. In some embodiments, if the search criteria include a name or identifier of an application, an application icon of the application is displayed among the search results. In some embodiments, if the search criteria include a name or identifier of an application, an application icon of the application is not displayed as a search result, instead, a user interface object including a default application user interface of the application is displayed among the search results. In some embodiments, the search criteria that include a description of a task that the user is interested in performing is a natural language description and the natural language description is processed by an artificial intelligence program on the computer system or on a remote server, to determine the steps, applications, and application functions within the applications, that are needed to accomplish the task, and the computer system provides an integrated user interface that includes a representation of the multi-step process, along with the application functions recommended for carrying out different steps of the multi-step processes and/or status of automatically initiated or completed steps of the multi-step process. For example, in FIG. 5AE, the search query is “Take me to hotel X” (e.g., a natural language phrase). Similarly, in FIG. 5AG, the search query is “Call Rideshare to take me to hotel X.” In some embodiments, the search results would include real-time status of the rideshare vehicle after the ride has been automatically requested using a rideshare application, payment and tipping options for the user to select at the end of the car ride, reservation information for hotel X retrieved from an email application, and recommendations for restaurants near hotel X provided by a maps application, for example. Displaying a first search user interface for performing a search on application functions relevant for one or more user provided search criteria, where the search criteria include a description of a task a user is interested in performing, provides additional control options (e.g., application functions) without cluttering the UI with additional displayed controls (e.g., individual controls for each available application function).

In some embodiments, performing a search on application functions relevant for one or more user-provided search criteria, includes (70040) displaying a respective user interface object (e.g., as a result of performing one or more operations to accomplish a task requested by the user, or as part of a plurality of search results relevant to the search criteria provided by the user) that includes combined content that is generated based on first application content (e.g., content and controls) from a first application and second application content (e.g., content and controls) from a second application different from the first application. The first application content and the second application content are identified as being relevant to the one or more user-provided search criteria (e.g., the first set of search criteria, the second set of search criteria, or another set of search criteria provided by the user) by the computer system, in response to receiving the one or more user-provided search criteria. In one example, the one or more user-provided search criteria include a functional description of a task that a user wishes to perform, such as “create a birthday card for mom” or “play some relaxing music.” In response to receiving the search criteria in the form of a task description in natural language, the computer system identifies relevant application functions, including a template for a birthday card from a word processing application, a plurality of images identified as “mom” from the photos application, a plurality of songs or music files from the music player application, a plurality of fonts and suggested birthday well wishes retrieved from the Internet. The computer system generates a respective user interface object that includes the different components relevant to the search, such as the template displayed in an editing user interface of the word processing application, with a panel showing the available fonts and suggested birthday well wishes on the side, and with an affordance for displaying a list of selectable thumbnails for the “mom” images retrieved from the photos application, and an affordance for playing back sample clips of the songs and music files retrieved from the music player application. Other types of combined user interface objects that include content and controls from multiple applications integrated into the same user interface object or other combined in a form that is concurrently accessible to the user for a searched task are possible in accordance with various embodiments. For example, as described with reference to FIG. 5AF, in some embodiments, the computer system 100 displays one or more search results that combine content from multiple applications. For example, the computer system 100 displays a search result that, when activated, uses the navigation application to provide directions for navigating to a train station, then uses the train application to provide trains to stations near hotel X (e.g., and then the navigation application provides directions for navigating to hotel X from the train station to hotel X). Displaying a respective user interface object that includes combined content generated based on first application content from a first application and second application content from a second application, wherein the first content and the second application content are identified as relevant to first search criteria provided by a user, provides additional control options and content (e.g., application functions and/or application content) without cluttering the UI with persistently displayed controls and content.

In some embodiments, performing a search on application functions relevant for one or more user-provided search criteria, includes (70042), in accordance with a determination that a respective application provides a first set of application content that meets the one or more user-provided search criteria and a second set of application content that does not meet the one or more user-provided search criteria, displaying the first set of application content, without displaying the second set of application content, in response to the search. In some embodiments, the first set of application content includes content that is not available in an initial application user interface (e.g., a default application user interface) of the respective application when the respective application is invoked through an application icon of the respective application (e.g., the second set of application content includes content that is available in the default initial application user interface). For example, if the default initial user interface of the messages application includes a listing of messages from different senders, and a control for displaying a blank new message to be composed by the user, the search results for a search query “send message to mom” includes a user interface object that includes a blank new message with recipient auto-filled with “mom's contact address and a default salutation “Hi mom filled into the message body. In another example, if the default initial application user interface of the payment application is a listing of saved payment cards, the search results for a search query “pay for gas” includes a user interface object with a subset of the payment cards that are associated with respective discounts for gasoline, in accordance with some embodiments. For example, in FIG. 5AH, the computer system 100 displays the user interface 5250 (e.g., corresponding to the rideshare application) that automatically enters the destination location (e.g., “to location”), which would not be pre-populated if accessing the same functionality through an application icon of the rideshare application. Displaying a first set of application content (e.g., corresponding to a respective application) relevant for user-provided search criteria that is not available in an initial application user interface invoked through an application icon of a respective application, provides additional control options without cluttering the UI with additional displayed controls (e.g., persistently displayed controls for the content that is not available in the initial application user interface).

In some embodiments, displaying the first set of application content in response to the search, includes (70044), in accordance with a determination that the computer system is coupled to an external device (e.g., another computer system, a peripheral device such as an external display device, or another electronic device that includes its own operating system and display), displaying a first amount of application content as the first set of application content; and in accordance with a determination that the computer system is not coupled to an external device (e.g., another computer system, a peripheral device such as an external display device, or another electronic device that includes its own operating system and display), displaying a second amount of application content that is different from (e.g., less than, or more than) the first amount of application content (e.g., less visual content, occupying a smaller area of display space, and/or includes fewer user interface objects and/or providing fewer functionalities of the respective application) as the first set of application content. In some embodiments, the computer system adjusts the threshold for identifying application content as relevant to the first set of search criteria or not, based on whether the computer system is coupled to an external device that provides additional display area for displaying the search results. In some embodiments, if the computer system determines that the computer system is coupled to an external device that provides additional display area and/or processing power, the computer system lowers the threshold for relevance, and allows more search results to be displayed; and if the computer system determines that the computer system is not coupled to an external device that provides additional display area and/or processing power, the computer system raises the threshold for relevance, and allows fewer search results to be displayed. In some embodiments, the computer system adjusts the level of complexity of a respective search result based on whether the computer system is connected to an external device that can provide additional display area and/or processing power. For example, if the computer system determines that the computer system is coupled to an external device that provides additional display area and/or processing power, the computer system generates a first user interface object that provides a relevant application function, and the first user interface object includes more detailed application information, and lays out a greater number of relevant controls for directly accessing other potentially relevant application functions through the user interface object; and if the computer system determines that the computer system is not coupled to an external device that provides additional display area and/or processing power, the computer system generates a second user interface object that provides the same relevant application function, but the second user interface object includes less detailed application information, and lays out a smaller number of relevant controls for directly accessing other potentially relevant application functions through the user interface object. For example, as described with reference to FIG. 5AF, in some embodiments, if the computer system 100 is connected to an external device (e.g., a personal or desktop computer, or an external display), the computer system 100 displays additional detail in the search user interface 5226. For example, when connected to a desktop computer, the computer system 100 can leverage the additional processing power of the desktop computer to generate additional search results, or additional content corresponding to a particular search result (e.g., the search result 5240 may include pricing information for different rideshare options; the search result 5242 may provide previews and/or information corresponding to potential routes to hotel X; and/or the search result 5244 may display some upcoming trains and/or departure times for trains heading towards hotel X). When connected to an external display, the computer system 100 can leverage the external display to display the generated search results with a higher level of detail (e.g., and/or a larger size). Displaying a first amount of application content when the computer system is coupled to an external device, and displaying a second (e.g., different) amount of application content when the computer system is not coupled to an external device, automatically displays an appropriate amount of application content based on context (e.g., more application content may be displayed when the computer system is coupled to an external device, as the external device may have and/or enable additional functionality and/or content to be displayed).

In some embodiments, while displaying the first user interface that corresponds to the starting state of the computer system upon exiting the restricted state of the computer system, the computer system detects (70046) selection of (e.g., detects a tap input or another type of selection input directed to) a first user interface object of a respective set of user interface objects currently displayed in the first user interface (e.g., the first plurality of user interface objects, the second plurality of user interface objects, the third plurality of user interface objects, or another plurality of user interface objects that have been selected for display in accordance with a set of contextual criteria suitable for the current context). In response to detecting the selection of the first user interface object of the respective plurality of user interface objects currently displayed in the first user interface, in accordance with a determination that the first user interface object corresponds to a first application, the computer system ceases to display the respective set of user interface objects in the first user interface, and displays a user interface of the first application (e.g., launching the first application, and/or displaying a default or normal application user interface provided by the first application, that is not redacted, augmented, or otherwise changed by the computer system, unlike the user interface objects corresponding to contextually relevant application functions that were provided on the first user interface by the computer system) with a first portion of the first user interface. In accordance with a determination that the first user interface object corresponds to a second application different from the first application, the computer system ceases to display the respective set of user interface objects in the first user interface, and displays a user interface of the second application (e.g., launches the second application and/or displays a default or normal application user interface provided by the second application, that is not redacted, augmented, or otherwise changed by the computer system, unlike the user interface objects corresponding to contextually relevant application functions that were provided on the first user interface by the computer system) with the first portion of the first user interface. In one example, in accordance with some embodiments, a plurality of contextually relevant user interface objects, such as widgets, application user interface objects, controls for triggering application functions, and/or other user interface objects, are displayed in the first user interface that corresponds to a starting system user interface of the computer system upon exiting the restricted state. When the user interacts with a user interface object displayed in the first user interface, other user interfaces related to the user interface object, such as expanded user interfaces or user interfaces from relevant applications are displayed, taking over the display area occupied by the original set of contextually relevant user interface objects in the first user interface; however, a portion of the first user interface remains visible outside of the newly displayed user interfaces and/or user interface objects, such that a background, some fixed elements of the first user interface remain visible and/or selectable (e.g., to bring back the first user interface, including the set of contextually relevant user interface objects). For example, in FIG. 5P, the computer system 100 displays the user interface 5142 overlaid over a portion of the user interface 5020. A portion of the user interface 5020 remains displayed, including the affordance 5022, the affordance 5024, and the affordance 5026, but a portion of the user interface 5020 is overlaid by the user interface 5142 (e.g., the widget user interface 5030-b is no longer displayed, as it is overlaid by the user interface 5142). For example, in FIG. 5U, the computer system 100 displays the user interface 5180 in an analogous fashion (e.g., overlaid over the same portion of the user interface 5020). Displaying a user interface of a respective application with (e.g., concurrently with) a portion of a first user interface, in response to detecting selection of a first user interface object displayed in the first user interface, reduces the number of user inputs needed to access relevant functionality and display appropriate content (e.g., the computer system can concurrently display the user interface of the respective application and a persistent portion of the first user interface, without requiring the user to navigate back and forth between the user interface of the respective application and the first user interface).

In some embodiments, the first user interface includes (70048) a persistently displayed portion (e.g., portion that includes a search interface, a background image, system status indicators such as battery level indicator and network indicators, preselected controls, such as controls for displaying a set of preselected contacts, shortcuts to a set of preselected application functions, and/or a set of preselected widgets, where the types and identities of the user interface objects included in the persistently displayed portion remain substantially unchanged when the first user interface is displayed in different contexts) and a contextually updated portion. The contextually updated portion of the first user interface includes a respective plurality of user interface objects corresponding a respective set of application functions (e.g., different numbers of user interface objects and/or application functions) that are automatically selected for display in the first user interface in accordance with changes in a current context of the computer system (e.g., based on the contextual criteria for identifying different relevant application functions) over time (e.g., while the first user interface remains displayed, and/or at different times when the first user interface is dismissed and then redisplayed at a later time), and the persistently displayed portion includes content (e.g., portion that includes a search interface, a background image, system status indicators such as battery level indicator and network indicators, preselected controls, such as controls for displaying a set of preselected contacts, shortcuts to a set of preselected application functions, and/or a set of preselected widgets) that is persistently included (e.g., maintaining the same number and the same type of functions) in the first user interface during the changes in the current context of the computer system (e.g., while the first user interface remains displayed, and/or at different times when the first user interface is dismissed and then redisplayed at a later time). For example, in FIG. 5L, the user interface 5020 includes a contextually updated portion (e.g., the user interface 5116, which updates dynamically with the playing content), and a persistently displayed portion (e.g., the time, the affordance 5022, the affordance 5024, the affordance 5026, the widget user interface 5030-a, the search bar 5032, and/or the affordance 5034). Displaying a first user interface that includes a persistently displayed portion and a contextually updated portion, reduces the number of user inputs needed to access relevant functionality and display appropriate content (e.g., the persistently displayed portion can include frequently accessed functionality, while the contextually updated portion automatically displays contextually relevant content without requiring additional user inputs).

In some embodiments, while displaying the first user interface, the computer system detects (70050) user interaction with the first user interface. In response to detecting the user interaction with the first user interface, the computer system performs one or more operations that causes display of new content in a first portion of a display previously occupied by the contextually updated portion of the first user interface, while at least a second portion of the display continues to display at least a portion of the persistently displayed portion of the first user interface (e.g., a portion of persistently displayed portion of the first user interface (e.g., maintaining the recognizable, persistent characteristics of the first user interface) remains visible and accessible to the user (e.g., to bring back the first user interface as a whole), even as new content and user interface objects are displayed in response to user interaction with the user interface objects of the initially displayed contextually updated portion of the first user interface). In some embodiments, at least a portion of the background and/or user interface controls of the persistently displayed portion of the first user interface remains visible and accessible to the user, and the user can bring the whole persistently displayed portion of the first user interface into view by providing an input directed to the visible portion of the persistently displayed portion of the first user interface. In an example, when the user interacts with a control or function provided in the contextually updated portion of the first user interface or the persistently displayed portion of the first user interface, the computer system may display additional user interface objects that take up a large portion of the display, and visually obscure the previously displayed content in the first user interface. However, as new content is displayed in response to the user's interaction with the computer system, at least a portion of the first user interface, such as a portion of the persistently displayed portion and, optionally, a portion of the contextually updated portion, would remain displayed and accessible to the user even if the new content occupies some regions previously occupied by the contextually updated portion and/or the persistently displayed portion of the first user interface. The user can always navigate back to the full view of the first user interface by dismissing the new content that were displayed in response to the user interactions with the computer system (e.g., closing the new content one by one, swiping on the new content from a top or bottom edge of the touch-screen display, or by a tap on the visible portion of the first user interface outside of the new content), in accordance with some embodiments. For example, in FIG. 5K, the computer system 100 displays the user interface 5098 in a portion of the user interface 5020 that previously included the widget user interface 5030-a, while maintaining display of a portion of the user interface 5020 (e.g., that includes the time, the affordance 5022, the affordance 5024, and the affordance 5026). Performing one or more operations that cause display of new content in a first portion of a display previously occupied by a contextually updated portion of the first user interface, while at least a second portion of the display continues to display at least a portion of a persistently displayed portion of the first user interface, reduces the number of user inputs needed to access relevant functionality and display appropriate content (e.g., the persistently displayed portion can include frequently accessed functionality, and is concurrently displayed with the new content, reducing the need for the user to perform additional user inputs to navigate between the first user interface and the new content).

In some embodiments, while the new content is displayed in the first portion of the display previously occupied by the contextually updated portion of the first user interface, and while the second portion of the display continues to display at least a portion of the persistently displayed portion of the first user interface, the computer system detects (70052) a respective user input that meets home criteria (e.g., the respective user input is a tap directed to the visible portion of the first user interface, or a swipe in a first direction (e.g., downward, upward, leftward, and/or rightward) and/or starts from an edge of the touch-screen display, or an input that meets home criteria for dismissing any new content that has been displayed since the first user interface was initially displayed and navigating back to the first user interface). In response to detecting the respective user input that meets the home criteria, the computer system displays the first user interface, including the persistently displayed portion and the contextually updated portion of the first user interface (e.g., including the full view of the first user interface, without the new content added in response to prior interaction with the first user interface and/or functionality directly or indirectly accessed through the first user interface). For example, in FIG. 5L, the computer system 100 displays (e.g., redisplays, after ceasing to display) the widget user interface 5030-a in the user interface 5020, in response to detecting the user input 5112 in FIG. 5K. The user interface 5020 includes a persistently displayed portion (e.g., including the time, and/or the affordance 5022, the affordance 5024, the affordance 5026, the search bar 5032, and/or the affordance 5034) and a contextually updated portion (e.g., including the widget user interface 5030-a). Displaying the first user interface, including the persistently displayed portion and the contextually updated portion of the first user interface, in response to detecting a respective user input that meets home criteria while new content is displayed in the first portion of the display previously occupied by the contextually updated portion of the first user interface (e.g., while continuing to display at least a portion of the persistently displayed portion of the first user interface), reduces the number of user inputs needed to display relevant content (e.g., the computer system can concurrently display the new content and a persistent portion of the first user interface, without requiring the user to navigate back and forth between the new content and the first user interface).

In some embodiments, displaying the first user interface includes (70054) displaying a first aggregated control (e.g., a control for displaying a list of contacts, a control for displaying a list of media files, or a control for displaying a list of operation modes) that, when activated, provides access to at least a first sub-function and a second sub-function in a first integrated user interface object. Performing the first sub-function requires operation of a first underlying application, and performing the second sub-function requires operation of a second underlying application different from the first underlying application. In one example, the first integrated user interface object provides a listing of a plurality of contacts and provides access to communicate with a respective contact using at least a first communication means (e.g., text message, file sharing, proximity-based communication, and/or other communication means) via a first communication application (e.g., a social networking application, a file sharing application, a network application, or other communication applications) and a second communication means (e.g., voice call, video call, text message, email, augmented reality communication, shared experience in an extended reality environment, and/or other communication means) via a second communication application (e.g., a telephony application, a VoIP application, a shared experience, or other communication applications). For example, in FIG. 5G, the user interface 5020 includes an aggregated control (e.g., the control 5022). When activated, as shown in FIG. 5H, the computer system 100 provides access to different sub-functions (e.g., an affordance 5066, an affordance 5068, and an affordance 5070, for initiating communications session via different protocols, with a contact stored in memory of the computer system 100). Displaying a first user interface that includes a first aggregated control, which when activated, provides access to at least a first sub-function and a second sub-function in a first integrated user interface object, reduces the number of user inputs needed to activate the first and/or second sub-function (e.g., the user does not need to perform additional user inputs to open a first and/or second underlying application corresponding to the first and/or second sub-functions).

In some embodiments, while displaying the first user interface, including the first aggregated control, the computer system detects (70056) a respective user input that activates the first aggregated control, and in response to detecting the respective user input that activates the first aggregated control, the computer system displays representations of a plurality of users (e.g., the contacts are users and/or devices with unique identifiers in different communication applications, such as phone numbers, social media handles, device ID, names, account identifiers, usernames, and/or other types of identifiers that can be used to route a communication message, communication request, and/or support a communication session, between users and/or between devices). A respective representation of a respective user of the plurality of users provides access to two or more means of communicating with the respective user. In some embodiments, while displaying the representations of the plurality of users, the computer system detects selection of a first representation of a first user among the representations of the plurality of users; and in response to detecting selection of the first representation of the first user, the computer system displays a first selectable option for initiating a first communication with the first user using a first means of communication (e.g., calling the first user using a telephone number of the first user, via a telephony application, or a VoIP application) and a second selectable option for initiating a second communication with the first user using a second means of communication (e.g., displaying a new message composition or a new reply with the first user as the recipient, using a email application, instant messaging application, or social media application) different from the first means of communication (e.g., communication means offered and carried out by two different communication applications using different application user interfaces of the two different communication applications). In some embodiments, in response to detecting the respective user input that activates the first aggregated control, the computer system displays the representations of the plurality of users, where a respective representation of a respective user is concurrently displayed with a first respective selectable option for initiating a first communication with the respective user using a first means of communications and a second respective selectable option for initiation a second communication with the respective user using a second means of communication that is different from the first means of communication. In some embodiments, the set of selectable options that are displayed for a respective representation of a respective user is determined based on what means of communications are available for the respective user, and may be different for different users. For example, in FIG. 5G, the user interface 5020 includes an aggregated control (e.g., the control 5022). When activated, as shown in FIG. 5H, the computer system 100 provides access to different sub-functions (e.g., an affordance 5066, an affordance 5068, and an affordance 5070, for initiating communications session via different protocols, with a contact stored in memory of the computer system 100). The user interface 5050 in FIG. 5H includes a plurality of contacts, each of which includes different affordances for initiating communication session via different protocols). Displaying representations of a plurality of users, wherein a respective representation of a respective user of the plurality of users provides access to two or more means of communicating with the respective user, in response to detecting a respective user input that activates a first integrated control, provides additional control options without cluttering the UI with persistently displayed controls (e.g., the single first integrated control provides access to a plurality of means of communicating with a plurality of users, rather than needing to persistently display individual controls for each means of communicating with each user of the plurality of users).

In some embodiments, displaying the first user interface includes (70058) displaying a second aggregated control (e.g., a control for displaying a list of media files, or a control for displaying a listing of operation modes) that, when activated, provides access to a respective plurality of media items. The respective plurality of media items includes a first plurality of media items when the first set of contextual criteria is met, and includes a second plurality of media items, different from the first plurality of media items, when the second set of contextual criteria is met. In some embodiments, the respective plurality of media items includes media items retrieved from different storage systems and/or different applications of the computer system (e.g., images, songs, videos retrieved from the saved files of two or more media applications, such as a photo library application, a social networking application, a messaging application, a voice memo application, a media capture application, and/or other applications that store media items). In one example, the computer system has access to media items, such as songs, albums, videos, and photos. The computer system automatically generates playlist or recommended media and include them in the second integrated user interface objects, based on the current context. For example, the playlist includes soothing music and quiet songs when the first user interface is displayed in response to the first event and in accordance with a determination that the first set of contextual criteria are met (e.g., when the current time is evening, and the current location is home); and the playlist includes songs and music suitable for exercising when the first user interface is displayed in response to the first event and in accordance with a determination that the second set of contextual criteria are met (e.g., the motion of the computer system indicates that the user is jogging or exercising). In some embodiments, the computer system includes recommended media such as slideshows of photos and videos in the user's media library, in the second integrated user interface objects, and photos and videos related to family are included in the second integrated user interface objects when the first set of contextual conditions are met (e.g., when the user is at home or the current time is the weekend), whereas photos and videos related to coworkers and work are included in the second integrated user interface object when the second set of contextual conditions are met (e.g., the user is in the office or the current time is during the work hours). In some embodiments, the second integrated user interface object provides a listing of media files, such as songs, albums, photos, videos and provides access to playing back a respective media item using at least a first playback mode (e.g., sampling portions of different songs in a playlist, playback with a first speed, show in a slideshow, show in a collage, and/or other playback modes) or first output device (e.g., speaker, carphone, in a first room, in a second room, and/or other output devices or locations) and using a second playback mode (e.g., play in full screen mode, play in thumbnail, play in background, and/or other playback modes) or second output device (e.g., all connected output devices, switching output devices when moving into different locations, or other devices or locations) different from the first playback mode or output device. For example, in FIG. 5J, the user interface 5020 includes an aggregated control (e.g., the control 5024). When activated, as shown in FIG. 5K, the computer system 100 displays the user interface 5098 that includes a plurality of media items (e.g., songs or music). Displaying a second aggregated control that provides access to a respective plurality of media items provides additional control options without cluttering the UI with additional displayed controls (e.g., individual controls for each media item of the plurality of media items).

In some embodiments, the first plurality of media item is included (70060) in a first automatically generated playlist, and the second plurality of media items is included in a second automatically generated playlist. For example, as described with reference to FIG. 5K, in some embodiments, the computer system 100 automatically generates a playlist of songs, and in some embodiments, the playlist of songs is automatically generated by the computer system 100 (e.g., based on a current context, such that different automatically generated playlists are available in different contexts). Displaying a second aggregated control that provides access to a respective plurality of media items, including a respective automatically generated playlist, reduces the number of user inputs needed to play media items (e.g., the user does not need to perform additional user inputs to compile a playlist of media items).

In some embodiments, while displaying the first user interface, including the second aggregated control, the computer system detects (70062) a respective user input that activates the second aggregated control, and in response to detecting the respective user input that activates the second aggregated control, the computer system displays representations of the respective plurality of media items (e.g., in an automatically generated playlist, in a slideshow, or in another collection of recommended media items), and starts playback of the respective plurality of media items (e.g., automatically starting to play without requiring an additional user input to select a playback control or a particular media item in the respective plurality of media items). For example, as described with reference to FIG. 5K, in some embodiments, the computer system 100 automatically begins playing media when the user interface 5098 is displayed (e.g., in response to detecting the user input 5096). Displaying representations of a respective plurality of media items and starting playback of a respective plurality of media items in response to detecting a respective user input that activates a second integrated control reduces the number of user inputs needed to play relevant media items (e.g., the user does not need to perform additional user inputs to initiate playback of the respective plurality of media items).

In some embodiments, displaying the first user interface includes (70064) displaying a media capture control that, when activated, starts media capture of a first media type (e.g., still photo, video, voice memo, or another type of media, optionally, without providing a mode switching function or media editing functions in the user interface of the media capture, unlike in the normal user interface of the application that performs the media capture of the first media type). In some embodiments, the user interface that is, optionally, provided in response to detecting activation of the media capture control in the first user interface is a simplified user interface of a media capture application, does not include the mode switching option and media library access of a default user interface of the media capture application if the media capture application was launched using an application icon of the media capture application, as opposed to the media capture control in the first user interface. In some embodiments, the first user interface includes one or more controls that provide access to different functions, including a first control corresponding to a first set of functions, a second control corresponding to a second set of functions (and, optionally a third control for a third set of functions). In some embodiments, these controls are displayed in a persistently displayed portion of the first user interface and do not change in number and function in response to changes in the current context of the computer system when display of the first user interface is triggered at different times. In some embodiments, these controls are displayed in the first user interface with the first plurality of user interface objects when the first set of contextual criteria is met. The first control and the second control are displayed in the first user interface with the second plurality of user interface objects when the second set of contextual criteria is met. In some embodiments, the first control triggers display of a user interface object that aggregates application functions of multiple applications (e.g., an application function provided by one application, and another application function provided by another application), and the second control triggers display of a user interface that aggregates application functions of multiple applications (e.g., an application function provided by one application, and another application function provided by another application). For example, in FIG. 5L, the user interface 5020 includes a media capture control (e.g., the control 5026), which when activated, starts media capture of a first media type (e.g., photo capture), as shown in FIG. 5M (e.g., the media capture is completed when the affordance 5122 is activated, e.g., by the user input 5124 in FIG. 5M). Displaying a media capture control, which when activated, starts media capture of a first media type, in response to detecting a first event, reduces the number of user inputs needed to start media capture of the first media type (e.g., the user does not need to perform additional user inputs to access a camera application and/or select the first media type for capture).

In some embodiments, displaying the first user interface in accordance with the determination that the current context meets the first set of contextual criteria includes (70066) displaying a respective user interface object corresponding to a first payment and/or credential function (e.g., credit card, membership card, boarding pass, ticket, proof of payment, identification card, online payment function, invitation, and/or other card, payment, ID, or credential functions) in the first user interface in accordance with a determination that a current location of the computer system meets first location criteria. The first location criteria correspond to one or more locations corresponding to the first payment or credential function. For example, in some embodiments, in response to detecting that the computer system has exited to restricted state and that the current location of the computer system is in a store, a bank, an airport, a train station, a concert venue, or another location that is associated with a payment function or card credential function, the computer system automatically displays a user interface object that includes payment information or credential information (e.g., payment card, tickets, identification, membership, and/or invitations) that can be used at the current location. In some embodiments, displaying the first user interface in accordance with the determination that the current context meets the first set of contextual criteria includes forgoing displaying the respective user interface object corresponding to the first payment and/or credential function (e.g., credit card, membership card, boarding pass, ticket, proof of payment, identification card, online payment function, invitation, and/or other card, payment, ID, or credential functions) in the first user interface in accordance with a determination that the current location of the computer system does not meet the first location criteria. For example, in some embodiments, in response to detecting that the computer system has exited to restricted state and that the current location of the computer system is not in a store, a bank, an airport, a train station, a concert venue, or another location that is associated with a payment function or card credential function, the computer system does not automatically display the user interface object that includes payment information or credential information (e.g., payment card, tickets, identification, membership, and/or invitations). For example, in FIG. 5Z, the computer system 100 displays the widget user interface 5216-b, which provides a credential function (e.g., boarding pass information) corresponding to an upcoming flight. Displaying a respective user interface object corresponding to a first payment and/or credential function in the first user interface, in response to detecting a first event, and in accordance with a determination that a current location of the computer system corresponds to one or more locations corresponding to the first payment or credential function, reduces the number of user inputs needed to perform the first payment and/or credential function (e.g., the user does not need to perform additional user inputs to first access a payment and/or credential application, or other user interface that provides access to the first payment and/or credential function).

It should be understood that the particular order in which the operations in FIGS. 7A-7I have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 80000) are also applicable in an analogous manner to method 70000 described above with respect to FIGS. 7A-7I. For example, the user inputs, user interfaces, and/or controls described above with reference to method 70000 optionally have one or more of the characteristics of the user inputs, user interfaces, and/or controls described herein with reference to other methods described herein (e.g., method 80000). For brevity, these details are not repeated here.

FIGS. 8A-8D are flow diagrams illustrating method 80000 of for displaying different user interfaces and changing functions of a computer system, when connected to different external computer systems, in accordance with some embodiments. Method 80000 is performed at a computer system or an electronic device (e.g., device 300, FIG. 3A, or portable multifunction device 100, FIG. 1A) that is in communication with one or more display generation components (e.g., touch-screen displays, projectors, LCD displays, displays with optical and/or video passthrough portions, and/or other types of displays) and a first set of one or more input elements for detecting user inputs (e.g., input devices and/or sensors for detecting user inputs, such as touch-sensitive surfaces, touch-screen displays, solid-state input regions, buttons, levels, image sensors, gyros, motion sensors, proximity sensors, pressure sensors, touch-sensors, orientation sensors, fingerprint sensors, microphones, temperature sensors, ambient light sensors, geolocation sensors, and/or other types of input elements). In some embodiments, the display generation component is a touch-screen display and the touch-sensitive surface is on or integrated with the display. In some embodiments, the display generation component is separate from the touch-sensitive surface. In some embodiments, the first computer system has characteristics and features of the computer system described with respect to the method 70000 and FIGS. 7A-7I (e.g., when the first computer system is operating in a standalone mode and/or when the first computer system is operating in accordance with a first operating environment), and vice versa, and analogous descriptions are not repeated herein, in the interest of brevity. Some operations in method 80000 are, optionally, combined and/or the order of some operations is, optionally, changed.

As described below, the method 80000 includes switching a computer system from operating in accordance with a first operating environment to operating in a respective other operating environment, in accordance with a determination that the computer system is connected to a respective other computer system, which automatically switches to operating the computer system in accordance with a contextually relevant operating environment without requiring additional user inputs (e.g., the user does not need to perform manual user inputs to switch operating environments each time the computer system is connected to a different other computer system).

The first computer system displays (80002), via the first set of one or more display generation components, a first user interface (e.g., the user interface 5020 in FIG. 6A) in accordance with a first operating environment associated with the first computer system (e.g., the computer system displays a user interface of the smartphone operating system, displays a home screen of a mobile device, and/or displays a system user interface or application user interface of a computer system of a first operating system type). The first user interface provides access to a first plurality of functions of the first operating environment (e.g., functions of the smartphone OS, system functions and/or application functions provided using user interfaces native to the operating system of the computer system of the first operating system type, such as a contacts function, a media function, a camera function, a search function, a speech input function, and/or application-related functions which are optionally accessed via widget user interfaces, as shown in the affordances of the user interface 5020 in FIG. 6A).

While displaying the first user interface in accordance with the first operating environment associated with the first computer system, the first computer system detects (80004), via the first set of one or more input elements, that the first computer system is connected to (e.g., coupled via one or more wired or wireless connections, optionally with handshake and communication channels established according to pre-agreed protocols) a respective computer system (e.g., a device that is independently operable from the first computer system and/or a device that has its own operating system, such as another mobile device, a desktop device, a peripheral device, such as a smart watch, a projector, a display, a headset, a speaker, a smart home appliance, a smart home controller, or other computer systems of the same or different operating system types as the first computer system). For example, as shown in FIG. 6C, the computer system 100 is connected to the television 5150; in FIG. 6J, the computer system 100 is connected to the personal computer system 5148; and in FIGS. 6K-6M, the computer system 100 is connected to the external display 6000.

In response to detecting (80006) that the first computer system is connected to the respective computer system, and in accordance with a determination that the respective computer system is a second computer system that operates in accordance with a second operating environment different from the first operating environment (e.g., a TV OS, a watch OS, a projector OS, a smart home controller OS, or another operating system type different from the first operating system type of the first computer system), the computer system switches (80008) from operating in accordance with the first operating environment (e.g., smartphone OS, or another example of the first operating system of the first computer system) to operating in accordance with the second operating environment (e.g., TV OS, or another example of the second operating system of the second computer system), including providing instructions to the second computer system (e.g., the TV, or another example of the second computer system) that, when received by the second computer system, cause performance of a second plurality of operations by the second computer system (e.g., smart TV, or another example of the second computer system), in accordance with the second operating environment (e.g., TV OS, or another example of the second operating system). For example, in some embodiments, the smartphone, after connected to a smart TV, switches from operating the phone OS to operating the TV OS, and provides instructions and causes the TV to perform operations in accordance with the TV OS. In another example, a mobile device, after connected to a smart home controller, switches from operating the operating system of the mobile device to operating the operating system of the smart home controller, and provides instructions to the smart home controller in accordance with the protocols of the operating system of the smart home controller and perform operations and/or cause the smart home controller to perform operations in accordance with the protocols of the operating system of the smart home controller. For example, as shown in FIG. 6E, in response to detecting that the computer system 100 is connected to the television 5150, the television 5150 provides instructions to the television 5150 to automatically begin playing media, as shown in the user interface 6006. In some embodiments, providing an instruction to the respective computer system in accordance with the second operating environment different from the first operating environment is more than simply transmitting an instruction using a mutually agreed communication protocol between two operating systems and having the respective computer system translate the instruction into locally usable form using the second operating environment, but involves directly generating the instruction according to the rules and syntax requirements of the second operating environment, so that the instruction is directly usable by the second operating environment to control the hardware, I/O functions, and core operating system functions at the respective computer system.

In response to detecting (80006) that the first computer system is connected to the respective computer system, and in accordance with a determination that the respective computer system is a third computer system that operates in accordance with a third operating environment (e.g., desktop OS, tablet OS, server OS, and/or another type of operating system that is different from the first operating system and the second operating system) different from the first operating environment (e.g., smartphone OS, or another example of the first operating system) and the second operating environment (e.g., TV OS, or another example of the second operating system), the computer system switches (80010) from operating in accordance with the first operating environment (e.g., smartphone OS, or another example of the first operating system) to operating in accordance with the third operating environment (e.g., desktop OS, or another example of the third operating system).

Switching from operating in accordance with the first operating environment to operating in accordance with the third operating environment includes receiving (80012) instructions from the third computer system (e.g., the desktop computer, or another example of the third computer system); and in response to receiving the instructions from the third computer system, performing (80014) a third plurality of operations (e.g., capturing touch inputs, capturing video, and/or other operations), different from the first plurality of operations (e.g., smartphone functions, and/or other examples of operations of the first computer system when operating the first operating system in a standalone fashion) and the second plurality of operations (e.g., performing operations specified by the TV OS instructions received from the second computer system). For example, as shown in FIG. 6J, in response to detecting the computer system 100 is connected to the personal computer system 5148, the computer system 100 functions as a trackpad for the personal computer system 5148. In some embodiments, receiving an instruction from the respective computer system and performing an operation in accordance with the third operating environment different from the first operating environment and is more than simply receiving an instruction using a mutually agreed communication protocol between two operating systems and translate the instruction into locally usable form using the first operating environment, but involves loading and executing the third operating environment in the memory of the first computer system and feeding the instruction into third operating environment directly, so that the instruction is directly executed by the newly loaded third operating environment to control the hardware and I/O functions at the first computer system. In some embodiments, the first computer system is a device that is capable of running multiple operating systems and/or providing instructions and/or executing instructions according to those operating systems, including a first operating system that is used when the first computer system is operating in a standalone fashion, a second operating system that is of the same operating system type as used by a second computer system that is connected to the first computer system and receiving instructions from the first operating system, and a third operating system that is the same operating system type as used by a third computer system that is connected to the first computer system and providing instruction to the first computer system. In some embodiments, depending on whether the first computer system is operating in a standalone fashion, or connected to another computer system with a different operating system, the first computer system changes its primary functions based on what computer system is currently connected to it. In a more specific example, a computer system may be a smartphone device operating a mobile phone OS, and when it is connected to a TV, it switches to operating the TV OS and controls the TV using instructions prepared in accordance with the TV OS; and when it connected to a desktop or laptop, it switches to operating the desktop OS or laptop OS and provides peripheral functions such as display function, trackpad function, network function, or other functions in accordance with instructions received from the desktop or laptop in accordance with the desktop OS or laptop OS. In some embodiments, the first computer system includes an overarching operating system that resides in the memory of the first computer system and that handles the automatic switching between multiple sub-operating systems (e.g., the first operating environment, the second operating environment, the third operating environment, or another operating environment), the automatic enabling and/or disabling one or more sub-operating systems, and/or the automatic enabling and/or disabling certain functions of one or more of the sub-operating systems, optionally, based on whether the first computer system is operating in the standalone mode, or is connected to another computer system; based on whether the first computer system is providing instructions (e.g., serving as a primary device for a secondary device connected to the first computer system) or receiving instructions from the connected computer system (e.g., serving as a secondary device for a primary device that is connected to the first computer system); based on the device type and capabilities of the respective computer system that is connected to the first computer system; based on the configuration and spatial relationship of the first computer system and the respective computer system that is connected to the first computer system; and/or based on other characteristics and contextual conditions related to the connection between the first computer system and the respective computer system.

In some embodiments, in response to detecting that the first computer system is connected to the respective computer system, and in accordance with a determination that the respective computer system is of a first device type (e.g., TV, computer monitor, bike mount, projector, desktop computer, smart home control device, cameras, doorbell, thermostat, smart picture frame, and/or another device type that, optionally, operates in a standalone manner using a respective operating system that is, optionally, different from the first operating system, and that can be connected to the first computer system and, optionally, be operated with the same or a different operating system from that used in the standalone mode), the computer system switches (80016) from providing a first set of functions (e.g., the set of functions provided using the first operating system of the first computer system in the standalone mode) to providing a second set of functions different from the first set of functions. The second set of functions is selected in accordance with the first device type (e.g., the second set of functions includes serving as a display device, an input device, a health monitor, a server, a speaker, a motion sensor, a camera, or another type of input device, output device, peripheral device, server, and/or controller for the respective computer system of the first device type). In response to detecting that the first computer system is connected to the respective computer system, and in accordance with a determination that the respective computer system is of a second device type different from the first device type (e.g., TV, computer monitor, bike mount, projector, desktop computer, smart home control device, cameras, doorbell, thermostat, smart picture frame, and/or another device type that, optionally, operates in a standalone manner using a respective operating system that is, optionally, different from the first operating system, and that can be connected to the first computer system and, optionally, be operated with the same or a different operating system from that used in the standalone mode), the computer system switches from providing the first set of functions to providing a third set of functions different from the first set of functions and the second set of functions. The third set of functions is selected in accordance with the second device type (e.g., the third set of functions includes serving as a display device, an input device, a health monitor, a server, a speaker, a motion sensor, a camera, or another type of input device, output device, peripheral device, server, and/or controller for the respective computer system of the second device type). In some embodiments, when a mobile device is operating in a standalone mode, it has its integrated display, touch-screen, camera, speaker, network circuitry, telephony circuitry, batteries, motion sensors, light sensors, and other components functioning in accordance with the first operating system and applications installed on the first operating system; and when the mobile device is connected to another device, such as a TV monitor, the mobile device switches to serve as a server device to stream content to the TV monitor, and also switches to operate a TV operating system and provides a user interface to provide selection of media content and control TV output parameters, and control the TV accordance with the inputs received from the user via the components of the mobile device. In another example, if the mobile device is connected to an exercise bike, the mobile device switches to operating as a controller for the exercise bike and utilizes its motion and temperature sensors to detect vibrations and temperature changes in the bike or the user to adjust operating parameters of the bike and cause the bike change resistance values and/or exercise modes. In some embodiments, the mobile device also serves as a display of the bike to provide exercise data, such as distance traveled, duration of the exercise session. Instead of relying on the bike to provide the data, the data is, optionally, generated by sensors of the mobile device itself. In another example, the mobile device is connected to a computer monitor, and the mobile device switches from operating in the mobile device operating system to operating in a desktop device operating system, and outputs the desktop environment of the desktop device operating system to the computer monitor. Optionally, the mobile device can connect to other input devices such as a keyboard or a mouse and emulate a main computing device of a desktop computer setup. In another example, the mobile device is connected to desktop computer, and the mobile device provides a webcam function, a display function, a trackpad function, or a keyboard function to the desktop computer, in accordance with the instructions of the desktop operating system received from the desktop computer. Other types of functions and roles are selectively served by the first computer system, in accordance with various embodiments, and in accordance with the operating system of the connected device, and/or the device type of the connected device. In an example, as shown in FIG. 6E, the computer system 100 is connected to the television 5150, and the computer system 100 displays information (e.g., episode and season information, and run time information) corresponding to television media playing on the television 5150 (e.g., in the user interface 6006). In FIG. 6J, the computer system 100 is connected to the personal computer 5148, and the user can perform inputs on and/or with the computer system 100 (e.g., the computer system 100 functions as a trackpad for the personal computer 5148). Switching from providing a first set of functions to providing a second set of functions (e.g., different from the first set of functions) in accordance with a determination that the respective computer system is of a first device type, and switching from providing the first set of functions to providing a third set of functions (e.g., different from the first and second sets of functions) in accordance with a determination that the respective computer system is of a second device type (e.g., different from the first device type), reduces the number of user inputs to enable an appropriate set of functions without requiring further user input (e.g., the computer system automatically switches to a respective set of functions when connected to a respective device type).

In some embodiments, in response to detecting that the first computer system is connected to the respective computer system, and in accordance with a determination that the first computer system is connected to the respective computer system (e.g., the respective computer system is of a first device type, or a second device type, operating a second operating system, or operating a third operating system) in a first manner (e.g., with a first spatial configuration between the first computer system and the respective computer system, side-by-side in a vertical direction, side-by-side in a horizontal direction, attached to a top edge, a bottom edge, a left edge, a right edge, on the front, on the back, and/or using a first type of connection (e.g., wired, wireless, magnetic, direct contact, non-contact, a first type of connection protocol, and/or using a first port), the computer system enables (80018) a first new function selected in accordance with the connection in the first manner (e.g., the first new function includes serving as a display device, an input device, a health monitor, a server, a speaker, a motion sensor, a camera, or another type of input device, output device, peripheral device, server, and/or controller for the respective computer system, while the respective computer system is connected to the first computer system in the first manner, without enabling a second new function selected in accordance with a connection in a manner different from the first manner). In response to detecting that the first computer system is connected to the respective computer system, in accordance with a determination that the first computer system is connected to the respective computer system (e.g., the respective computer system is of a first device type, or a second device type, operating a second operating system, or operating a third operating system) in a second manner different from the first manner (e.g., with a second spatial configuration between the first computer system and the respective computer system, side-by-side in a vertical direction, side-by-side in a horizontal direction, attached to a top edge, a bottom edge, a left edge, a right edge, on the front, on the back, and/or using a second type of connection e.g., wired, wireless, magnetic, direct contact, non-contact, a second type of connection protocol, and/or using a second port), the computer system enables a second new function, different from the first new function (e.g., without enabling the first new function that was selected in accordance with a connection in the first manner). The second new function is selected in accordance with the connection in the second manner (e.g., the second new function includes serving as a display device, an input device, a health monitor, a server, a speaker, a motion sensor, a camera, or another type of input device, output device, peripheral device, server, and/or controller for the respective computer system, while the respective computer system is connected to the first computer system in the second manner). In one example, in some embodiments, if the mobile device is connected to a desktop display, while the mobile device is laid flat on a horizontal surface close to the desktop display, the mobile device provides the function of a desktop computer for the display and displays the desktop user interface on the display. The mobile device also uses its touch-screen as a trackpad for the desktop computer, in accordance with some embodiments. Continuing with the example, if the mobile device is connected to the desktop display while the mobile device and the desktop display are coplanar or face the same direction, the mobile device provides the function of a webcam, and optionally receives operation instruction from a desktop computer through the desktop display. In another example, if the mobile device is connected to a smart home controller through a wireless connection, the mobile device provides instruction to the smart home controller and changes the operation mode of the smart home controller; and if the mobile device is connected to the smart home controller through a wired connection, the mobile device becomes a display device for the smart home controller and displays a user interface of the smart home controller in accordance with instructions received from the smart home controller. In an example, as shown in FIG. 6E, the computer system 100 is connected to the television 5150 in a first manner (e.g., via a magnetic connection, while the computer system 100 has a landscape orientation), and the computer system 100 displays information (e.g., episode and season information, and run time information) corresponding to television media playing on the television 5150 (e.g., in the user interface 6006). In FIG. 6H, the computer system 100 is connected to the television 5150 in a second manner (e.g., via a wireless connection, while the computer system 100 has a portrait orientation), and the computer system 100 provides control affordances. Enabling a first new function in accordance with a determination that the first computer system is connected to the respective computer system in a first manner, and enabling a second new function (e.g., different from the first new function) in accordance with a determination that the first computer system is connected to the respective computer system in a second manner (e.g., different than the first manner), reduces the number of user inputs to enable appropriate functions without requiring further user input (e.g., the computer system automatically enables a respective new function when connected to the respective device in a respective manner).

In some embodiments, switching from operating in accordance with the first operating environment to operating in accordance with the second operating environment includes (80020) switching from operating in a standalone mode to operating in a dual operating system mode, operating in the standalone mode includes operating in accordance with the first operating environment, and operating in the dual operating system mode includes operating in accordance with the first operating environment and the second operating environment in parallel. Similarly, in some embodiments, switching from operating in accordance with the first operating environment to operating in accordance with the third operating environment includes switching from operating in the standalone mode to operating in the dual operating system mode. Operating in the standalone mode includes operating in accordance with the first operating environment. Operating in the dual operating system mode including operating in accordance with the first operating environment and the third operating environment in parallel. For example, the mobile device operates in a standalone mode in accordance with the mobile device operating system, and the mobile device enables operation of another operating system without disabling the mobile device operating system when the mobile device is connected to another device, and the two operating system function concurrently and in parallel. In a more specific example, the mobile device can still provide mobile phone functionality and/or display notifications from applications in accordance with the mobile device operating system, while serving as a track pad or webcam for a desktop computer connected to the mobile device (e.g., the mobile device also runs the desktop operating system and receives instructions from the desktop to function as the track pad or webcam in accordance with the desktop operating system), or serving as a streaming and controlling device for the TV connected to the mobile device (e.g., the mobile device also runs the TV operating system, and provides instruction and content to the TV in accordance with the TV operating system). For example, as described with reference to FIG. 6F, in some embodiments, the computer system 100 is operating in a dual operating system mode. For example, the computer system 100 operates in a television operating system mode, and transmits instructions and/or television content to the television 5150 for display. The computer system 100 simultaneously operates in a phone operating system mode, in which the computer system 100 continues to receive and display notifications (e.g., relating to text messages, phone calls, video calls, or other phone-based functions). Switching from operating in a standalone mode to operating in a dual operating system mode, automatically switches to operating the computer system in a contextually relevant mode without requiring additional user inputs (e.g., the user does not need to perform manual user inputs to switch operational modes each time the computer system is connected to another computer system).

In some embodiments, switching from operating in accordance with the first operating environment to operating in accordance with the second operating environment includes (80022): in accordance with a determination that a first set of contextual criteria are met (e.g., first set of contextual criteria based on the current location, the current time, the identity of the second computer system, the identity of a user that is currently in proximity to the first computer system, a user that provided the authentication information to the first or second computer system, and other contextual conditions), operating the second operating environment in accordance with a first operating profile (e.g., the first operating profile is associated with the current location, the current time, or the user identity that is in proximity to the first computer system or provided authentication information to the first computer system) associated with the second operating environment; and in accordance with a determination that a second set of contextual criteria are met (e.g., second contextual criteria based on the current location, the current time, the identity of the second computer system, the identity of a user that is currently in proximity to the first computer system, a user that provided the authentication information to the first or second computer system, and other contextual conditions), different from the first set of contextual criteria, operating the second operating environment in accordance with a second operating profile (e.g., the second operating profile is associated with the current location, the current time, or the user identity that is in proximity to the first computer system or provided authentication information to the first computer system), different from the first operating profile, associated with the second operating environment. For example, in some embodiments, when the mobile device is connected to a desktop monitor, the mobile device switches from operating the mobile device operating system to operating the desktop operating system, and depending on whether the current location is at home or in the office, the mobile device operates the desktop operating system using a home profile or a work profile. In some embodiments, different profiles for a respective operating system determines what the frequently used applications are, what configurations of the desktop to use, which calendars to load, and/or other settings and configurations that can be customized for different operating profiles of the respective operating system. In some embodiments, switching from operating in accordance with the first operating environment to operating in accordance with the third operating environment includes: in accordance with a determination that a third set of contextual criteria are met (e.g., third set of contextual criteria based on the current location, the current time, the identity of the second computer system, the identity of a user that is currently in proximity to the first computer system, a user that provided the authentication information to the first or second computer system, and other contextual conditions), operating the third operating environment in accordance with a third operating profile (e.g., the third operating profile is associated with the current location, the current time, or the user identity that is in proximity to the first computer system or provided authentication information to the first computer system) associated with the third operating environment; and in accordance with a determination that a fourth set of contextual criteria (e.g., fourth contextual criteria based on the current location, the current time, the identity of the second computer system, the identity of a user that is currently in proximity to the first computer system, a user that provided the authentication information to the first or second computer system, and other contextual conditions), different from the third set of contextual criteria, are met, operating the third operating environment in accordance with a fourth operating profile (e.g., the fourth operating profile is associated with the current location, the current time, or the user identity that is in proximity to the first computer system or provided authentication information to the first computer system), different from the third operating profile, associated with the third operating environment. For example, in FIG. 6K, in a first context (e.g., at a work location and/or at a first time), the computer system 100 is connected to the external display 6000, and provides access to a first set of affordances (e.g., and the external display 6000 displays the email user interface 6048). In FIG. 6L, in a second context (e.g., at a home location and/or at a second time), the computer system 100 is connected to the external display 6000, and provides access to a second set of affordances (e.g., and the external display 6000 displays the video user interface 6068). Operating the second operating environment in accordance with a first operating profile in accordance with a determination that a first set of contextual criteria are met, and operating the second operating environment in accordance with a second operating profile (e.g., different than the first operating profile) in accordance with a determination that a second set of contextual criteria (e.g., different than the first set of contextual criteria) are met, reduces the number of user inputs to operate the second operating environment with the correct operating profile (e.g., the computer system automatically operates the second operating environment in accordance with a contextually appropriate operating profile when respective contextual criteria are met).

In some embodiments, switching from operating in accordance with the first operating environment to operating in accordance with the third operating environment includes (80024) switching from operating as a phone (e.g., a mobile phone, a smart phone, or other portable multifunctional device that provides a telephony function as a primary function and runs one application on the foreground (on the display) at a time) to operating as a trackpad for the third computer system (e.g., in accordance with a determination that the respective computer system is a desktop computer, or a desktop monitor, or another computer system that will provide the operating instruction for the mobile phone to operate as a trackpad in accordance with the operating system environment of the computer system). For example, in FIG. 6J, the computer system 100 functions as a trackpad for the personal computer 5148, when the computer system 100 is connected to the personal computer 5148. Switching from operating as a phone to operating as a trackpad for the third computer system reduces the number of user input to enable contextually relevant functionality (e.g., the computer system automatically enables trackpad functionality when contextually relevant, without requiring the user to manually enable the trackpad functionality).

In some embodiments, switching from operating in accordance with the first operating environment to operating in accordance with the third operating environment includes (80026) switching from operating as a phone (e.g., a mobile phone, a smart phone, or other portable multifunctional device that provides a telephony function as a primary function and runs one application on the foreground (on the display) at a time) to operating as a display for status notifications of the third computer system (e.g., in accordance with a determination that the respective computer system is a desktop computer, or a TV, or another computer system that will provide the operating instruction for the mobile phone to operate as a display for notifications and status information for the desktop computer or TV, in accordance with the operating system environment of the desktop computer or TV). For example, as described with reference to FIG. 6F, in some embodiments, the user interface 6012 displays status notifications (e.g., notifications generated by the computer system 100, the television 5150, and/or another device connected to the computer system 100). Switching from operating as a phone to operating as a display for status notifications of the third computer system reduces the number of user inputs needed to enable contextually relevant functionality (e.g., the computer system automatically enables display of status notifications when contextually relevant, without requiring the user to manually enable or allow display of status notifications).

In some embodiments, switching from operating in accordance with the first operating environment to operating in accordance with the second operating environment includes (80028) switching from operating using a first operating system (e.g., an operating system associated with a mobile phone, a smart phone, or other portable multifunctional device that provides a telephony function as a primary function and runs one application on the foreground (on the display) at a time) to operating using a second operating system that is different from the first operating system (e.g., an operating system associated with a computer system that provides a desktop that is capable of displaying multiple windows of multiple applications at the same time, where the windows are freely movable on the desktop in response to user input) (e.g., in accordance with a determination that the respective computer system is a computer monitor or another big display). For example, as described with reference to FIG. 6K, in some embodiments, while connected to the external display 6000, the computer system 100 provides content to be displayed via the external display 6000 (e.g., the computer system 100 switches from operating as a phone, prior to connecting to the external display 6000, to functioning a primary device that provides instructions to a secondary device such as the external display 6000). Switching from operating using a first operating system to operating using a second operating system that is different from the first operating system reduces the number of user inputs needed to operate the computer system with the contextually relevant operating system (e.g., the computer system automatically switches to an appropriate operating system, based on context).

In some embodiments, switching from operating in accordance with the first operating environment to operating in accordance with the second operating environment includes (80030) switching from operating as a phone (e.g., a mobile phone, a smart phone, or other portable multifunctional device that provides a telephony function as a primary function and runs one application on the foreground (on the display) at a time) to operating as a content source for a television (e.g., a device that has a display and a primary function of displaying streamed video content from a content source, such as a TV antenna, closed circuit TV, cable box, or other streaming content source that feeds to content to the device continuously). In some embodiments, the switching from operating as a phone to operating as a content source for a television is performed in response to and/or in accordance with a determination that the respective computer system is a television. For example, as described with reference to FIG. 6E, in some embodiments, the computer system 100 provides the television media to the television 5150 (e.g., transmits content to be displayed by the television media). In some embodiments, the computer system 100 is a primary device (e.g., that provides instructions and/or content to the television 5150) and the television 5150 is a secondary device (e.g., that receives instructions and/or content from a primary device). Switching from operating as a phone to operating as a content source for a television reduces the number of user inputs needed to provide relevant content (e.g., the computer system automatically switches to providing content for a television without requiring the user to manually enable and/or select content to be provided to the television).

In some embodiments, the first computer system is connected (80032) to the respective computer system via a wireless connection (e.g., a WiFi connection, a Bluetooth connection, a magnetic connection, a connection with direct physical contact, a connection without a direct physical contact, and/or another type of wireless connection based on a currently known or future developed wireless connection protocol). For example, in FIGS. 6G and 6H, the computer system 100 is connected to the television 5150 via a wireless connection, such as a Bluetooth connection without direct physical contact with the television. Switching a computer system from operating in accordance with a first operating environment to operating in a respective other operating environment, in accordance with a determination that the computer system is connected to a respective other computer system via a wireless connection, automatically switches to operating the computer system in accordance with a contextually relevant operating environment without requiring additional user inputs (e.g., the user does not need to perform manual user inputs to switch operating environments each time the computer system is connected to a different other computer system).

In some embodiments, the first computer system is connected (80034) to the respective computer system via a physical connection (e.g., a wired connection, connection via a hardware port, or another type of connection that requires direct physical contact or nearfield interactions between the first computer system and the respective computer system). For example, in FIG. 6I, the computer system 100 is connected to the personal computer 5148 via the physical connector 6042 (e.g., a cable, a port, or another physical connector). Switching a computer system from operating in accordance with a first operating environment to operating in a respective other operating environment, in accordance with a determination that the computer system is connected to a respective other computer system via a physical connection, automatically switches to operating the computer system in accordance with a contextually relevant operating environment without requiring additional user inputs (e.g., the user does not need to perform manual user inputs to switch operating environments each time the computer system is connected to a different other computer system).

In some embodiments, the first computer system is connected (80036) to the respective computer system via a magnetic connection (e.g., a connection that includes coupling via electromagnetic fields or waves, and does not require a physical contact between the respective computer system and the first computer system, or only requires contact or proximity and does not require a specific hardware port). In some embodiments, the magnetic connection is an electro-permanent connection. For example, in FIG. 6D, the computer system 100 is connected to the television 5150 via a magnetic connector 6004. Switching a computer system from operating in accordance with a first operating environment to operating in a respective other operating environment, in accordance with a determination that the computer system is connected to a respective other computer system via a magnetic connection, automatically switches to operating the computer system in accordance with a contextually relevant operating environment without requiring additional user inputs (e.g., the user does not need to perform manual user inputs to switch operating environments each time the computer system is connected to a different other computer system).

In some embodiments, the computer system turns on (80038) (e.g., causing to exit from an power-off state, a standby state, a sleep state, a dormant state, a low-power state, and/or a low-power always-on state, and enter into a power-on state, a normal state, a wake state, a non-dormant state, a non-low-power state) the respective computer system (e.g., sending an instruction to the respective computer system to power on, and/or displaying a user interface of the first computer system, or a starting user interface of the respective computer system) in response to detecting that the first computer system is connected to the respective computer system (e.g., via an electro-permanent connection, or another type of physical and/or nearfield connection). In some embodiments, the first computer system also provides an instruction to the respective computer system to shut down when the respective computer system is disconnected from the first computer system. In some embodiments, the first computer system provides an instruction to the respective computer system, where the instruction causes the respective computer system to display a user interface of the first computer system when the first computer system is connected to the respective computer system. In some embodiments, the first computer system provides an instruction to the respective computer system, and the instruction causes the respective computer system to cease to display a user interface of the first computer system when the first computer system is disconnected from the respective computer system. For example, as described with reference to FIG. 6E, in some embodiments, before the computer system 100 is connected to the television 5150, the television is in a power off and/or low-power state (e.g., in FIG. 6C, the display of the television 5150 is off as the computer system 100 is being moved to connect to the television 5150). In response to connecting the computer system 100 to the television 5150, the television 5150 is turned on (e.g., and/or exits the low-power state), and optionally, automatically begins playing television content (e.g., as shown in FIG. 6E). Turning on the respective computer system in response to detecting that the first computer system is connected to the respective computer system automatically turns on the respective computer system without requiring additional user inputs (e.g., the user does not need to manually power on the respective computer system before connecting the first computer system, or manually power on the respective computer system after connecting the first computer system).

In some embodiments, in response to detecting that the first computer system is connected to the respective computer system, the computer system initiates (80040) charging of the first computer system using the respective computer system as a power source, or initiating charging of the respective computer system using the first computer system as a power source. In some embodiments, the first computer system and/or the respective computer system determines which of the two will serve as the charging source based on which computer system has more battery power or which computer system is already connected to another power source. For example, the computer system that has more battery charge will serve as the power source for the other computer system. In another example, the computer system that is already connected to another power source, such as a charging station or wall outlet, will serve as the power source for the other computer system). For example, in FIG. 6F, the computer system 100 is charging (e.g., as indicated by the notification 6018), via the connection to the television 5150. Initiating charging of the first computer system using the respective computer system as a power source, or initiating charging of the respective computer system using the first computer system as a power source, automatically charges an appropriate computer system without requiring further user input, and ensures that the connected computer systems have adequate power to perform and/or provide contextually appropriate and/or intended functions (e.g., and reduces the number of connections needed to an external power source, such as a wall outlet or power strip, as only one of the first computer system and respective computer system needs to be connected to the external power source to provide power to both computer systems).

In some embodiments, displaying the first user interface in accordance with the first operating environment associated with the first computer system includes (80042): in accordance with a determination that the first computer system is operating with a first user profile (e.g., a first user profile selected based on a first set of contextual criteria being met or when the first user is present or has provided authentication information to the first computer system), providing access to the first plurality of functions in accordance with the first user profile; and in accordance with a determination that the first computer system is operating with a second user profile (e.g., a second user profile selected based on a second set of contextual criteria being met or when the second user is present or has provided authentication information to the first computer system), providing access to the first plurality of functions in accordance with the second user profile. The first user profile and the second user profile specify different sets of customization for the first plurality of functions (e.g., different sets of applications, restrictions, and/or settings for the functions). In one example, the first computer system has a first user profile for a parent and a second user profile for a child, and depending on which user has provided the authentication information for exiting the restricted state of the first computer system, the first computer system will operate with either the first user profile or the second user profile, when providing the first plurality of functions. For example, in FIG. 6L, the user profile JS is in use, and a first set of affordances is available on the computer system 100. In FIG. 6M, the user profile LK is in use, and a different set of affordances is available on the computer system 100. Providing access to a first plurality of functions in accordance with a first user profile when the first computer system is operating with a first user profile, and providing access to the first plurality of functions in accordance with a second user profile when the first computer system is operating with the second user profile, automatically customizes the first plurality of functions based on the current user profile without requiring further user input (e.g., the user does not need to manually enable, disable, or otherwise customize functions of the first plurality of functions when the current user profile is changed). This also increases the privacy, security, and content filtering capabilities of the computer system (e.g., for computer systems that are used by multiple different users), by automatically enabling and/or disabling different functions and/or content based on the current user profile.

It should be understood that the particular order in which the operations in FIGS. 8A-8D have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 70000 and/or methods described with respect to FIGS. 5A-5AJ) are also applicable in an analogous manner to method 80000 described above with respect to FIGS. 8A-8D. For example, the user inputs, user interfaces, and/or controls described above with reference to method 80000 optionally have one or more of the characteristics of the user inputs, user interfaces, and/or controls described herein with reference to other methods described herein (e.g., method 70000 and/or methods described in FIGS. 5A-5AJ). For brevity, these details are not repeated here.

The operations described above with reference to FIGS. 7A-7I and 8A-8D are, optionally, implemented by components depicted in FIGS. 1A-1B. For example, detection operation 70002, switching operation 80008, and/or performance operation 80014 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method, comprising:
at a first computer system that is in communication with a first set of one or more display generation components and a first set of one or more input elements for detecting user inputs:
displaying, via the first set of one or more display generation components, a first user interface in accordance with a first operating environment associated with the first computer system, wherein the first user interface provides access to a first plurality of functions of the first operating environment, the first plurality of functions corresponding to a first set of operations of the first computer system;
while displaying the first user interface in accordance with the first operating environment associated with the first computer system, detecting, via the first set of one or more input elements, that the first computer system is connected to a respective computer system;
in response to detecting that the first computer system is connected to the respective computer system:
in accordance with a determination that the respective computer system is a second computer system that operates in accordance with a second operating environment different from the first operating environment, switching from operating in accordance with the first operating environment to operating in accordance with the second operating environment, including providing instructions to the second computer system that, when received by the second computer system, cause performance of a second plurality of operations by the second computer system, in accordance with the second operating environment; and
in accordance with a determination that the respective computer system is a third computer system that operates in accordance with a third operating environment different from the first operating environment and the second operating environment, switching from operating in accordance with the first operating environment to operating in accordance with the third operating environment, including:
receiving instructions from the third computer system; and
in response to receiving the instructions from the third computer system performing a third plurality of operations, different from the first plurality of operations and the second plurality of operations.

2. The method of claim 1, including:
in response to detecting that the first computer system is connected to the respective computer system:
in accordance with a determination that the respective computer system is of a first device type, switching from providing a first set of functions to providing a second set of functions different from the first set of functions, wherein the second set of functions is selected in accordance with the first device type; and
in accordance with a determination that the respective computer system is of a second device type different from the first device type, switching from providing the first set of functions to providing a third set of functions different from the first set of functions and the second set of functions, wherein the third set of functions is selected in accordance with the second device type.

3. The method of claim 1, including:
in response to detecting that the first computer system is connected to the respective computer system:
in accordance with a determination that the first computer system is connected to the respective computer system in a first manner, enabling a first new function selected in accordance with the connection in the first manner; and
in accordance with a determination that the first computer system is connected to the respective computer system in a second manner different from the first manner, enabling a second new function, different from the first new function, wherein the second new function is selected in accordance with the connection in the second manner.

4. The method of claim 1, wherein:
switching from operating in accordance with the first operating environment to operating in accordance with the second operating environment includes switching from operating in a standalone mode to operating in a dual operating system mode;
operating in the standalone mode includes operating in accordance with the first operating environment; and
operating in the dual operating system mode includes operating in accordance with the first operating environment and the second operating environment in parallel.

5. The method of claim 1, wherein switching from operating in accordance with the first operating environment to operating in accordance with the second operating environment includes:
in accordance with a determination that a first set of contextual criteria is met, operating in the second operating environment in accordance with a first operating profile associated with the second operating environment; and
in accordance with a determination that a second set of contextual criteria is met, different from the first set of contextual criteria, are met, operating in the second operating environment in accordance with a second operating profile, different from the first operating profile, associated with the second operating environment.

6. The method of claim 1, wherein switching from operating in accordance with the first operating environment to operating in accordance with the third operating environment includes switching from operating as a phone to operating as a trackpad for the third computer system.

7. The method of claim 1, wherein switching from operating in accordance with the first operating environment to operating in accordance with the third operating environment includes switching from operating as a phone to operating as a display for status notifications of the third computer system.

8. The method of claim 1, wherein switching from operating in accordance with the first operating environment to operating in accordance with the second operating environment includes switching from operating using a first operating system to operating using a second operating system that is different from the first operating system.

9. The method of claim 1, wherein switching from operating in accordance with the first operating environment to operating in accordance with the second operating environment includes switching from operating as a phone to operating as a content source for a television.

10. The method of claim 1, wherein the first computer system is connected to the respective computer system via a wireless connection.

11. The method of claim 1, wherein the first computer system is connected to the respective computer system via a physical connection.

12. The method of claim 1, wherein the first computer system is connected to the respective computer system via a magnetic connection.

13. The method of claim 1, including:
turning on the respective computer system in response to detecting that the first computer system is connected to the respective computer system.

14. The method of claim 1, including:
in response to detecting that the first computer system is connected to the respective computer system, initiating charging of the first computer system using the respective computer system as a power source, or initiating charging of the respective computer system using the first computer system as a power source.

15. The method of claim 1, wherein displaying the first user interface in accordance with the first operating environment associated with the first computer system includes:
in accordance with a determination that the first computer system is operating with a first user profile, providing access to the first plurality of functions in accordance with the first user profile; and
in accordance with a determination that the first computer system is operating with a second user profile, providing access to the first plurality of functions in accordance with the second user profile, wherein the first user profile and the second user profile specify different sets of customization for the first plurality of functions.

16. A first computer system, comprising:
a first set of one or more display generation components;
a first set of one or more input elements for detecting user inputs;
one or more processors; and
memory storing one or more programs, wherein the one or more programs are configured to be executed by the one or more processors, the one or more programs including instructions for:
displaying, via the first set of one or more display generation components, a first user interface in accordance with a first operating environment associated with the first computer system, wherein the first user interface provides access to a first plurality of functions of the first operating environment, the first plurality of functions corresponding to a first set of operations of the first computer system;
while displaying the first user interface in accordance with the first operating environment associated with the first computer system, detecting, via the first set of one or more input elements, that the first computer system is connected to a respective computer system; and
in response to detecting that the first computer system is connected to the respective computer system:
in accordance with a determination that the respective computer system is a second computer system that operates in accordance with a second operating environment different from the first operating environment, switching from operating in accordance with the first operating environment to operating in accordance with the second operating environment, including providing instructions to the second computer system that, when received by the second computer system, cause performance of a second plurality of operations by the second computer system, in accordance with the second operating environment; and
in accordance with a determination that the respective computer system is a third computer system that operates in accordance with a third operating environment different from the first operating environment and the second operating environment, switching from operating in accordance with the first operating environment to operating in accordance with the third operating environment, including:
receiving instructions from the third computer system; and
in response to receiving the instructions from the third computer system performing a third plurality of operations, different from the first plurality of operations and the second plurality of operations.

17. A computer readable storage medium storing one or more programs, the one or more programs comprising instructions that, when executed by a first computer system that is in communication with a first set of one or more display generation components and a first set of one or more input elements for detecting user inputs, cause the first computer system to:
display, via the first set of one or more display generation components, a first user interface in accordance with a first operating environment associated with the first computer system, wherein the first user interface provides access to a first plurality of functions of the first operating environment, the first plurality of functions corresponding to a first set of operations of the first computer system;
while displaying the first user interface in accordance with the first operating environment associated with the first computer system, detect, via the first set of one or more input elements, that the first computer system is connected to a respective computer system; and
in response to detecting that the first computer system is connected to the respective computer system:
in accordance with a determination that the respective computer system is a second computer system that operates in accordance with a second operating environment different from the first operating environment, switch from operating in accordance with the first operating environment to operating in accordance with the second operating environment, including providing instructions to the second computer system that, when received by the second computer system, cause performance of a second plurality of operations by the second computer system, in accordance with the second operating environment; and
in accordance with a determination that the respective computer system is a third computer system that operates in accordance with a third operating environment different from the first operating environment and the second operating environment, switch from operating in accordance with the first operating environment to operating in accordance with the third operating environment, including:
receiving instructions from the third computer system; and
in response to receiving the instructions from the third computer system performing a third plurality of operations, different from the first plurality of operations and the second plurality of operations.
